(19) United States
(12) Patent Application Publication
(10) Pub. No.: US 2026/0268117 A1
(43) Pub. Date: Sep. 10, 2026

(54) MACHINE LEARNING SYSTEMS AND METHODS FOR AUTOMATED PROCESS DISCOVERY

(71) Applicant: Soroco India Private Limited, Bengaluru (IN)

(72) Inventors: George Peter Nychis, Somerville, MA (US); Sourabh De, Bangalore (IN); Vageesh Ganesh Hoskere, Bangalore (IN); Abdul Qadir, Bangalore (IN); Rohan Narayana Murty, Bangalore (IN); Hemanth Yamijala, Bangalore (IN); Vinod Kumar Viswanath, Bangalore (IN); Sasi Kumar Reddy Kattamanchi, Telangana (IN); Vinayak Dhar, Bengaluru (IN)

(73) Assignee: Soroco India Private Limited, Bengaluru (IN)

(21) Appl. No.: 19/473,768

(22) PCT Filed: Apr. 10, 2024
(86) PCT No.: PCT/IN2024/050370

§ 371 Date: Oct. 8, 2025

Related U.S. Application Data
(60) Provisional application No. 63/471,665, filed on Jun. 7, 2023.

(30) Foreign Application Priority Data
Apr. 10, 2023 (IN) 202341026569

(51) Int. Cl. G06N 3/045

(52) U.S. Cl. CPC G06N 3/045

(57) ABSTRACT

Techniques for using trained machine learning (ML) model(s) to identify a process in a stream of event data at least in part by receiving information corresponding to a stream of events corresponding to interactions between a user and application program(s) executing on a computing device; organizing events in the stream of events into a plurality of windows of events; generating, using the trained ML model(s), a respective plurality of numeric representations corresponding to the plurality of windows; determining a measure of similarity between each of the numeric representations and stored and previously-determined numeric representation(s) of the process to obtain a plurality of measures of similarity; and identifying, using the determined measures of similarity, the process in the stream of events as comprising events in those windows, among the plurality of windows, whose determined measure of similarity to the stored numeric representation(s) of the process was greater than a first threshold.

### CROSS-REFERENCE TO RELATED APPLICATIONS

This application claims the benefit of U.S. Provisional Patent Application Ser. No. 63/471,665, filed Jun. 7, 2023, entitled “Machine Learning Techniques for Generating Business Context from User Interaction-Based Data”. This application also claims priority from Indian Patent Application number 202341026569, filed Apr. 10, 2023, entitled “Machine Learning Techniques for Generating Business Context from User Interaction-Based Data”. Both these applications are incorporated by reference herein in their entirety.

### BACKGROUND

Employees at many companies spend much of their time working on computers. An employer may monitor an employee's computer activity by installing a monitoring application program on the employee's work computer to monitor the employee's actions. For example, an employer may install a keystroke logger application on the employee's work computer. The keystroke logger application may be used to capture the employee's keystrokes and store the captured keystrokes in a text file for subsequent analysis.

### SUMMARY

Some embodiments provide for a method of using at least one trained machine learning (ML) model to identify a first process in a stream of event data, the method comprising: using at least one computer hardware processor to perform: receiving information corresponding to a stream of events corresponding to interactions between a user and one or more application programs executing on a computing device, the information comprising, for each particular event in the stream, metadata associated with the particular event, wherein metadata for the particular event specifies values for attributes of the particular event; organizing events in the stream of events into a plurality of windows of events, wherein each of the plurality of windows of events comprises one or multiple events in the stream of events; generating, using the at least one trained machine learning (ML) model, a respective plurality of numeric representations corresponding to the plurality of windows of events; determining a measure of similarity between each of the numeric representations in the plurality of numeric representations and one or more stored and previously-determined numeric representations of the first process to obtain a plurality of measures of similarity; and identifying, using the determined plurality of measures of similarity, the first process in the stream of events as comprising events in those windows, among the plurality of windows, whose determined measure of similarity to the one or more stored numeric representations of the first process was greater than a first threshold.

Some embodiments provide for a system, comprising at least one computer hardware processor; and at least one non-transitory computer-readable storage medium storing processor executable instructions that, when executed by the at least one compute hardware processor, cause the at least one computer hardware processor to perform a method of using at least one trained machine learning (ML) model to identify a first process in a stream of event data, the method comprising: receiving information corresponding to a stream of events corresponding to interactions between a user and one or more application programs executing on a computing device, the information comprising, for each particular event in the stream, metadata associated with the particular event, wherein metadata for the particular event specifies values for attributes of the particular event; organizing events in the stream of events into a plurality of windows of events, wherein each of the plurality of windows of events comprises one or multiple events in the stream of events; generating, using the at least one trained machine learning (ML) model, a respective plurality of numeric representations corresponding to the plurality of windows of events; determining a measure of similarity between each of the numeric representations in the plurality of numeric representations and one or more stored and previously-determined numeric representations of the first process to obtain a plurality of measures of similarity; and identifying, using the determined plurality of measures of similarity, the first process in the stream of events as comprising events in those windows, among the plurality of windows, whose determined measure of similarity to the one or more stored numeric representations of the first process was greater than a first threshold.

Some embodiments provide for at least one non-transitory computer-readable storage medium storing processor executable instructions that, when executed by at least one computer hardware processor, cause the at least one computer hardware processor to perform a method of using at least one trained machine learning (ML) model to identify a first process in a stream of event data, the method comprising: receiving information corresponding to a stream of events corresponding to interactions between a user and one or more application programs executing on a computing device, the information comprising, for each particular event in the stream, metadata associated with the particular event, wherein metadata for the particular event specifies values for attributes of the particular event; organizing events in the stream of events into a plurality of windows of events, wherein each of the plurality of windows of events comprises one or multiple events in the stream of events; generating, using the at least one trained machine learning (ML) model, a respective plurality of numeric representations corresponding to the plurality of windows of events; determining a measure of similarity between each of the numeric representations in the plurality of numeric representations and one or more stored and previously-determined numeric representations of the first process to obtain a plurality of measures of similarity; and identifying, using the determined plurality of measures of similarity, the first process in the stream of events as comprising events in those windows, among the plurality of windows, whose determined measure of similarity to the one or more stored numeric representations of the first process was greater than a first threshold.

It should be appreciated that all combinations of the foregoing concepts and additional concepts described in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF THE DRAWINGS

Various non-limiting embodiments of the technology will be described with reference to the following figures. It should be appreciated that the figures are not necessarily drawn to scale.

FIG. 1 is a block diagram including components of a process tracking system, according to some aspects of the technology described herein;

FIG. 2 illustrates a flowchart of acts for generating numeric representation(s) for a process and using the numeric representation(s) during process discovery in accordance with some aspects of the technology described herein;

FIG. 3 illustrates a flowchart of acts for generating numeric representation(s) of a process in accordance with some aspects of the technology described herein;

FIGS. 4A-4B illustrates flowcharts of acts for using stored numeric representation(s) of a process to identify the process in a stream of events, in accordance with some aspects of the technology described herein.

FIG. 5 is a block diagram 500 showing use of machine learning models for process discovery, in accordance with some aspects of the technology described herein;

FIG. 6A illustrates an annotated screenshot indicating examples of metadata associated with events corresponding to user interactions with a purchase order screen, in accordance with some aspects of the technology described herein;

FIG. 6B illustrates an annotated screenshot indicating examples of metadata associated with events corresponding to user interactions with a document, in accordance with some aspects of the technology described herein;

FIG. 7 schematically illustrates components of a computer that may be used to implement some embodiments;

FIG. 8 illustrates an example model trained on digital interactions and metadata from those interactions to learn and understand business context, in accordance with some aspects of the technology described herein;

FIG. 9 illustrates an example model architecture trained with generally available information that trains encoding layers, a model with a vector space tuned with business context and semantic similarity, and decoding layers for particular tasks, in accordance with some aspects of the technology described herein;

FIG. 10 illustrates example process templates used for training, in accordance with some aspects of the technology described herein;

FIG. 11 illustrates an example model architecture trained using synthetic data, in accordance with some aspects of the technology described herein;

FIG. 12 illustrates an output example for an exemplary input requesting a trend view of the past 6 months, in accordance with some aspects of the technology described herein;

FIG. 13 illustrates an example diagram in which many user interactions that are shown do not have business context associated to them, in accordance with some aspects of the technology described herein;

FIG. 14 illustrates an example diagram showing a descriptive version of what the user was conducting with a greater level of business understanding as compared to FIG. 13, in accordance with some aspects of the technology described herein;

FIG. 15 illustrates a screenshot where each repetitive pattern is given a generic name like Task-4174 or Task-3723, in accordance with some aspects of the technology described herein;

FIG. 16 is a screenshot clusters or groups based on the business intent, in accordance with some aspects of the technology described herein;

FIG. 17 is a screenshot showing repetitive patterns or activities that are related to the “Invoice updates” business intent, in accordance with some aspects of the technology described herein;

FIG. 18 is a screenshot illustrating exemplary activity cluster names with corresponding exemplary confidence scores, in accordance with some aspects of the technology described herein;

FIG. 19 illustrates an example diagram of how a process is normally expressed as a set of interactions/screen titles, in accordance with some aspects of the technology described herein;

FIG. 20 illustrates an example diagram of a more descriptive version of what the user was conducting with a greater level of business understanding as compared to FIG. 19, in accordance with some aspects of the technology described herein;

FIG. 21 is a screenshot illustrating a capability through which a user can ask questions about the business entities, in accordance with some aspects of the technology described herein;

FIGS. 22A-22C show screenshots illustrating examples of questions which can be asked by the user in the cost category and/or answers provided, in accordance with some aspects of the technology described herein;

FIGS. 23A-23B show screenshots illustrating examples of questions which can be asked by the user in the customer experience category and/or answers provided, in accordance with some aspects of the technology described herein;

FIGS. 24A-24I show additional screenshots illustrating examples of questions which can be asked by the user and/or answers provided, in accordance with some aspects of the technology described herein;

FIGS. 25A-25B are screenshots illustrating the user experience of creating or reporting on a purchase order using a business application, in accordance with some aspects of the technology described herein;

FIG. 26 is a diagram illustrating that different types of variations can each be classified to a family of variations, in accordance with some aspects of the technology described herein;

FIG. 27 is a screenshot illustrating new information that can be provided when interacting with the activity cluster related to a document due to the contextual understanding of the model, in accordance with some aspects of the technology described herein;

FIG. 28 is a screenshot displaying a list view of processes with high-level statistics about when they are discovered, in accordance with some aspects of the technology described herein;

FIG. 29 is a screenshot displaying a chart view of processes, in accordance with some aspects of the technology described herein;

FIG. 30 is a screenshot through which a process may be created, in accordance with some aspects of the technology described herein;

FIG. 31 is a screenshot displaying controls for filtering out process discovery results, in accordance with some aspects of the technology described herein;

FIG. 32 is a screenshot displaying taught process instances as flow graphs, in accordance with some aspects of the technology described herein;

FIG. 33 is a screenshot displaying a discovered variant of a process, in accordance with some aspects of the technology described herein;

FIG. 34 is a screenshot displaying side-by-side views of process flows once discovered, in accordance with some aspects of the technology described herein.

### DETAILED DESCRIPTION

Aspects of the technology described herein relate to improvements in robotic process automation technology. Generally, robotic process automation involves two stages: (1) an information gathering stage that involves identifying processes being performed by one or more users; and (2) an automation stage that involves automating these processes through software programs, sometimes referred to as “software robots,” which can perform the identified processes more efficiently thereby assisting the users and/or freeing them up to attend to other work.

In the automation stage, in some embodiments, the information collected during the information gathering stage may be employed to create software robot computer programs (hereinafter, “software robots”) that are configured to programmatically control one or more other computer programs (e.g., one or more application programs and/or one or more operating systems) to perform one or more tasks at least in part via the graphical user interfaces (GUIs) and/or application programming interfaces (APIs) of the other computer program(s). For example, an automatable task may be identified from the data collected during the information gathering stage and a software developer may create a software robot to perform the automatable task. In another example, all or any portion of a software robot configured to perform the automatable task may be automatically generated by a computer system based on the collected computer usage information. Some aspects of software robots are described in U.S. Pat. No. 10,474,313, titled “SOFTWARE ROBOTS FOR PROGRAMMATICALLY CONTROLLING COMPUTER PROGRAMS TO PERFORM TASKS,” granted on Nov. 12, 2019, filed on Mar. 3, 2016, which is incorporated herein by reference in its entirety.

The inventors have recognized that conventional techniques applied during the information gathering stage suffer from numerous drawbacks and can be improved upon. For example, some conventional techniques involve interviewing people to ask them how they perform certain computerized processes and the steps involved. However, this approach is very limited. Such interviews often result in information that is incorrect and unusable for automation. With respect to correctness, organizations rarely know which people are the ones performing certain processes, how long each of them takes to perform the process and, most importantly, interviewing reveals only high-level information (e.g., some of the application programs that may be used in performing the process), but not the low-level information needed to automate the process such as, for example, information indicating what low-level acts (e.g., mouse clicks, keystrokes, button presses) are performed in each application that is used, the screens and interfaces within each application that are used, and the order in which all the various acts (low- and high-level) are performed. Without such detailed information it is difficult, if not outright impossible, to generate a software robot to automate the process and have that software robot perform the desired process accurately. Additionally, interview-based approaches make it impossible to collect data for metrics (e.g., how long processes take to perform on average, how many users are involved, what is the value (e.g., savings and/or efficiency gained) of automating a particular process, etc.)

Other conventional methods have tried to address the above shortcomings of the interviewing approach through automated processing of log files generated by application programs that may be utilized by users when performing processes. However, such log-mining approaches have limited utility because they are supported for only a handful of application programs (e.g., SAP) that generate such logs, and because such logs still do not contain the right level of detail in the data from which processes may be reliably discovered and automated. For example, such logs may indicate which application programs are used, but not what the user did within each application program and in what order. These approaches monitor the overall system but do not collect user-level data and, as a result, do not have access to information such as, for example, how long it takes various users to perform the process, how many times the process performed across a large organization, click-level data, etc.

The inventors have appreciated that to address the above shortcomings of conventional approaches, one approach can be to collect low-level data such as click and keystroke data from multiple users for a period of time and analyze that data to discern or discover, in these data, instances of one or more processes being performed by the monitored users. The inventors recognized that conventional techniques do not involve collection of such data because it is noisy and voluminous requiring substantial computational and storage resources to handle (e.g., such data can include gigabytes of data per user per day and terabytes or petabytes of data across an enterprise per over days and weeks), and such data is difficult to analyze because it is noisy and disorganized. However, the inventors have developed techniques described herein for precisely doing this—the techniques described herein developed by the inventors allow for accurate, intuitive, and computationally efficient ways of processing low-level data (e.g., click and keystroke data across multiple applications) to identify processes being performed by multiple users in an enterprise (e.g., a business having tens, hundreds, thousands or even tens of thousands of users). These techniques constitute an improvement to robotic process automation technology.

There are various aspects of the techniques developed by the inventors that enable such voluminous low-level data to be analyzed efficiently and accurately. One aspect of the techniques developed by the inventors is the notion of “numerical representation(s)” of a process. Numerical representation(s) for a particular process can be used to rapidly process large volumes of low-level data gathered during user monitoring to identify instances of that particular process being performed by one or more users. The inventors have developed techniques that allow a process discovery software system to generate numerical representation(s) of a particular process. This is done through a teaching mechanism in which the process discovery software is placed into a “teaching mode” and one or more users perform one or more instances of the particular process while the process discovery software is capturing low-level data as the user interacts with his/her computing device using multiple different application programs, user interfaces of the application program(s), and the buttons, fields, and other user interface elements therein. In turn, the taught process instances may be used to generate the numeric representation(s) of the process, in accordance with the techniques described herein. The generated numeric representation(s) may be then used to discover, efficiently, other instances of the process from data collected by monitoring one or more other users (e.g., other users at an enterprise).

In some embodiments, the numeric representation(s) of a process may be compact and may contain a small amount of data relative to the data collected for a particular process instance. As a result, using the numeric representation(s) to identify process instances can be implemented efficiently, reducing the computational burden on the process discovery system. By contrast, recording a single process instance and attempting to correlate that process instance with volumes of data, would be computationally inefficient. In this sense, the techniques described herein provide an improvement to not only process discovery technology, but also to the functioning of a computer because they substantially reduce the amount of computational resources required to identify process instances while performing process discovery.

The inventors have recognized that process discovery can utilize numeric representation(s) of a process having different scales, for example, a fine-scale process representation in which numeric representations for each event associated with the process are utilized, or a coarse-scale process representation in which a single numeric representation obtained by averaging the numeric representations for each event associated with the process is utilized. Utilization of the fine-scale representation for process discovery is computationally intensive because it requires manipulation of numeric representations for every event that could be potentially part of a process, and there is a large number of such events (e.g., thousands, tens of thousands, hundreds of thousands of events) to be analyzed. On the other hand, utilization of the coarse-scale representation in which the entire process is represented by a single numeric representation may be efficient, but may in some instances perform poorly due to the information lost as part of generating the representation by averaging information across a large number of different events. To address these concerns, the inventors have developed techniques for organizing recorded events into windows of events and generating numeric representation(s) corresponding to the windows of events before correlating such representations against stored representations of taught processes (which may themselves be a single representation of an taught process instance or a collection of numeric representations of windows of events in the taught process instance). As such, the techniques described herein may utilize numeric representation(s) corresponding to windows of events having an intermediate scale (e.g., between the fine and coarse scale), which provides a balance between computational efficiency and a faithful representation of the process. Numeric representations of windows of events thereby provide that balance and contribute to strong process discovery performance of the techniques described herein.

The processes discovered using the process discovery techniques described herein can be used in different ways. For example, one or more visualizations of the process discovery results may be displayed to a user. As another example, the discovered processes may be automatically evaluated for automating using software (e.g., creation of software robots for automating the entire or a portion of the discovered process). In some embodiments, an automatable task may be identified from the discovered processes and all or a portion of a software robot configured to perform the automatable task may be manually or automatically created. As such, the techniques described herein also provide an improvement to not only process discovery technology but also robotic process automation technology that can utilize processes discovered by the process discovery technology.

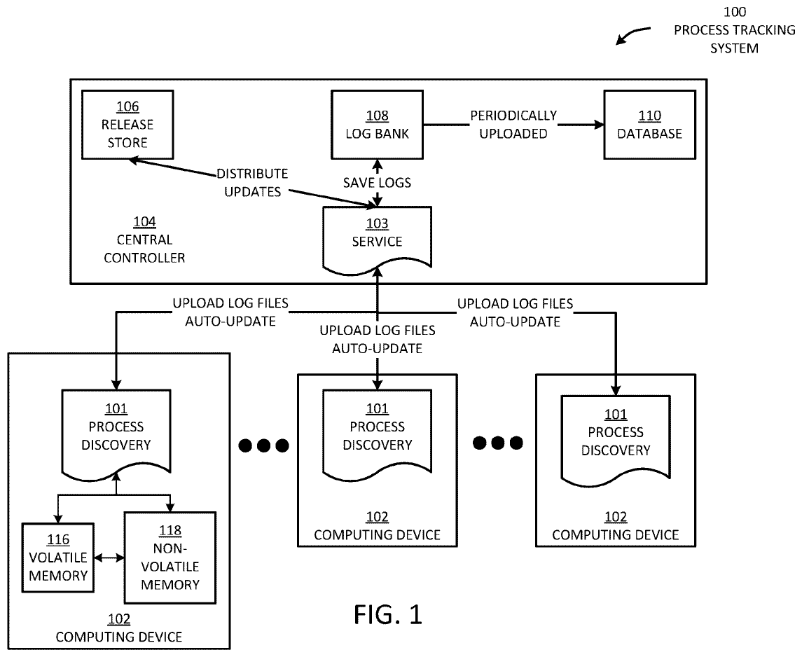

FIG. 1 shows an example process event tracking system 100, according to some embodiments. The process tracking system 100 is suitable to track one or more processes being performed by users on a plurality of computing devices 102. Each of the computing devices 102 may comprise a volatile memory 116 and a non-volatile memory 118. At least some of the computing devices may be configured to execute process discovery module 101 (also referred to herein as “Scout™” that tracks user interaction with the respective computing device 102. Process discovery module 101 may be, for example, implemented as a software application and installed on an operating system, such as the WINDOWS® operating system, running on the computing device 102. In another example, process discovery module 101 may be integrated into the operating system running on the computing device 102. As shown in FIG. 1, process tracking system 100 further includes a central controller 104 that may be a computing device, such as a server, including a release store 106, a log bank 108, and a database 110. The central controller 104 may be configured to execute a service 103 that gathers the computer usage information collected from the process discovery modules 101 executing on the computing devices 102 and store the collected information in the database 110. Service 103 may be implemented in any of a variety of ways including, for example, as a web-application. In some embodiments, service 103 may be a python Web Server Gateway Interface (WSGI) application that is exposed as a web resource to the process discovery modules 101 running on the computing devices 102.

In some embodiments, process discovery module 101 may monitor the particular tasks being performed on the computing device 102 on which it is running. For example, process discovery module 101 may monitor the task being performed by monitoring keystrokes and/or clicks and gathering contextual information associated with each keystroke and/or click. The contextual information may include information indicative of the state of the user interface when the keystroke and/or click occurred. For example, the contextual information may include information regarding a state of the user interface such as the name of the particular application that the user interacted with, the particular button or field that the user interacted with, and/or the uniform resource locator (URL) link in an active web-browser. The contextual information may be leveraged to gain insight regarding the particular task that the user is performing. For example, a software developer may be using the computing device 102 to develop source code and may be continuously switching between an application suitable for developing source code and a web-browser to locate code snippets. Unlike traditional keystroke loggers that would merely gather a string of depressed keys including bits of source code and web URLs, process discovery module 101 may advantageously gather useful contextual information such as the particular active application associated with each keystroke. Thereby, the task of developing source code may be more readily identified in the collected data by analyzing the active applications.

The data collection processes performed by process discovery module 101 may be seamless to a user of the computing device 102. For example, process discovery module 101 may gather the computer usage data without introducing a perceivable lag to the user between when one or more actions of a process are performed and when the user interface is updated. Further, process discovery module 101 may automatically store the collected computer usage data in the volatile memory 116 and periodically (or aperiodically or according to a pre-defined schedule) transfer portions of the collected computer usage data from the volatile memory 116 to the non-volatile memory 118. Thereby, process discovery module 101 may automatically upload captured information in the form of log files from the non-volatile memory 118 to service 103 and/or receive updates from service 103. Accordingly, process discovery module 101 may be completely unobtrusive on the user experience.

In some embodiments, the process discovery module 101 running on each computing device 102 may upload log files to service 103 that include computer usage information such as information indicative of one or more actions performed by a user on the respective computing device 102 and contextual information associated those actions. Service 103 may, in turn, receive these log files and store the log files in the log bank 108. Service 103 may also periodically upload the logs in the log bank 108 to a database 110. It should be appreciated that the database 110 may be any type of database including, for example, a relational database such as PostgreSQL. Further, the events stored in the database 110 and/or the log bank 108 may be stored redundantly to reduce the likelihood of data loss from, for example, equipment failures. The redundancy may be added by, for example, by duplicating the log bank 108 and/or the database 110.

In some embodiments, service 103 may distribute updates (e.g., software updates) to the process discovery modules 101 running on each of the computing devices 102. For example, process discovery module 101 may request information regarding the latest updates that are available. In this example, service 103 may respond to the request by reading information from the release store 106 to identify the latest software updates and provide information indicative of the latest update to the process discovery module 101 that issued the request. If the process discovery module 101 returns with a request to download the latest version, the service 103 may retrieve the latest update from the release store 106 and provide the latest update to the process discovery module 101 that issued the request.

In some embodiments, service 103 may implement various security features to ensure that the data that passes between service 103 and one or more process discovery modules 101 is secure. For example, a Public Key Infrastructure may be employed by which process discovery module 101 authenticates itself using a client certificate to access any part of the service 103. Further, the transactions between process discovery module 101 and service 103 may be performed over HTTPS and thus encrypted.

In some embodiments, service 103 makes the collected computer usage information in the database 110 and/or information based on the collected computer usage information (e.g., numeric representation(s) of a process as described in more detail below) available to users. For example, service 103 (or some other component in communication with service 103) may be configured to provide a visual representation of at least some of the information stored in the database 110 and/or information based on the stored information to one or more users (e.g., of computing devices 102). For example, a series of user interface screens that permit a user to interact with the computer usage data in the database 110 and/or information based on the stored computer usage data may be provided as the visual representation. These user interface screens may be accessible over the Internet using, for example, HTTPS. It should be appreciated that service 103 may provide access to the data in the database 110 through still yet other ways. For example, service 103 may accept queries through a command-line interface (CLI), such as psql, or a graphical user interface (GUI), such as pgAdmin.

Some embodiments relate to using user interaction information collected via one or more process discovery modules 101 to generate numeric representation(s) of a process that can then be used to identify instances of the process from captured data corresponding to further user interaction information collected via the one or more of the process discovery modules.

Various components in process tracker system 100 may be used to perform generation of numeric representation(s) in teaching mode and/or process discovery. In some embodiments, process discovery may be performed locally on individual computing devices 102 by process discovery modules 101, which may be updated with the most recent numeric representation(s) stored centrally by service 103 periodically, aperiodically or in response to a request from the computing device to provide an update. In some embodiments, process discovery may be performed centrally, with data collected by process discovery modules 101 executing on computing devices 102 being forwarded to service 103, and with service 103 performing process discovery on the received data (from computing devices 102) using the numeric representation(s). In some embodiments, process discovery results may be analyzed using one or more software tools as described herein, and the software tools may execute locally on one or more computing device(s) 102, centrally as part of service 103, and/or in any suitable combination of local and centralized processing.

Regardless of whether process discovery is performed locally, centrally, or in a combination of local and central processing, in some embodiments, process discovery results may be analyzed by any user.

It should be appreciated that the above-described architecture in which some functions are performed locally on computing devices 102 and other functions are performed centrally (e.g., on a server) is only one such embodiment, and various other architectures in which all functions (e.g., generation of numeric representation(s), process discovery, visualization, teaching, analysis of process discovery results) are performed locally, all functions are performed remotely, or a mixture of local and remote resources are used to perform the functions described herein are also contemplated as being part of the technology described herein.

In some embodiments, the discovered processes may be automatically evaluated for automating using software (e.g., creation of software robots for automating the entire or a portion of the discovered process). In some embodiments, an automatable task may be identified from the discovered processes and all or a portion of a software robot configured to perform the automatable task may be automatically created by the process tracking system 100.

In some embodiments, the process tracking system 100 may identify an automatable task based on an automation score generated by analyzing the metadata associated with events in the discovered processes. For example, the metadata may be analyzed to determine values for one or more parameters that impact automatability of a given task. Example parameters include but are not limited to, a number of applications employed to perform a task, a number of keystrokes performed in the task, a ratio between keystrokes and clicks performed in the task, and/or other parameters. In some embodiments, the process tracking system 100 may generate the automation score by combining (e.g., linearly combining) the values of these parameters. A determination may be made regarding whether the automation score exceeds a threshold. For example, a task with an automation score that exceeds the threshold may be a good candidate for automation. In response to a determination that the automation score exceeds a threshold, a software robot may be generated to perform the automatable task.

In some embodiments, a software robot that is configured to perform the automatable task may be generated. The software robot may be configured to control the same set of one or more computer programs employed in the task, The software robot may be generated in any of a variety of ways. In some embodiments, the software robot may be generated using, for example, a sequence of one or more events defining the automatable task. For example, the process tracking system 100 may comprise one or more predetermined software routines for replicating one or more events and the process tracking system 100 may combine these software routines in accordance with the defined sequence of events associated with the task to form a software robot that is configured to perform the task.

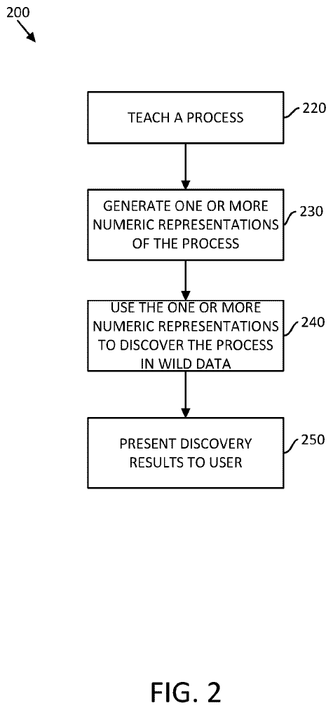

FIG. 2 illustrates a flowchart of a method 200 of acts for generating numerical representation(s) for a process and using the numerical representation(s) during process discovery in accordance with some embodiments. At least some of the acts of method 200 may be performed by any suitable computing device(s) and, for example, may be performed by one or more of the computing devices 102 shown in process tracking system 100 of FIG. 1.

In act 220, one or more users “teach” the process by performing a plurality of actions that collectively form the process while interactions between the user and their computing device are captured (e.g., by using a process discovery module 101 executing on the computing device). Each performance of the process by a user may be called an “instance” of the process, and the data captured during the user's performance of the instance may be stored in association with the instance (e.g., in association with an identifier corresponding to the instance of the process). Specifically, with respect to teaching, an instance performed during teaching may be called a “teaching instance” performed by a user, and a collection of instances taught by one or more users for a particular process may be called the “taught instances” for that process. The information captured during a user's performance of a teaching instance may be called a “stream of events,” a “plurality of events” or simply “events.” The events in a stream of events may correspond to individual keystrokes, clicks, etc. captured by the process discovery module during performance of the teaching instance.

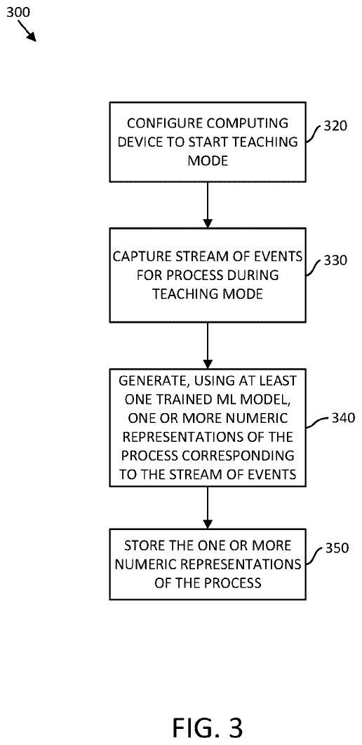

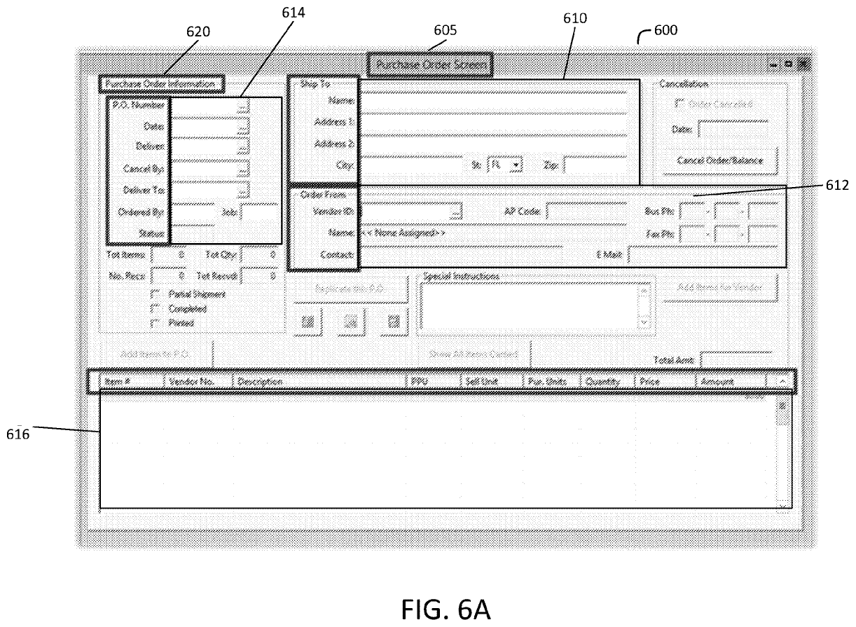

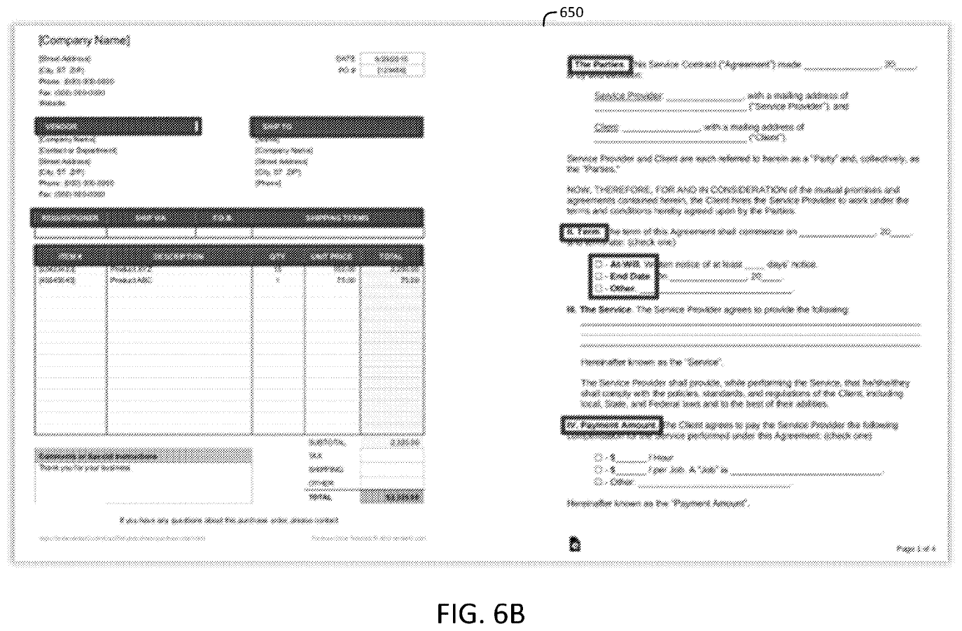

A “process” as that term is used herein, refers to a plurality of steps or user actions that are collectively performed to achieve a task. The task may be any suitable task that could be performed by a user (or multiple users) by interacting with one or more computing devices. The task, in some embodiments, may be any suitable task that one or more users perform in a business such as, for example, one or more accounting, finance, IT, human resources, purchasing and/or any other types of tasks. For example, a process may refer to a plurality of user actions that a user takes to perform the task of receiving a purchase order, reviewing the purchase order, and approving the purchase order. As another example, a process may refer to a plurality of user actions that a user takes to perform the task of opening an IT ticket for an issue (e.g., resetting a user's password), addressing the issue, and closing same (e.g., by resetting the password and notifying the user whose password was reset that this is completed). Some processes may include only a few (e.g., 2 or 3) user actions, whereas other processes may include more (e.g., tens, hundreds, or thousands) user actions. As described herein, a process is a unit of discovery that is searched for during “process discovery” to identify instances of the process in data other than training data, often referred to herein as “wild data” or “data in the wild.” In some embodiments, the “wild data” may be data captured during interaction between users and their computing devices. The data captured may include keystrokes, mouse clicks, and associated metadata described herein including with reference to FIGS. 3, 6A, and 6B. In turn, the captured data may be analyzed using the techniques described herein to identify instances of one or more processes being performed by the users. Examples of the types of data that may be captured are provided herein and in U.S. Pat. No. 10,831,450, titled “SYSTEMS AND METHODS FOR DISCOVERING AUTOMATABLE TASKS,” granted on Nov. 10, 2020, which is incorporated by reference herein in its entirety.

Method 200 then proceeds to act 230, where one or more numeric representations of the process may be generated based on the taught instances of the process. In some embodiments, the one or more numeric representations of the process may be generated using at least one trained machine learning model.

Method 200 then proceeds to act 240, where the generated numeric representation(s) is used to discover the process (referred to herein as “process discovery” or simply “discovery”) in wild data (i.e., data on which the process was not taught). Each identification of the process during process discovery may be called a “discovered instance” or “observed instance” of the process. Similar to data captured during performance of a teaching instance, the wild data may also correspond to a stream of events performed by a user, and process discovery may operate by discovering the process in the stream of events.

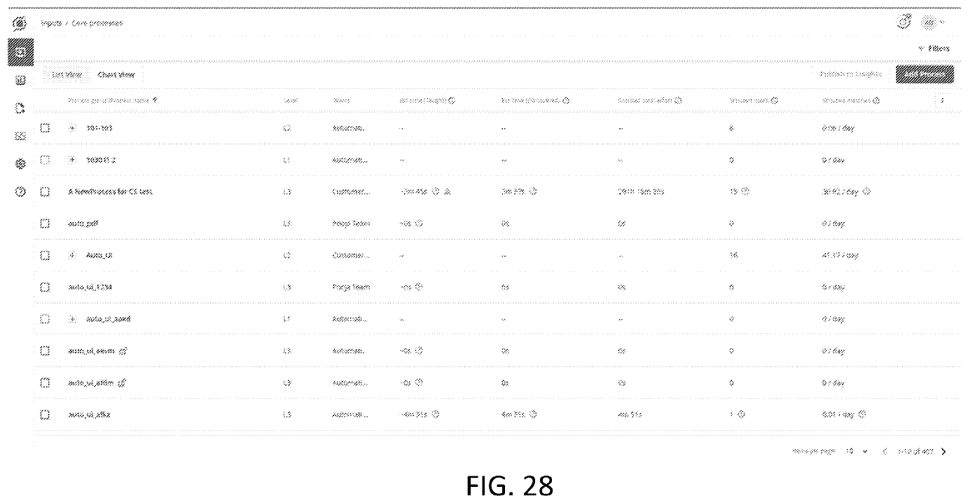

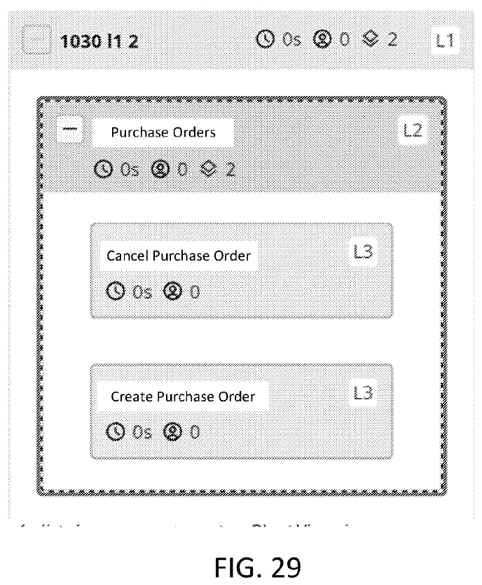

Following process discovery, method 200 proceeds to act 250, where the process discovery results are provided to the user. In some embodiments, one or more visualizations of the process discovery results may be displayed to a user to provide the user insight into whether process discovery for a particular process is operating in a manner that is consistent with the user's expectations. For example, FIG. 28 depicts a screenshot showing a list of processes and for each of the listed processes, details regarding estimated time taken to teach the process, estimated time taken to discover the process, and/or other details. As another example, FIG. 29 depicts a screenshot showing a chart view of processes, where some processes can be related and grouped together. As shown in FIG. 29, the chart view may include a top-level group “Purchase Orders” and inner groups such as “Cancel Purchase Order” and “Create Purchase Order”. Clicking on the “Cancel Purchase Order” tab or the “Create Purchase Order” tab may cause details about that process to be displayed.

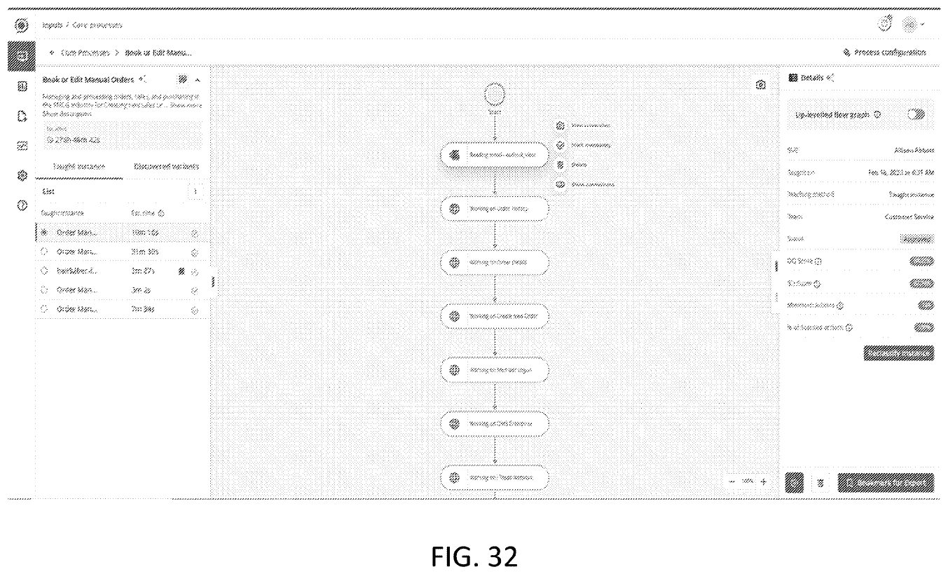

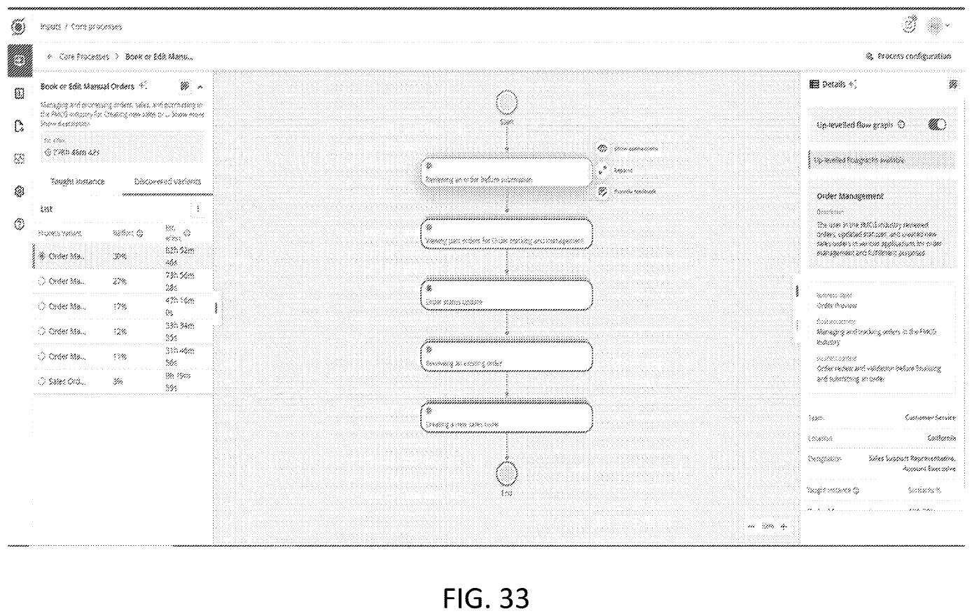

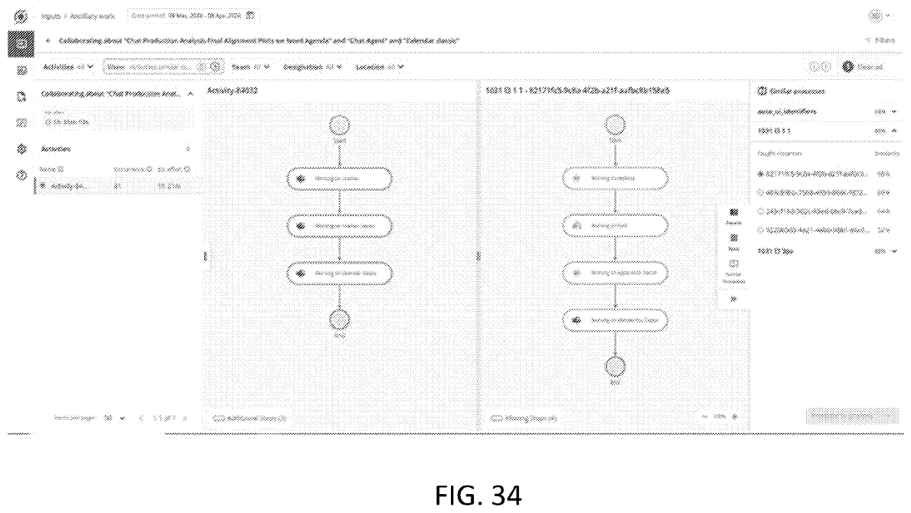

In some embodiments, a visualization, as shown in FIG. 33, of a discovered variant of a process (e.g., Book or Edit Manual Orders process) may be provided. On the left-hand side of the visualization, different variations may be selected from the list of discovered variants to view their particular execution flow through the process on the right-hand side of the visualization. In some embodiments, taught instances of the process may also be viewed by selecting the “Taught instance tab” as shown in FIG. 32. In some embodiments, a visualization, as shown in FIG. 34, may be provided where the visualization depicts side-by-side views of the process flows once discovered.

It should be appreciated that one or more of the acts of method 200 may be optional. For example, only acts 220 and 230 may be used, with the result being generation of numeric representation(s) of a process, and discovery may not be performed until the generated numeric representation(s) is approved for use. As another example, acts 220, 230, and 240 (or any subset of these acts) may be used, but results of process discovery may not be presented to a user or the process discovery results may be presented to a user at a later time. The data about discovered processes may be collected and stored for subsequent analysis and/or visualization.

As described in more detail below, in some embodiments, a user teaches an instance of the process by performing the process while a stream of events is collected as the process is performed. If the process is short enough, the user may teach an instance of the process by performing the process as they normally would by starting from the beginning of the process (possibly with manually starting capture of the stream of events-referred to herein as causing the computing device to enter a “training mode”), performing one or more actions included in the process, and concluding with a successful submission of a taught instance. Once the submission is complete, recording of the stream of events may be stopped (either manually by the user or automatically by the computing device of the user). For some longer processes that may be conducted across multiple sittings (e.g., a 3-hour process), the teaching instance of the process may be performed in parts and each part may be associated with an identifier (e.g., a transaction ID). For example, a user may teach a first part of an instance of a process at a first time, and the first part may be labeled with a process identifier and a particular transaction ID (e.g., “PO-12345”). The teaching instance may then be paused and resumed at a later time (e.g., at a second time), and the second part of the instance of the process may be associated with the same process identifier and transaction ID (e.g., “PO-12345”). A similar strategy may be used for processes that are conducted across multiple users and/or teams, where each user teaches a part of the process and each part is labeled with the same process identifier and transaction ID. In some embodiments, using the same transaction ID across multiple parts of the process may not be needed, for example, if the system is taught the various parts of the process a sufficient number of times to generate reliable numeric representation(s) of the process.

In some embodiments, the computer may be configured to enter a “teaching mode,” for a process which initiates collection of events during performance of a process. To generate training data a user may be instructed to teach a plurality of instances of a process (referred to herein as “teaching instances”). The computer may be configured to start the teaching mode to begin capturing events and associated metadata for the process.

FIG. 3 illustrates a flowchart of a method 300 for capturing a stream of events when a computer is configured to implement a teaching mode and generating numerical representation(s) of a process in accordance with some embodiments. At least some of the acts of method 300 may be performed by any suitable computing device(s) and, for example, may be performed by one or more of the computing devices 102 shown in process tracking system 100 of FIG. 1.

In act 320, the computing device is configured to start a teaching mode. In some embodiments, the computing device is configured to start the teaching mode in response to an indication to start the teaching mode. For example, a user may interact with a user interface presented by an application executing on the computer to provide an indication to start the teaching mode.

Method 300 then proceeds to act 330, where a stream of events for one or more processes is captured while the computer is configured to be in the teaching mode. The stream of events corresponds to interactions between a user and one or more application programs executing on a computing device. The events collected while the user interacts with the computer during performance of a process may be considered a stream of events sorted with respect to the time at which the events occurred during performance of the process.

Information corresponding to the stream of events may be collected in any suitable way. In some embodiments the information may be collected as a user interacts with a computer. For instance, an application (e.g., process discovery module 101 shown in FIG. 1) may be installed on the user's computer that collects data as the user interacts with the computer to perform a process. In some embodiments, each user interaction such as a mouse click, keyboard key press, or voice command that a user performs may be considered as an “event.” For each event, metadata associated with the event may be collected. Aspects of the collecting information as the user interacts with a computer are described herein and in U.S. Pat. No. 10,831,450, titled “SYSTEMS AND METHODS FOR DISCOVERING AUTOMATABLE TASKS,” granted on Nov. 10, 2020, which is incorporated by reference herein in its entirety. Examples of metadata that may be collected for each event include, but are not limited to:
Application (e.g., the name of an application program, such as an operating system (e.g., Microsoft Windows, Mac OS, Linux) application, a web application, or a mobile application)
Screen Title (e.g., the title appearing on an application program screen such as the name of the tab in a web browser, the name of a file open in an application, etc.)
Element Identifier(s) (e.g., identifier(s) of user interface element(s) of the application program screen with which the user interacted and/or identifier(s) for user interface element(s) of the application program screen with which the user did not interact)
Element Type (e.g., the type of a user interface element of the application program screen with which the user interacted, such as “button”, “input”, “dropdown” etc.)
Element Name (e.g., the name of a user interface element of the application program screen with which the user interacted such as a name of a button, label of input, etc.)
Duration of the interaction
One or more textual phrases and/or sentences appearing on the application program screen (e.g., subject and body of emails in an email application (e.g., Outlook); content of a spreadsheet or document, such as, a list of special words that are colored, italicized, bolded or highlighted, in the spreadsheet or document application (e.g., Excel, Word, Adobe reader); text displayed on the screen of a mainframe application, etc.)

In some embodiments, metadata associated with an event may additionally include an event identifier. The event identifier may be in any suitable format, such as, numeric, alphanumeric, or other format. For example, an event identifier may be combination of digits, alphabets, and special characters, such as, underscore.

FIG. 6A illustrates an annotated screenshot indicating examples of metadata associated with events corresponding to user interactions with a purchase order screen 600, in accordance with some aspects of the technology described herein. As shown in FIG. 6A, the metadata includes the title of the screen 605 (e.g., Purchase Order Screen), element identifiers, types (e.g., dropdowns, input, etc.) and names (e.g., P.O. Number, Date, Name, Address, etc.) associated with user interface elements 610, 612, 614, and 616 with which the user interacted, and/or element identifier for user interface element 620 with which the user did not interact.

FIG. 6B illustrates an annotated screenshot indicating examples of metadata associated with events corresponding to user interactions with a document 650, in accordance with some aspects of the technology described herein. As shown in FIG. 6B, the metadata includes textual phrases, sentences, highlighted sections, etc. in the document with which the user interacted.

In some embodiments, the metadata for each particular event specifies values for attributes of the particular event. For example, entering an address in an address field shown in FIG. 6A may cause the following information (attribute value pairs) to be captured as metadata. It will be appreciated that the following list is not exhaustive and other information may be captured without departing from the scope of this disclosure.
Application—Purchase Order
Screen Title—Purchase Order Screen
Element Type—Input field
Element Name—Address 1

As another example, interacting with the document shown in FIG. 6B (e.g., clicking a save button) may cause the following information to be captured as metadata. It will be appreciated that the following list is not exhaustive and other information may be captured without departing from the scope of this disclosure.
Application—Word
Document Title—Service Contract
Element Type—Button
Element Name—Save
Text—Parties heading and associated text; Term heading and associated text; Payment Amount heading and associated text.

In some embodiments, at least some of the metadata associated with the stream of events may be processed using a first trained ML model. This portion of metadata may include attribute values that do not include natural language text and/or complex values such as textual phrases, sentences, paragraphs, etc. For instance, the first portion of metadata may include attribute values described above in relation to FIG. 6A. In some embodiments, the first trained ML model may include an encoder including a trained neural network having a transformer-based architecture, though it should be appreciated that one or more other types of neural network architectures may be used in other embodiments. For example, the first trained ML model may include an encoder including a trained neural network having a BERT model architecture or a RoBERTa model architecture.

In some embodiments, at least some other of the metadata associated with the stream of events may be processed using a second trained ML model. This portion of metadata may include attribute values that include natural language text and/or complex values such as textual phrases, sentences, paragraphs, etc. For instance, the second portion of metadata may include some of the attribute values (e.g., text) described above in relation to FIG. 6B. In some embodiments, the second trained ML model may include an encoder including a trained neural network having a transformer-based architecture, though it should be appreciated that one or more other types of neural network architectures may be used in other embodiments. For example, the second trained ML model may include an encoder having a trained neural network having a Sentence-BERT architecture.

Referring back to FIG. 3, in act 340, one or more numeric representations of the process corresponding to the stream of events may be generated using at least one trained machine learning model. In some embodiments, the one or more numeric representations of the process may include a single numeric representation of the process corresponding to the stream of events. The single numeric representation of the process may be generated by processing at least some of the metadata associated with the stream of events using the first trained ML model and at least some other of the metadata associated with the stream of events using the second trained ML model.

In some embodiments, the one or more numeric representations of the process may include multiple (e.g., two or more) numeric representations of the process, where each of the multiple numeric representations corresponds to one or multiple events in the stream of events. At least some metadata associated with the one or multiple events may be processed using the first trained ML model and at least some other metadata associated with the one or multiple events may be processed using the second trained ML model.

In some embodiments, each of the multiple numeric representations corresponds to a window of events including the one or more multiple events in the stream of events. Any suitable windowing technique may be used to organize events in the stream of events into a plurality of windows, where each window includes the one or multiple events. In some embodiments, one or more windowing parameters such as, time, number of events, or number or sequence of actions may be used to split the stream of events into smaller subsets or windows of events. For example, each set of events in the stream that is associated with a number of consecutive user actions (e.g., 2, 3, 4, 5, or other suitable number of consecutive actions) performed by the user may be organized into a window. As another example, each set of events in the stream that is associated with a particular timeframe (e.g., 10 seconds, 20 seconds, 30 seconds, 40 seconds, 50 seconds, 1 minute, 2 minutes, or other suitable timeframe) may be organized into a window. As yet another example, each set number of events (e.g., 5, 10, 15, 20, 25, 30, or any other suitable number) in the stream may be organized into a window.

The method proceeds to act 350, where the one or more numeric representations of the process may be stored. For example, the one or more numeric representations generated for each taught process may be stored in database 110. In some embodiments, the one or more numeric representations are stored in a database with vector indexing capabilities such that a vector search can be performed to find representations that are most similar to known representations.

As described herein, some embodiments relate to generating numeric representation(s) of a process based on teaching conducted by one or more users. The generated numeric representation(s) of processes are then used to discover the process and one or more process variations in wild data on which teaching has not been conducted.

Although in some embodiments collecting information for a stream of events during performance of a process may be performed by a specialized application (e.g., process discovery module 101 shown in FIG. 1) for capturing events executing on a computer as the user performs the process, in other embodiments, the information for a stream of events may be collected by one or more other applications (e.g., the native applications with which the user is interacting to perform the process). For example, the one or more other applications may log events (e.g., in a log file) that occur during user interactions with the application(s) and receiving the information for the stream of events may be accomplished by receiving one or more of such log files that includes the events and their associated metadata.

The inventors have recognized that any particular process may be performed in different ways both by the same user and across different users, resulting in multiple variations of the process. To ensure that inter- and intra-user variations of performing processes is taken into account, each of multiple users may be asked to provide training data for multiple instances of a process (i.e., multiple teaching instances performed by each of multiple users). Any suitable number of taught instances of a process (e.g., three taught instances of a process performed by three different users) may be used, and embodiments are not limited in this respect. Also, multiple processes may be taught by multiple users belonging to an organization or team within the organization resulting in multiple numeric representations of processes to be stored in the system. For example, in practice, the system may store may (e.g., 1-10, 5-20, 10-30, 50-100, etc.) numeric representations for a process or across various processes.

Teaching a process in accordance with some embodiments is typically performed on the computing device of the user that is teaching the process, which may be where the applications needed to perform one or more actions associated with performance of the process reside. The applications may be implemented as thick clients on the desktop of the user's computing device, may be implemented as web applications that the user is accessing through a browser, or a combination of thick and thin (e.g., web-based) applications. In some instances, the applications needed to perform one or more actions associated with performance of a process may be virtualized to be interactable from the user's computing device using virtualization techniques known in the art.

As the user is teaching an instance of the process by interacting with different business applications, events and their metadata are collected as described above in connection with FIGS. 2-3. The events and associated metadata may be stored locally on the computing device of the user or sent to a server over one or more networks (e.g., using the system architecture described in connection with FIG. 1). However, it should be appreciated that the events need not be collected by a remote service in all embodiments and can be used directly on the computing device of the user for discovering processes in wild data.

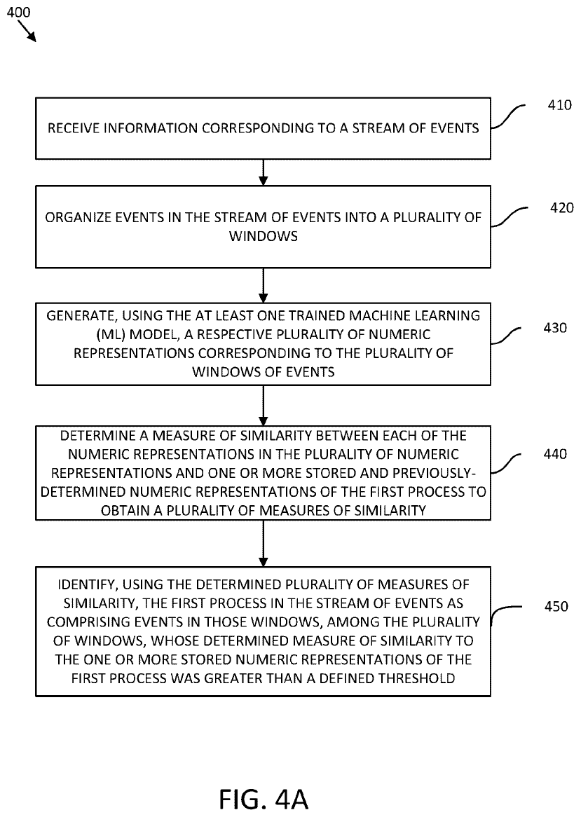

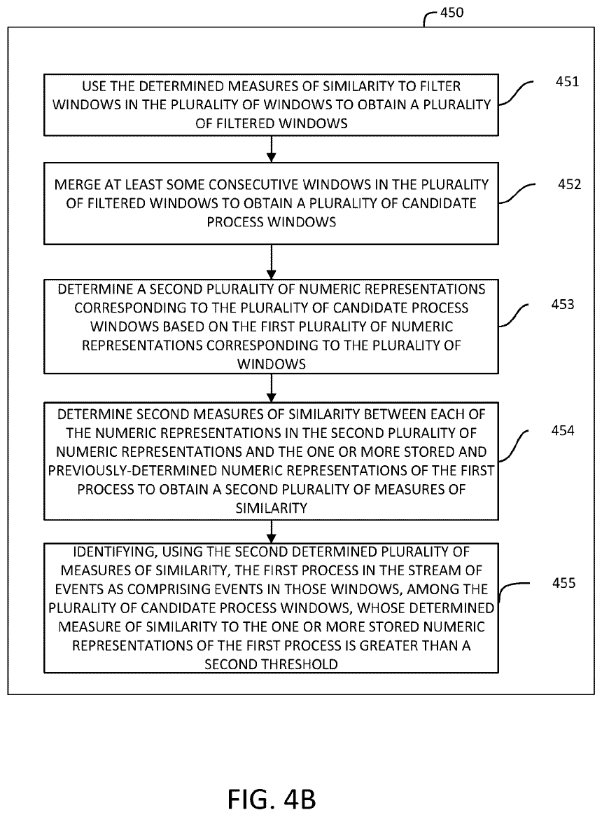

As described herein, process discovery refers to techniques for discovering a process after that process has been taught during training and generation of numerical representation(s) of the taught process. FIGS. 4A-4B illustrate a flowchart of a process discovery method 400 for using stored numeric representation(s) for a process to identify the process in wild data. At least some of the acts of method 400 may be performed by any suitable computing device(s) and, for example, may be performed by one or more of the computing devices 102 shown in process tracking system 100 of FIG. 1.

In act 410, information corresponding to a stream of events may be received. The information corresponding to a stream of events may correspond to interactions between a user and one or more application programs executing on computing device 102. The information may include, for each particular event in the stream, metadata associated with the particular event, where the metadata for the particular event specifies values for attributes of the particular event. Examples of metadata are described herein including with reference to FIGS. 3, 6A and 6B. In some embodiments, the information may be collected from a single user or a user part of a team of users whose computer interactions are being captured and analyzed to identify one or more processes being performed by the user and/or team of users.

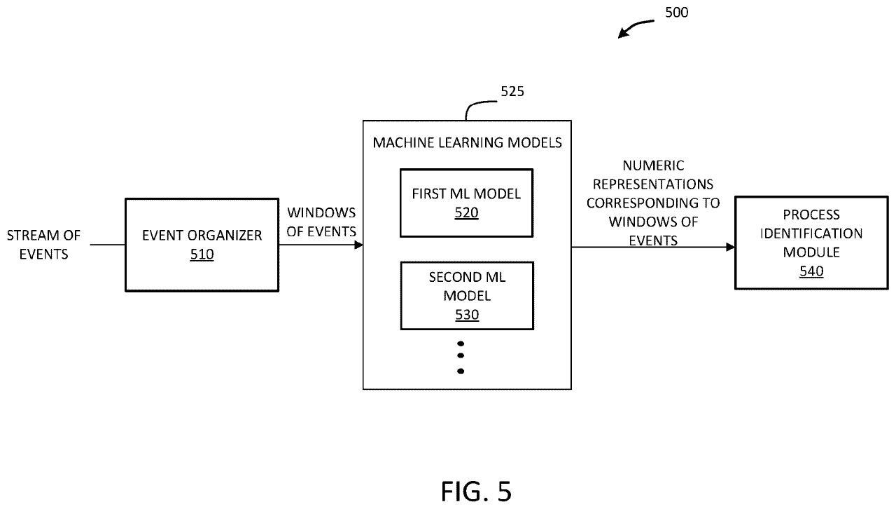

Method 400 then proceeds to act 420, where events in the stream of events may be organized into a plurality of windows of events. In some embodiments, each of the plurality of windows of events includes one or multiple events in the stream of events. In some embodiments, each window of events may be associated with one or more event identifiers. In some embodiments, process discovery module 101 may include an event organizer 510, as shown in FIG. 5, that receives information corresponding to a stream of events and organizes events in the stream of events in a plurality of windows of events. In some embodiments, the windows of events may be overlapping (e.g., meaning that the same event may be associated with two or more windows) and in other embodiments the windows may not be overlapping, as aspects of the technology described herein are not limited in this respect.

Any suitable windowing technique may be used to organize the events in the stream of events into the plurality of windows. In some embodiments, one or more windowing parameters such as, time, number of events, or number or sequence of actions may be used to split the stream of events into smaller subsets or windows of events. For example, each set of events in the stream that is associated with a number of consecutive user actions (e.g., 2, 3, 4, 5, or other suitable number of consecutive actions) performed by the user may be organized into a window. As another example, each set of events in the stream that is associated with a particular timeframe (e.g., 10 seconds, 20 seconds, 30 seconds, 40 seconds, 50 seconds, 1 minute, 2 minutes, or other suitable timeframe) may be organized into a window. As yet another example, each set number of events (e.g., 5, 10, 15, 20, 25, 30, or any other suitable number) in the stream may be organized into a window.

In some embodiments, the same windowing scheme used during the teaching mode may be used to organize the events into windows during process discovery.

Method 400 the proceeds to act 430, where a respective plurality of numeric representations corresponding to the plurality of windows of events may be generated using at least one trained machine learning model. In some embodiments, as shown in FIG. 5, metadata associated with the windows of events may be processed using machine learning models 525 to generate the respective plurality of numeric representations corresponding to the plurality of windows of events.

In some embodiments, the at least one trained machine learning model includes a first trained ML model, for example, first trained ML model 520 shown in FIG. 5. In some embodiments, each window of events may include a plurality of events and a numeric representation of the window may be generated by processing at least some of the metadata associated with events in the plurality of events using the first trained ML model 520.

In some embodiments, generating a numeric representation of a window of events may include generating a numeric embedding of each event of the plurality of events in the window using the first trained ML model to obtain a plurality of numeric embeddings corresponding to the plurality of events. In some embodiments, generating the numeric embedding for each event comprises generating the numeric embedding of the event by processing its associated metadata with the first trained ML model.

In some embodiments, generating the numeric embedding of the event by processing its associated metadata with the first trained ML model comprises generating a textual event representation of the event using the values of the attributes specified in the metadata associated with the event, tokenizing the textual event representation to obtain a tokenized event representation, determining an initial numeric encoding of the tokenized event representation, and processing the initial numeric encoding with the first trained ML model to obtain the numeric embedding of the event.

An example of metadata associated with an event (e.g., interaction with an Order field in an SAP application screen) is shown below, where the metadata comprises attributes and values of the attributes.

| | | | | |
|---|---|---|---|---|
| Attributes | Application | Screen Title | Element Type | Element Name |
| Values | sap | SAP Easy | Guictextfield | Order |
| | | Access | | |

A textual representation of the event generated using the values of these attributes may be sap_->_SAP_Easy_Access_->_Guictextfield_->_Order. In some embodiments, the textual representation may be generated by following the steps below, although other textual representation formats may be used:
Within an event, all the different attributes are concatenated with the token ‘->’
Within an attribute, all spaces are replaced with ‘_’
Events are separated by spaces
Independent user days of events are separated by new line characters

In some embodiments, the special characters are different kinds of delimiters which are uniquely defined as special tokens in a tokenizer.

A tokenized event representation generated by tokenizing the textual representation above may be [‘s’, ‘ap’, ‘_’, ‘->’, ‘_’, ‘S’, ‘AP’, ‘_’, ‘Easy’, ‘_’, ‘Access’, ‘_’, ‘->’, ‘_’, ‘Gu’, ‘ic’, ‘text’, ‘field’, ‘_’, ‘=>’, ‘_’, ‘Order’]. Any suitable tokenizing algorithm may be used to generate the tokenized event representation.

In some embodiments, an initial numeric encoding of the tokenized event representation above may be determined. The initial numeric encoding may be [0, 29, 1115, 1215, 46613, 1215, 104, 591, 1215, 43361, 1215, 35505, 1215, 46613, 1215, 14484, 636, 29015, 1399, 1215, 46613, 1215, 45613, 2]. In some embodiments, determining the initial numeric encoding may include determining a byte pair encoding (BPE) of the tokenized event representation. Each token may have a corresponding ID that is determined via byte pair encoding (BPE). BPE is typically used by tokenizers of BERT based models. For example, a RoBERTa tokenizer may be used to tokenize the textual representation and generate the initial numeric encoding.

In some embodiments, the numeric embedding of the event may be obtained by processing the initial numeric encoding above with the first trained ML model. In some embodiments, the BPE may be converted to a numeric embedding using an embedding layer of the BERT based model.

In some embodiments, the first trained ML model may include an encoder including a trained neural network having a transformer-based architecture, such as, a BERT model architecture described in Devlin et. al., “BERT: Pre-training of Deep Bidirectional Transformers for Language Understanding,” Computation and Language, arXiv: 1810.04805, May 2019 or a RoBERTa model architecture described in Liu et al., “A Robustly Optimized BERT Pretraining Approach,” Computation and Language, arXiv: 1907.11692, July 2019, both of which are incorporated by reference herein in their entirety). In some embodiments, a trained ML model that is a variation of the BERT and/or RoBERTa models may be used, as aspects of the technology described herein are not limited in this respect.

In some embodiments, RoBERTa may use the same transformer-based architecture as BERT, which comprises several layers of multi-headed attention and feed-forward neural networks. However, RoBERTa may implement some optimizations to improve pretraining such as dynamic masking, omitting the next sentence prediction task and increasing the batch size. This modification may allow RoBERTa to capitalize on larger training datasets and longer training durations, enhancing its ability to learn the underlying structure in the data, capturing complex linguistic patterns and nuances.

In some embodiments, RoBERTa may operate by first tokenizing input text into sub-word or word tokens, each mapped to a high-dimensional embedding vector. These embeddings may then be fed into transformer blocks, where multi-head self-attention mechanisms and position-wise feed-forward networks refine the contextualized representations of tokens. By iteratively encoding the input sequence through multiple transformer blocks, RoBERTa may capture semantic and structural intricacies in the data. A pooling strategy may be employed to aggregate contextualized token embeddings into a fixed-size vector representation for the entire input sequence. This final representation may serve as input for downstream applications.

In some embodiments, the first trained ML model is configured to process the first portion of the metadata that includes attribute values that do not include natural language text and/or complex values such as textual phrases, sentences, paragraphs, etc. Examples of such attribute values are described in relation to FIG. 6A.

In some embodiments, the at least one trained machine learning model includes a second trained ML model different from the first trained ML model, for example, second trained ML model 530 shown in FIG. 5. In some embodiments, each window of events may include a plurality of events and a numeric representation of the window may be generated by processing at least some of the metadata associated with events in the plurality of events using the first trained ML model 520 and at least some other of the metadata associated with events in the plurality of events using the second trained ML model 530.

In some embodiments, generating a numeric embedding of each event of the plurality of events in the window may include generating a first numeric embedding of the event by processing a first portion of the metadata associated with the event with the first trained ML model and generating a second numeric embedding of the event by processing a second portion of the metadata associated with the event with the second trained ML model.

In some embodiments, the second trained ML model is configured to process the second portion of the metadata that includes attribute values that include natural language text and/or complex values such as textual phrases, sentences, paragraphs, etc. Examples of such attribute values are described in relation to FIG. 6B.

In some embodiments, the second trained ML model may include an encoder having a trained neural network having a Sentence-BERT architecture described in Reimers et. al., “Sentence-BERT: Sentence Embeddings using Siamese BERT-Networks,” Computation and Language, arXiv: 1908.10084, August 2019, which is incorporated by reference herein in its entirety. Sentence-BERT is a modification of the pretrained BERT network that use siamese and triplet network structures to derive semantically meaningful sentence embeddings that can be compared using cosine-similarity. Sentence-BERT is pretrained on natural language data

In some embodiments, the first numeric embedding output from the first trained ML model may be a first multi-dimensional embedding (e.g., an embedding having 768 dimensions) and the second numeric embedding output from the second trained ML model may be a second multi-dimensional embedding (e.g., an embedding having 384 dimensions). In some embodiments, the first and second numeric embeddings may be concatenated to generate the numeric embedding of the event. For example, the numeric embedding of the event may be a multi-dimensional embedding obtained by concatenating the first and second multi-dimensional embeddings (e.g., 768+384=1152-dimensional embedding). This numeric embedding contains data about different attributes associated with the event including some attributes that are associated with natural language text and others that are not.

For example, metadata associated with an event corresponding to an interaction with an email application (e.g., clicking the send button to send an email message) may specify values for the following attributes: application, element name, element type, and text. The value of the application attribute may be “Outlook”, the value of the element name attribute may be “Send”, the value of the element type attribute may be “Button”, and the value of the text attribute may be “Email body” which includes natural language text. For this example, a first portion of the metadata (e.g., values of the first three attributes—application, element name, and element type) associated with the event may be processed with the first trained ML model to generate a first numeric embedding of the event and a second portion of the metadata (e.g., value of the fourth attribute—text) associated with the event may be processed with the second trained ML model to generating a second numeric embedding of the event. These first and second numeric embeddings may be concatenated to generate a numeric embedding for the event.

In some embodiments, the attribute values (e.g., email bodies, paragraphs in a document) associated with the second portion of the metadata may be pre-processed prior to generating the numeric embedding of the event. The inventors have recognized that some events may be associated with metadata including similar values for certain attributes (e.g., the “text” attribute including natural language text) and it may be beneficial to preprocess these events by applying clustering techniques. For example, when interacting with an email application to send or reply to a message, the body of the email during both these events may be similar. In some embodiments, the attribute values (e.g., email bodies) associated with both these events may be processed using the Sentence-BERT model to generate corresponding embeddings. Based on these embeddings, clustering may be performed to merge together attribute values that are similar. The attribute values for each event may then then mapped to the attribute value of the corresponding cluster medoids before forming the textual event representation. For example, considering two email events with representations “outlook_->_Email_Body_One_->_Button_->_Send” and “outlook_->_Email_Body_Two_->_Button_->_Reply”. If these events are preprocessed by applying clustering to the email bodies, and assuming that both email bodies are clustered into one group and its medoid is “Email Body One”, then the textual event representations for these events would be modified to “outlook_->_Email_Body_One_->_Button_->_Send” and “outlook_->_Email_Body_One_->_Button_->_Reply”.

In some embodiments, the plurality of numeric embeddings corresponding to the plurality of events in the window of events may be combined to obtain the numeric representation of the window of events. In some embodiments, combining the plurality of numeric embeddings may include averaging the plurality of numeric embeddings to obtain the numeric representation of the window of events. In other embodiments, combining the plurality of numeric embeddings may include determining a weighted average of the plurality of numeric embeddings to obtain the numeric representation of the window of events. Determining the weighted average may include weighting the plurality of numeric embeddings based on durations of the plurality of events from which the plurality of numeric embeddings were derived.

In some embodiments, the techniques described in acts 410, 420, and 430 may be performed when generating numeric representation(s) of a process in the teaching mode described in FIG. 3. Generating the numeric representation(s) of the process in the teaching mode may also include generating a numeric embedding of each of the events in the stream of events or window of events, where generating the numeric embedding may include generating a first numeric embedding of the event by processing a first portion of the metadata associated with the event with the first trained ML model and generating a second numeric embedding of the event by processing a second portion of the metadata associated with the event with the second trained ML model.

Method 400 then proceeds to act 440, where a measure of similarity between each of the numeric representations in the plurality of numeric representations (corresponding to the plurality of windows of events) and one or more stored and previously-determined numeric representations of the process (e.g., numeric representation(s) generated as part of the teaching mode described in relation to FIG. 3) may be determined to obtain a plurality of measures of similarity. In some embodiments, determining the measure of similarity may include determining a cosine similarity between each of the numeric representations and the one or more stored and previously-determined numeric representations of the process. In some embodiments, a similarity score may be obtained by computing the cosine similarity between the numeric representations of the windows and the numeric representations of the taught process. The similarity score may be a value between 0-1, a higher score indicating a better match than a lower score.

In some embodiments, a measure of similarity between each of the numeric representations in the plurality of numeric representations and a single stored and previously-determined numeric representation of the process may be determined to obtain a plurality of measures of similarity. In these embodiments, a numeric representation of each of the plurality of windows of events is compared with the stored numeric representation of the process. As part of this comparison, the ith dimension of the numeric representation may be compared to the ith dimension of the stored numeric representation. In other words, the dimensions that embed the first portion of the metadata are compared to one other and the dimensions that embed the second portion of the metadata are compared to one another. This comparison makes process discovery extendable and capable of using data from multiple domains.

In some embodiments, a measure of similarity between each of the numeric representations in the plurality of numeric representations and each of multiple stored and previously-determined numeric representation of the process may be determined. In these embodiments, a numeric representation of each of the plurality of windows of events is compared with each stored numeric representation of the process. As part of this comparison, the ith dimension of the numeric representation may be compared to the ith dimension of each stored numeric representation of the process. In some embodiments, where the stored representation of a taught process instance is a collection of numeric representations of windows of events in the taught process instance, measures of similarity may be determined between the numeric representations of windows of events in the taught process instance and the numeric representations of windows of events generated at act 430. An example measure of similarity between numeric representations corresponding to window 0 may be computed as similarity (numeric representation of taught window 0, numeric representation of discovery window 0).

Method 400 then proceeds to act 450, where the determined plurality of measures of similarity may be used to identify the process in the stream of events as comprising events in those windows, among the plurality of windows, whose determined measure of similarity to the one or more stored numeric representations of the process was greater than a first threshold (0.7 or 70%). Any suitable first threshold may be used.

In some embodiments, identifying the process in the stream of events in act 450 may include acts 451, 451, 453, 454, and 455 of FIG. 4B. In some embodiments, process discovery module 101 may include a process identification module 540, as shown in FIG. 5, that is configured to identify the process in the stream of events. In some embodiments, while FIGS. 3, 4A, and 4B describe process teaching and discovery for one process, it may be appreciated that the techniques described herein may be performed for multiple processes performed by multiple members of a team or an organization.

In act 451, the determined measures of similarity may be used to filter windows in the plurality of windows to obtain a plurality of filtered windows. In some embodiments, any window whose determined measure of similarity to the one or more stored numeric representations of the process is below a predetermined filtering threshold (e.g., 0.3 or 30%) may be discarded. In some embodiments, the numeric representations of all the windows may be compared with numeric representations of multiple taught processes of a team and similarity scores may be computed for each comparison. For every window and taught process combination, a combination with the highest similarity score may be determined, where the highest similarity score is produced by the closest taught process to the window. If the highest similarity score is above a predetermined filtering threshold, then the window associated with that window-taught process combination is stored as a filtered window.

In act 452, at least some consecutive windows in the plurality of filtered windows may be merged to obtain a plurality of candidate process windows. If any two filtered windows are consecutive, then the filtered windows may be merged to create a candidate process window. For example, if a filtered window of a given user-day is made of steps or actions 0-3 and another filtered window from the same user-day is made of steps or actions 4-7, then these filtered windows may be merged to create a candidate process window made of steps or actions 0-7.

In act 453, a second plurality of numeric representations corresponding to the plurality of candidate process windows may be determined based on the first plurality of numeric representations corresponding to the plurality of windows. In some embodiments, the numeric representations of the consecutive filtered windows may be combined to obtain a numeric representation of the candidate process window. In some embodiments, a numeric representation for the candidate process window may be determined by averaging or weighted averaging of numeric representations of the filtered windows.

In act 454, second measures of similarity between each of the numeric representations in the second plurality of numeric representations and the one or more stored and previously-determined numeric representations of the process may be determined to obtain a second plurality of measures of similarity.

In act 456, the second determined plurality of measures of similarity may be used to identify the process in the stream of events as comprising events in those windows, among the plurality of candidate process windows, whose determined measure of similarity to the one or more stored numeric representations of the first process is greater than a second threshold (e.g., 0.8 or 80%). Any suitable second threshold may be used.

Process instances identified and labeled as a particular taught process using process discovery techniques as described herein include variations of the process due to the similarity matching being an approximate match rather than an exact match. In some embodiments, all of the discovered process instances in a stream of event data are then grouped, such that two or more discovered instances belonging to the same variation are grouped together. Variation of a discovered process may be defined in any suitable way. In some embodiments, two discovered process instances that have a similarity above a third predetermined threshold (e.g., 95%) may be considered as the same variation of the same process, two discovered process instances that have a similarity less than a fourth predetermined threshold (e.g., <70% similar) may be considered as different processes, and two discovered process instances that have a similarity between the third and fourth thresholds may be considered as variations of the same process. It should be appreciated that the third and fourth thresholds described herein are merely provided as examples, and any suitable third and fourth thresholds used for grouping discovered process instances may alternatively be used. By using measures of similarity of numeric representations in discovering process instances in wild data rather than requiring exact matches, variations of processes can be discovered without having to explicitly teach the variations.

In some embodiments, every stored and previously-determined numeric representation of the process may be considered as an independent representation for similarity comparison purposes. For example, a process A may have multiple taught instances A1, A2, and A3, and numeric representations corresponding to each of the taught instances. Similarly, a process B may have multiple taught instances B1, B2, and B3, and numeric representations corresponding to each of these taught instances. A measure of similarity may be determined between following-similarity (numeric representation of A1, numeric representation of window 1), similarity (numeric representation of A2, numeric representation of window 1), similarity (numeric representation of A3, numeric representation of window 1), similarity (numeric representation of B1, numeric representation of window 1), similarity (numeric representation of B2, numeric representation of window 1). In some embodiments, comparisons may be performed for each combination of numeric representation of taught instance (e.g., A1, A2, A3, B1, and B2) and numeric representation of each window (window 1, window 2, window 3, . . . , window N). In some embodiments, a similarity score may be generated for each of comparisons.

In some embodiments, a comparison with a highest score may be chosen and the process label associated with the taught process may assigned to the window of events. For example, to identify process A, the various comparisons may be performed and the window of events associated with the comparison with the highest similarity score may be labeled as process A.

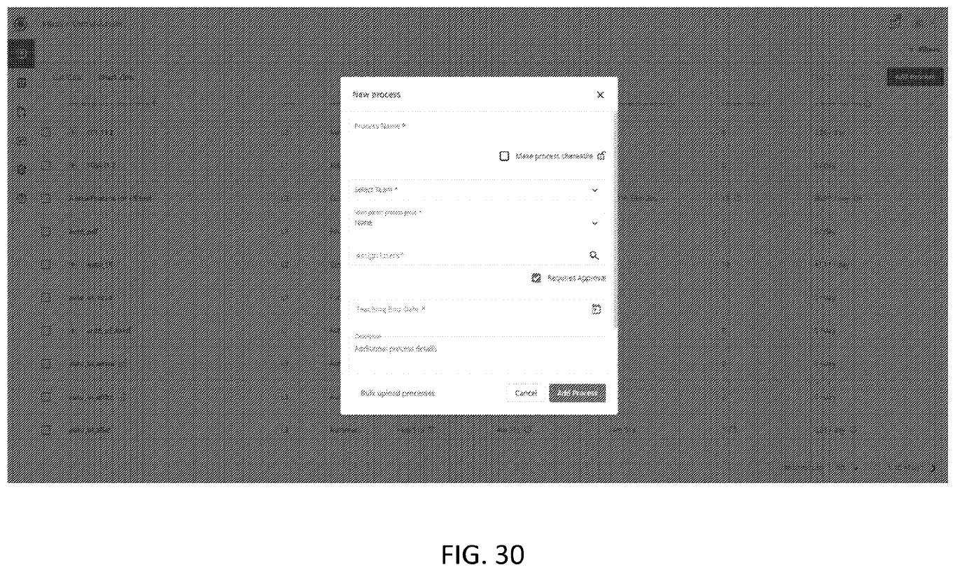

FIG. 30 illustrates a screenshot for creating or defining a process in accordance with some embodiments. In some embodiments, defining a process may include associating metadata with the process for the benefit of discovery, training, and management of defined processes. Examples of metadata that may be associated with a process include, but are not limited to, a name of the process (which can be associated with one or more groups or team of users), one or more users selected or assigned to teach/train the process, and one or more features related to management of teaching of the process (e.g., a time by which teaching should be complete).

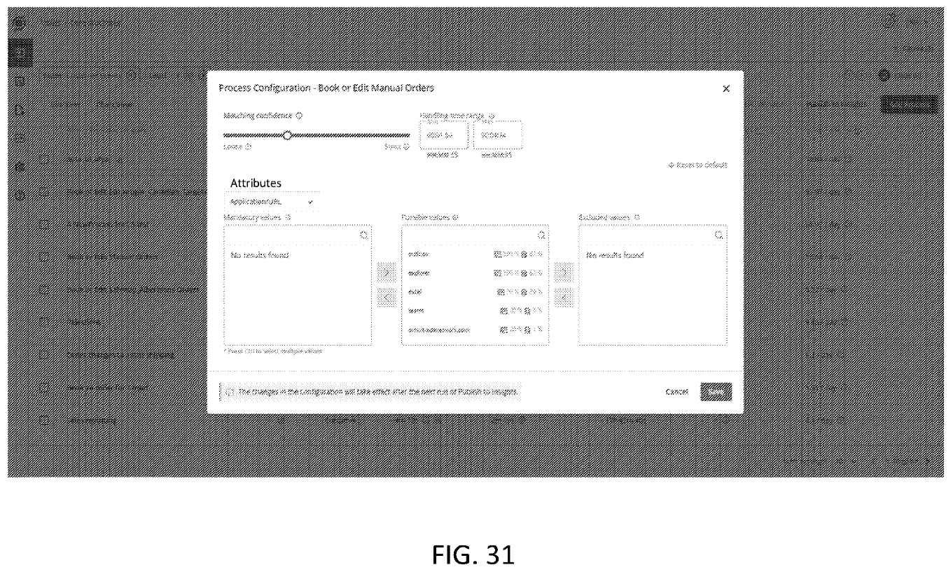

FIG. 31 illustrates a control for filtering process discovery results based on a measure of confidence or other parameters to facilitate better process matches as part of process discovery. An example of a matching confidence threshold setting control is shown in FIG. 31 where the matching confidence is set via a sliding bar (or other type of graphical user interface element). Sliding to the right may set a higher matching confidence threshold and sliding to the left may set a lower matching confidence threshold. Another example parameter that may be used to filter the process discovery results may include a handling time range, where lower and/or upper time bounds may be set to filter results whose duration is below the lower time bound and/or above the upper time bound. Yet another example parameter that may be used to filter the process discovery results may include values of attributes (e.g., Application/URL).

### ML Model Training

The BERT or RoBERTa model is trained using masked language modelling. The training corpus of text is a series of events formatted in the following manner, although other formats may be used.
Within an event, all the different attributes are concatenated with the token ‘->’
Within an attribute, all spaces are replaced with ‘_’
Events are separated by spaces
Independent user days of events are separated by new line characters

When using masked language modelling, 15% of the tokens are randomly masked in the input to the model. The model predicts the masked tokens. The model is trained using techniques described in Paszke et al., “Pytorch: An imperative style, high-performance deep learning library,” Machine Learning, arXiv: 1912.01703, December 2019; Wolf et al., “HuggingFace's Transformers: State-of-the-art Natural Language Processing,” Computation and Language, arXiv: 1910.03771, July 2020; and Rasley et al., “DeepSpeed: System Optimizations Enable Training Deep Learning Models with Over 100 Billion Parameters 2020,” Proceedings of the 26th ACM SIGKDD International Conference on Knowledge Discovery & Data Mining, August 2020, each of which is incorporated by reference herein in its entirety. The implementation of RoBERTa model provided in HuggingFace's Transformers is used and default hyperparameters for training the model are used. The DeepSpeed package is used to efficiently run training on a GPU cluster with multiple nodes.

The prediction layer is removed after training and the logits from the previous layer are considered as the model's output. Only the output of the classify (CLS) token is used because it is a single embedding that represents the entire input sequence or stream.

Further aspects of the above-described techniques (e.g., techniques for generating numeric representations of events, windows of events, and/or processes, techniques for process discovery, etc.) are described below. These further aspects include further examples and/or illustrative implementations of such techniques as well as example non-limiting applications of such techniques.

Generating Business Context from User Interaction-Based Data

### 1. Overview

Observing the detailed interactions that white collar workers take with business applications, digital documents, e-mails, chats, and more (e.g., observing and recording granular details about what buttons, text boxes, dropdowns, and data are entered in business applications as workers conduct their day-to-day business activities and processes) has enabled abilities such as being able to generate click-by-click understandings of how processes are performed and even discover patterns in the data collected such as various ways in which processes are performed by team members. This granular level of data can even allow for automatic generation of code that performs the same activities that the user did by having originally observed and recorded them.

Although the interaction-level data captured while observing interactions with business applications, documents, e-mails, chats, etc. provides a great level of detail, it can often be cumbersome for a user to understand the high-level steps performed to complete the process. For example, reviewing a series of 200 interactions to try to understand how a business process is performed is extremely difficult and hard to derive a high-level description of what was performed. This is the difference between “User clicked on username field”, “User typed in username field”, “User clicked on password field”, “User typed in password field”, and “User clicked login” versus a few words in a high-level description which summarize these interactions as “The user logged in.”

There are many other challenges like this related to how users can understand business context from the low-level interactions that are captured and what additional business context can be provided for the teams to understand their work better and more easily. For example:
High-level description with business context of what interactions were performed by a user.
High-level descriptions of how different ways of the same process are performed.
Summarization of the differences in how a team conducts a business process differently.
Automatically labelling a repetitive pattern that users perform as likely to be a particular business activity with a name (e.g., “Creating a purchase order.”)
Describing the business intent of a document based on its content.
Providing what business processes a document is typically performed in.
Benchmarking the efficiency of how a team performs the process compared to other teams.
Identifying bottlenecks with business context when the process is typically performed (e.g., The slowness of application X is causing purchase order creation delays.)

In addition to being able to provide better comprehension of business interactions, activities, documents, etc. it is also desirable to be able to generate more than just descriptions but also generate content itself such as:
Generating an ideal document for a particular use case (e.g., “Generate an ideal invoice form for my process.”)
Generating a more efficient way of performing steps in a business process that the team can perform.
Generating code that can perform a set of business activities that were captured.
Generating support tickets when issues are experienced.
Generating consultant-like recommendations to improve the process or activities being performed.

In addition to the desired functionality to overcome challenges experienced around summarizing, describing, and generating there are others related to enabling teams with better business understanding of their activities and how to improve them. For example, by providing them an interactive query system, real-time notifications when they are about to make a mistake, performing a process, and others.

In some embodiments, presented is an approach to developing and applying deep learning models that can understand and generate significant business context for interaction-level data white collar workers take with business applications, documents, e-mails, chats, and more. For example, deep learning models capable of summarizing the interactions workers had to perform to complete a business activity or process so that anyone could better understand how the work was performed.

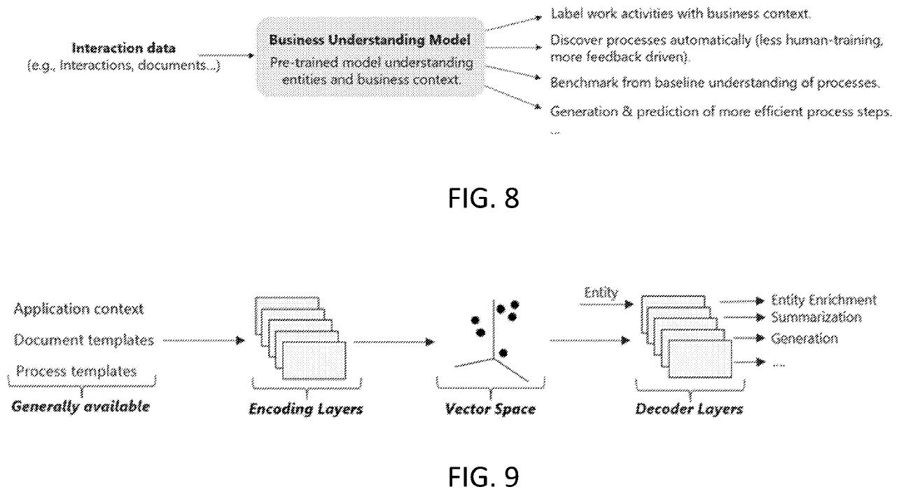

This model, as illustrated in FIG. 8, is trained on digital interactions and meta-data from those interactions to learn and understand business context. In some embodiments, the model is trained through interaction data to learn meaning behind the interactions to be able to describe, summarize, generate, and predict aspects of work that teams do.

### 2. Architecture of a Deep Learning Model with Business Context

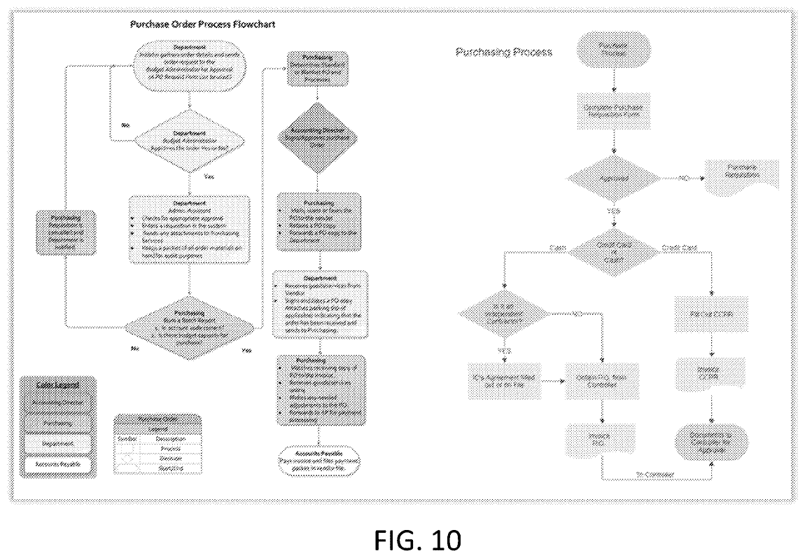

In some embodiments, to build a deep learning model based on user interaction data with applications, documents, chats, etc. the architecture which is summarized in FIG. 9 may be constructed. First, the architecture takes generally available information such as generally available application information, document templates, and process templates for the purpose of training (discussed in detail in the next section). This information is what is often captured when collecting work graph related information and entities and has embedded business context in them which guide human users of them. That same business context that is provided to guide human users can also be used to train our model. That information is then passed to a deep learning architecture (e.g., transformer or auto-regressive based) which builds out a set of encoding layers. These encoding layers are responsible for taking work graph related entities as inputs and producing a vector representation of them.

The vector representations based on the weights learned in the encoding process may be produced such that entities that have similarity have a shorter distance from each other in the vector space. For example, documents that have similar intents may have vector values that are closer to each other than documents without similar intent. Any entity given to the encoding layers that have similar business intent or understanding may be placed closely to each other in the vector space, based on the properties learned by the encoding layers. The architecture is one in which there may be multiple encoders and vector spaces that are fine-tuned for particular work graph entities. For example, one set of layers could be fine-tuned for document entities and another set of layers could be fine-tuned for user interactions or steps that they perform.

The encoding that was described is either one or all parts of the relevant model, in that the encoding layers can be used to produce vectors that are used directly by use cases. For example, directly used to compute similarity between entities in the work graph without needing to use any decoding layers. However, some decoding layers may be relevant to particular tasks or use cases of the model, such as layers that take vectors produced by the encoder and resultingly produce summaries of the entities that were encoded. Other uses of the decoding layers may be to have fine-tuning to particular tasks as described in the overview and further sections below on the use cases. However, the decoding layers may provide functionality like summarization of the entities, enriching them with additional business context (e.g., like the business purpose of what was given), generation of new material from the model (e.g., generating an ideal document based on a goal), or for but not limited to providing a conversational interface for users to ask questions of the model.

The model architecture described herein includes encoding layers that are trained from entities that have business context associated with them. This embeds business understanding into the encoding layers for various entities of the work graph such as user interactions, documents, chats, and e-mails. Such that when new entities are provided to the encoder, they can also be embedded with business context based on their placement in the vector space and their resulting nearest neighbors. That can be learned via the decoders. For example, final decoder layers in the model can be fine-tuned to learn that an area of the vector space contains documents or user interactions whose intent are related to Purchase Orders. Such that any new entity that is encoded which the model has never seen which is of some distance to that area in the vector space can also be classified as related to Purchase Orders. This is how the model may obtain business understanding, which is explained in more detail below in how the model is trained.

### 3. Train the Deep Learning Model to Understand Business Context

The deep learning model and architecture chosen is trained with general information available that is collected across applications, documents, and process templates. This is information that is often displayed to human users to give them business context of what they see on their screen. For example, text labels in business applications are meant to give the human user business context of what activity they are performing and guiding them. This same information can be used to train the model to give it the same business context. With enough information from applications, documents, process templates, chats and more the model can learn to understand the same kind of business context that humans need and are looking for when they see data that has been collected to help them understand their business processes and activities.

### 3.1 Training on Application Data

In some embodiments, FIG. 6A can show application information and context that is given to human users which is used to train the model to learn the same kind of business context. Training can be performed using general application context that is provided to users.

In the application there are various labels that give the user business context, and by training the model with these words together the encoder layer will learn that they have semantic similarity with each other. That is due to the bi-directional transformer and autoregressive designs of the model. As can be seen in the example application screen of FIG. 6A, it is possible to take business applications and use various technologies to extract information from them such as the labels in the application that say, “Purchase Order Screen”, “Purchase Order Information”, “P.O. Number”, “Ship To”, “Item #”, “Vendor No.” etc. All of this information will be given sequentially to the encoder which will construct layers that produce a vector space whereby these words will be closer to each other due to their context associated with each other. If they appear together, such as shown in FIG. 6A, the encoder learns of their association and thereby use in similar contexts. That puts them nearby each other in the vector space.

The model may learn that even if key words providing the business context like ‘Purchase Order’ did not exist anywhere in the screen, it is still be possible for it to associate the context and the meaning of what the user is doing. For example, imagine that only “Vendor ID:,” “P.O. Number”, “Order Form” and other terms like this were present, the model may still place these contextually in the same vector space as a purchase order. This can later allow for applications of the model and its decoders to do things like enrich smaller amount of information that would have been shown to a user which explains the work they are doing to something far more rich of descriptions. Even the ability to be able to predict and classify the work they are doing automatically.

When collecting this information from applications, there are several strategies that can be used when deciding what to train the encoder with, but not limited to:
Application labels can be used during the training.
Screen titles can be used during the training (e.g., the text at the top of the window).
Values in the application, such as those in text boxes or dropdowns, can be used during training.
Meta-data from the application not shown to the user (e.g., embedded in the application), such as application element names used by the UI frameworks (UIA, Java Access Bridge, SAP scripting, etc).
Visual representations of the screen and the text in it.

In addition to this information, broader context can be provided when the training is occurring and/or in the decoding layers. For example, there may be additional information provided with the training. Such as knowing when training that the application's purpose or this section of the application's purpose is related to purchase orders. This information can come out-of-band to what is actually in the application, but rather from pre-existing metadata about the application or sections of it.

Since this information is general to the business context it will extend to work for applications that the model has never seen before in the future. These applications may be in-house applications in organizations who use the technology. Even if the model was never explicitly trained on them, the general information given to the model means that is likely to still see similar labels and context in applications it has never seen before.

### 3.2 Training on Document Data

The next generally available information that the model can be trained on are publicly accessible documents. When training on documents, formatting may be used to detect general information in the document such as headers, subheadings, sections, and general context given to users. Such as what has been highlighted in FIG. 6B like “VENDOR,” “SHIP TO”, “ITEM #”, “Payment Amount”, etc. To find this information in training various formatting filters such as bold text, italic text, larger text, all capital text, colored text, table headings, etc. may be used. This identifies information that is generally context about what's being done as opposed to values. Although the technique works for both templates and filled in documents, it is templates that also help find more structure about the documents and their context as they will not be filled with a lot of dynamic information yet.

This information is passed in training just as described above in the training on application data section and just like with the training on application data, information in the documents that train the business understanding may build an understanding of documents even if not shown to the model in training. In fact, documents can be treated just like an application and what is learned in applications and documents will extend to each other. That is, business context learned in one can extend to another i.e., business context in applications can still be used to generate business context for documents.

### 3.3 Training on Process Templates and Flows

Process templates are descriptions of business process flows that are industry standards and exist across all industries. The process flows, as shown in FIG. 10, can be used to train the model on business context. The process templates and their flows include the various steps with language used in the process. Additionally, they often come with additional metadata that can be used for training. As explained in detail below in the use cases of the model, in addition to this information being able to train an encoder this can also be used to fine-tune additional decoding layers that predict what activity or process users are doing.

Training using the general process templates is taken by using the information in each of the steps as well as the associated process meta-data associated with them, such as the business flow being for a certain business vertical and certain process that is conducted. This is all information that is trained during the encoding, in addition to the information that is in the individual steps.

How the information is given to the model to build the encoder is just like the information from applications and documents. Depending on the process flows being given for the training, a choice may be made to train on the names of the steps. Or it can be trained on all of the information that is available in the steps to give the model more context.

By associating it with meta-data about the process such as the business vertical and the name of the process, it may continue to fine-tune the encoding layer and the resulting vector space that certain terminology is relevant to particular verticals and processes. This places them nearby each other in the vector space and improves the model's performance when performing tasks that are described in the use case sections below, such as being able to label the kind of activity that the user is doing.

3.4 Generating and Training with Synthetic Data

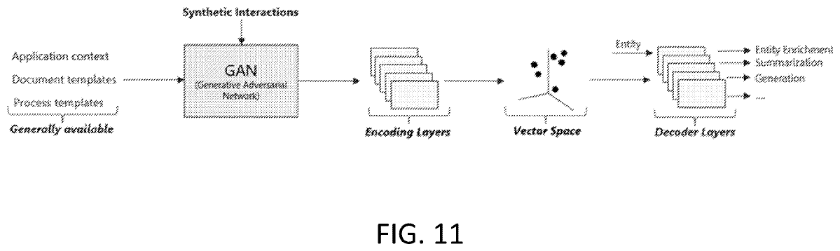

To help train the model at scale, synthetic data may also be generated for the training. This synthetic data is generated from learned statistical properties of general user interactions with the applications, documents, process templates, and more. How this data is generated is from a GAN as shown in FIG. 11, but other generative networks or synthetic data generic techniques can be used.

To train a model to learn to generate the data, we provide the model observed user interactions and the associated application, document, e-mail, chat, etc. meta-data associated with it. This includes information related to the actual interaction data such as the time it occurred and any associated business context with it such as a process or activity name. This information is passed to the GAN's training layers such that it learns to be able to produce data that looks like the original data provided. This allows us to generate data sets that are substantially larger than the original data, and we can do this from general information available.

### 3.5 Developing and Fine-Tuning Decoding Layers and Tasks

The encoding layers may be trained to produce a vector space with embedded business context and understanding. The next step is to train the decoder layers shown in FIG. 9, which may produce at least one if not multiple models that are fine-tuned to particular tasks, such as being able to summarize business context for a user based on interaction data or generate a more efficient way of doing a process.

How this works is that the encoding layers are trained using the techniques herein. That will create the ability to take work graph data such as user interactions with the applications, documents, chats, e-mails, etc. and convert them into vector values in the vector space. Next, the decoding layers may be developed which may take as inputs the vectors output of the previous encoding layers and potentially reduce or expand them into a new set of outputs such as a classification.

Using a classification decoding layer as an example, we may pass a set of user interactions to the encoder which produces the set of resulting vectors. The next layer may be setup as a classification layer where the goal may be to take the vectorized user interactions and classify them into a potential business activity, such as activity related to Purchase Orders. If the output of the final encoding layer is of size 100 and there are 50 possible business activities that the user could be performing, then the final decoding layer may be a fine-tuned model that is 100×50 where it takes the vector of size 100 and produces a resulting vector of size 50 which is its output fine-tuned for the use case of activity classification. Each value in that vector of size 50 being a vector with a result that embeds the potential weight of each possible label from the classification. This is just one example of how the model will be built and fine-tuned for different use cases.

Another example of how the decoder is built and fine-tuned to particular use cases is an example of summarization or generation. Given an input vector from the encoding layers, such as a series of user interactions from an activity they performed, a resulting vector representation will again be produced. A set of context and text that was learned from the encoding and embedded in the vector space can then be used to generate a summary of the context of the business application. An example of this will be that as we build the vector space, to keep a representation of the context that is associated with different regions of the vector space. For example, when training on Purchase Order related activities we can embed through the decoder that the region of the vector space related to this activity is bounded by this area in the vector space. Imagine that ‘Creation’ (e.g., creation of a purchase order, creation of an invoice, creation of a report . . . ) is also represented by some area of the vector space. Then when we pass in a set of activities to the decoder it will be able to generate a description of what the user is doing by recognizing what parts of the vector space their digital interactions belong in. It could therefore predict that the user is both working on purchase orders and creating, thereby capable of producing a description such as “The user is creating purchase orders.”

All of these applications and use cases are described in the detail below, including the relevant details of the model to be able to produce the outcome of that use case.

### 4. Entities and Functions of the Model to Enable Business Understanding

In this section, we describe how the model is used to derive novel functionality for users. These use cases are built on top of the model and its business understanding, which were not possible before with data from the work graph, from user interaction data, and from documents, e-mails, or chats.

All of the techniques that we describe below are applicable to any of the entities described herein or other entities that we may construct in the future since the techniques are generally applicable to the information available in the entities. For example, model tasks that we describe to find similar entities will work across any entity. Techniques that we describe to compute similarity work across any two entities. Techniques that we describe to summarize an entity work across all entities, and so on.

In the remainder of this section, we present entities and the model tasks that are built on top of the model and the entities that will enable greater business understanding and context.

### 4.1 Business Entities

Entities as we define them are related to organization's work and operations, as collected and/or created by technologies described herein. Particularly, these entities can describe the digital interactions that users take with applications, documents, chats, e-mails, etc. and their organization into business activities like processes or steps that they perform. These entities are as follows, but not limited to:
User Interactions that are collected as they interact with applications, documents, chats, e-mails, etc.
Fields which are application elements like text boxes, dropdowns, radio buttons, etc.
Attributes/Identifiers are Fields that contain properties of a business activity, such as a purchase order number for a purchase order process.
Views which are a representation of what the user sees on their screen when working with applications, documents, chats, e-mails, etc.
Activities that users perform such as a series of interactions to perform a task.
Steps that users perform, such as a series of activities that are part of a business activity.
Processes that users follow to complete a business activity (e.g., creating an invoice).
Variations of the interactions, activities, steps, processes, documents, e-mails, etc. that might exist.
Applications are digital interfaces by which teams perform work.
Documents that the business uses to complete interactions, activities, steps, processes, etc.
Chats/Conversations that are related to the business activities that they perform.
E-mails that are related to the business activities that they perform.
Groups which are collections of any of the above entities that share some business intent.
KPIs are performance indicators towards specific business objectives.
Statistics are numerical properties of entities described above (e.g., like total number of e-mails).
Users are the individual workers who conduct the business activities.
Teams are the groups of workers who conduct the business activities.

### 4.2 Model Tasks on the Entities Built on the Model to Enable Understanding

For all entities techniques may be deployed on the model that are accessible on every entity and across entities that enable obtaining greater business understanding, searching entities, finding similar entities, etc. Described herein is how the technique can be achieved, and in each section, a brief description of how it enables new insights, experiences, and technology may be provided. Each section contains one example, and then in following sections we will give more comprehensive examples with each entity.

The available model tasks that are enabled on every entity are as follows, but not limited to, for enabling greater business understanding using the model:

Entity Enrichment: For the given entity, we enrich it with additional business context using the model developed. Additional context, for example, being some additional purpose or description to help the user understand more about the business activity. This can be implemented via generative layers in the model. For a generative layer, it can be giving the model the original details about the entity and having a decoder produce additional tokens or words that describe the entity in more detail. Given how the model was trained, it produces additional context relevant to the entity that was provided. A generative model is not the only way, but one such way to implement entity enrichment that can be used.
Input Example: “User edited text field.”
Output Example: “User edited an address field related to shipping.”

Summarization: For multiples of the same entity (e.g., multiple User Interactions), to summarize what was performed in a natural language form with the enrichment that was added to the entity. A common method for implementing summarization is a sequence-to-sequence set of layers in the model to produce a natural language summarization. In particular, by being example sequences from the original domain (e.g., multiple User Interactions) with example sequences in the following domain (e.g., a set of natural language words that summarize it). Not limited in solution to sequence-to-sequence models, however, as other ways of providing the summarization are possible (e.g., through generation).
Input Example: “User edited text field. User clicked on dropdown. User clicked on button.”
Output Example: “The user changed an address field related to shipping and saved the address.”

Topic Modelling: Topic modelling can be provided on any of the entities to relate them to a business activity, thereby giving them additional business context. For example, to say that the User Interaction or the Step is related to “Purchase Orders.” This provides better business understanding of the information that is presented to users. Implementations of topic modelling can happen in many different ways, such as single label classification, multi-label classification, and various clustering techniques. One such implementation, e.g., with single label classification, can have the model described in the design and training sections trained on inputs of the entities with resulting topic classifications for it to learn from.
Input Example: “The user changed an address field related to shipping and saved the address.”
Output Example: “Updating Purchase Orders.”

Similarity Analysis: Any entity can be directly compared to another instance of another entity and obtain a similarity score via vector distances and other techniques from the model that was described. This will enable a number of features related to finding similar documents, similar processes, similar users, etc. The similarity analysis can take two or more entities and will return a similarity score between them. This score can be, for example, a score between 0 and 1 but is open to many different types of similarities (e.g., cosine similarity, Euclidean distance, etc.).

Input Example: Document 1, Document 2
Output Example: 0.65

Fast Similarity Analysis and Search: With similarity analysis as a base feature and all of the entities being encodable in the vector space, it is easy to implement a fast similarity analysis and search. This can, for example, be implemented using a nearest neighbor search in the vector space and can span across entities. Within the same entity type, it can find all other documents that are similar to a given document that users were viewing, editing, creating, etc. Across entity types, finding processes that are similar to a given document will result in processes that are most likely to use the document. This enables many use cases that we describe below.

Input Example: Document 1
Output Example: Document 7, Document 10, Document 32 ...
(all of which are semantically similar in business intent / context)

Finding the Usage Of: With the similarity analysis, nearest neighbor searches, as well as the mappings that can be created, the model can enable finding usage of any of the entities across user's and team's work. For example, the relationship between documents and processes can enable finding the usage of documents in processes. It can also enable finding the usage of documents in unstructured work the teams do. It can also enable finding the usage of documents in e-mails, or when they are referenced in chats. But this is not limited to documents, it can be used on any of the entities, such as e-mails to see what processes e-mails belong to and so forth.

Input Example: Document 1
Output Example:
{‘Processes’: [‘Purchase Order Creation’, ‘Purchase Order Cancellation’,
...], ‘E-Mails’: [‘URGENT: Cancel purchase order #1234, ...]}

Grouping: There are several ways using the model and the vector space that entities can now be grouped and clustered. First, is using model tasks and techniques already described. For example, grouping entities together by the using the Topic Modelling, Similarity Analysis, and some of the nearest neighbor searches described. The value of the clustering and grouping that results from these techniques can help provide user experiences where clusters or groups of entities are created for users, in addition to users being able to create their own clusters or groups. Clusters or groups will contain entities that have semantic similarity to each other as well. The groups will contain entities that all belong to the same topic, which are all within some similarity threshold, or all within some distance as neighbors in a vector space. Groups can either be pre-defined, e.g., based on the topics, or a user can create a cluster by providing one example of an entity which can then use similarity analysis or nearest neighbors as an example. For example, if the user were to provide a document and request that a group is created from it. That group can be named by the user or provided through the summarization model task previously described.
Output Example: {′Group Name′: [Group Entities], . . . }

Interactive Queries: Using the model's business understanding learned from training, a model task can be implemented that provides interactive queries on the data using natural language. This allows a user to ask for knowledge about the entities listed and others that the technology may be extended to include. To provide the model task of interactive queries, there are a number of techniques employed. To provide access to data that is dynamic and can change over time, there are translation options of the natural language queries into SQL queries where entities are detected in the natural language queries and mapped to database information. Other techniques may retrain an interactive query model with knowledge daily to instead embed the exact knowledge into the model. These are two example ways of achieving this. This can allow users to ask questions like the example below. In addition to this, the user can request that the information be graphed for them for easier understanding of the data.

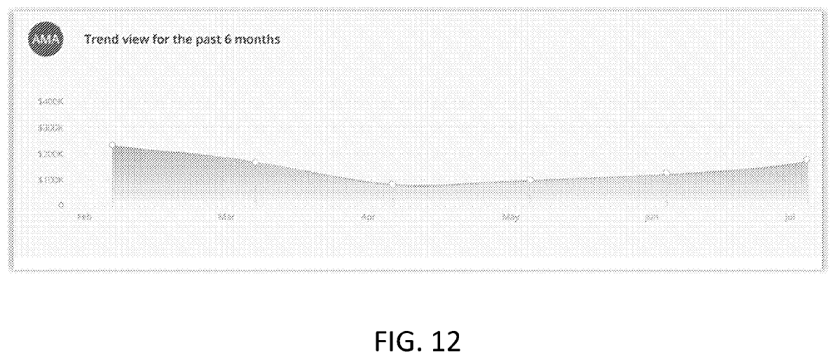

Input Example: What is the total cost impact due to reprocessing of
orders in the last month?
Output Example: ~$220.
Input Example: Give me a trend view of the past 6 months.
Output Example as shown in FIG. 12 may be provided.

Generation Of: With the learning built into the model, generative tasks can be built which enable the generation of entities. These model tasks can be fine-tuned to generate entities such as generating documents that have a template structure ideal for the process learned by the model or detected in the customer's use case. The generative model tasks can be fine-tuned to generate the summarization as previously described. The generative model tasks can be fine-tuned to generate a more efficient set of Steps to performing a process.

Input Example: <Set of business process Steps>
Output Example: <More efficient set of business process Steps>
Input Example: <Purchase Classification like ‘Purchase Order’>
Output Example: <An ideal ‘Purchase Order’ document>

Impact on Business KPIs: Part of what the model has learned are about statistics (entity) that are relevant to processes (entity). The model therefore has an understanding of what statistics are influenced by what processes, what documents, what e-mails, what applications, etc. This can identify what entities are bottlenecks in a process and how they impact business KPIs. For example, that a Purchase Order document has an impact on the manual processing effort related to purchase orders. The user can be navigated to more information on the business KPI with actual statistics on their impact to the KPI.

Input Example: Purchase Order Document
Output Example: Impact: Manual processing effort per-invoice.

Industry Benchmarking: When the model is trained with business understanding from process templates and other industry standards, it is learning general industry benchmarks in terms of the standard set of steps that should be performed, statistics about the process from industry standards such as the average processing time, the amount of effort required to complete a transaction of the process, the cycle time it may take to complete the process (i.e., time from start of a transaction to the end, including gaps in time where it has not been worked on). Other benchmarking can include documents that should be present or used according to industry standards, like a compliance tracker.

Input Example: <Example executions of Purchase Order Process>
Output Example: {‘Processing Time Benchmark’: ‘−10 minutes’, ‘Manual
document processing effort’: ‘+15 minutes’, ...}

Real-time User Experiences: Various of the model tasks described above can then be used to build real-time user experiences. These experiences, for example, can help improve the productivity of the user related to particular entities. For processes, it is now possible to provide the real-time experience of detecting the process that the user is doing in real-time (e.g., using the model's classification) and simply asking the user to confirm whether or not they are doing the process. Previously, accurate classification may have required substantial amounts of manual user effort to train the model. Now, a more real-time experience can be built using a classification task and learning from the user's feedback. Other experiences that can be provided are checking compliance against a process. All of these are specific real-time user experiences that will be addressed through examples in later sections.

4.3 Improving Business Understanding to the Entities with the Model Tasks

### 4.3.1 User Interactions

Entity Enrichment: One of the challenges in user interaction data is that the default information available from the application can be very sparse. It can be lacking sufficient business context that would help a user understand the actual business activity that was being performed.

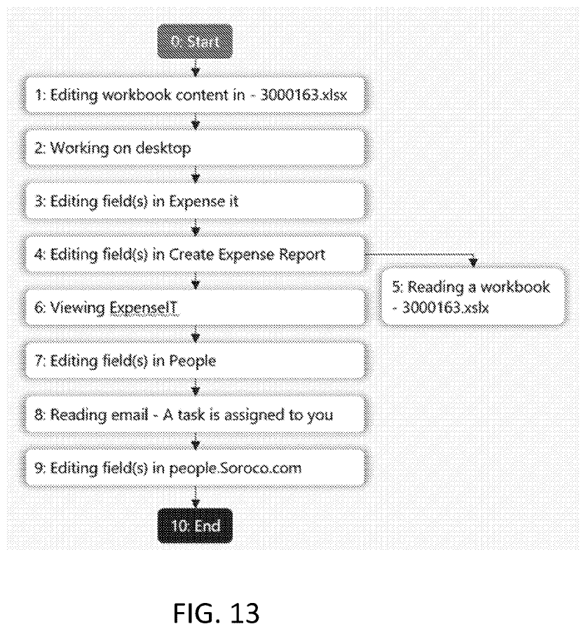

In the example shown in FIG. 13, there are many user interactions that are shown which do not have business context associated to them. For example, “Editing field(s) in People” is for what purpose? And “Reading email—A task is assigned to you” also does not carry context of what the e-mail's business purpose is, for example. This is because interaction data is often very low level, but with the model that has been trained in the prior example we can use it to add additional business context and understanding to every interaction.

The way that this is done is by taking the user interaction that the user performed, and having the model generate a few additional labels that describe the work the user was doing, by observing business context that was in the application, document, e-mail, etc. and having the model's decoder layer return back a set of business context labels that can be applied to the activity. For example, as shown in previous sections about training the model there may be additional context in the application when “Editing field(s) in People” occurred that can now be used to pass to the model again to have it find these fields in the vector space and return back labels of business context with it.

By doing so, we can generate a far more descriptive version of what the user was conducting with a greater level of business understanding. Now, there is business context and understanding about what exactly the user was doing in addition to being more well summarized. Instead of saying that they read an e-mail or that they edited fields, there is now a more descriptive set of business activities that are summarized for the user through use of the model.

This understanding can be added within the individual interactions, e.g., instead of “Editing field(s) in Create Expense Report” it can be “Creating sales expense report” which is the action on editing the fields. All of this can be summarized into the smaller set of steps.

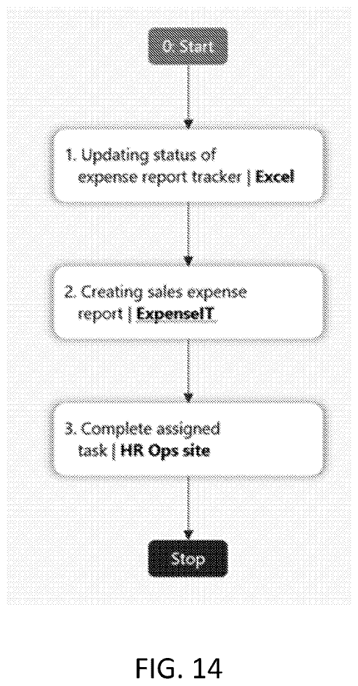

Summarization: The summarization of User Interactions is to take them and be able to describe them into something like the sentences with business context as shown in FIG. 14. This figure shows how we have gone from 9 low-level details of the events that occurred, into 3 high-level states for summarization. This can be provided in this way, and/or in a natural language form back to the user such as “The user updated the status of an expense report tracker in Excel. They then created the sales expense report in ExpenseIT. They completed their assigned task in the HR Ops site.”

Topic Modelling: Using the topic modelling that was described on User Interactions, we can also suggest the business intent or topic that the user interactions were related to. By doing so, we can present back the business intent or topics such as the user interactions having been related to “Editing address fields” whereas it may have just previously said “Editing fields” where the topic is related to an address. It can also be to a higher-level business set of topics such as purchase orders, invoices, reports, contracts, billing, hiring, loans, banking, etc.

Similarity Analysis: Using the mechanisms described, we can now perform a similarity analysis across all of the following entities, where similarity analysis with User Interactions is with itself. Again, the exact similarity mechanism used is modular and described in the previous section on the similarity analysis model task.

| Usage/Relation To | Description |
|---|---|
| User Interactions | Returns the similarity between two user interactions. |
| Fields | Returns the similarity between a user interaction |
| | and a field, which will be of greater similarity |
| | if the user interactions are performed on the field. |
| Attributes | Returns the similarity between user interactions |
| | and attributes, which will be of greater similarity |
| | if the attributes are related to or interacted with |
| | on the user interactions. |
| Views | Returns the similarity of user interactions and a |
| | view, which will be of greater similarity if the |
| | user interaction happens within the views. |
| Activities | Returns the similarity of user interaction and |
| | Activities, which will be of greater similarity if |
| | the user interactions are part of the Activity |
| | that is being performed. |
| Steps | Returns the similarity of the user interaction |
| | and Steps, which will be of greater similarity if |
| | the user interaction is part of the Steps or |
| | similar to interactions in the steps performed. |
| Processes | Returns the similarity of the user interaction and |
| | Processes, which will be of greater similarity if |
| | the user interactions are part of the process. |
| Variations | Returns the similarity of the user interaction and |
| | Variations, which will be of greater similarity |
| | if the user interactions that take place in the |
| | variations. |
| Documents | Returns the similarity of the user interaction |
| | and Documents, which will be of greater similarity |
| | if the user interactions had taken place in the |
| | document or ones similar to it. |
| Chats/Conversations | Returns the similarity of the user interaction and |
| | conversations, which will be of greater similarity |
| | if the user interactions are common for the given |
| | set of conversations. |
| E-Mails | Returns the similarity of the user interaction and |
| | e-mails, which will be of greater similarity if the |
| | user interactions are part of creating, writing, |
| | sending, reading, etc. of e-mails. |
| Groups | Returns the similarity of the user interaction and |
| | groups of any entity, which will be of greater |
| | similarity if the user interaction has a relationship |
| | to entities within that group. |
| KPIs | Returns the similarity of the user interaction |
| | and the KPIs, which will be of greater similarity |
| | if the user interactions are influencing or related |
| | to the KPIs (e.g., involved in manual effort which |
| | impact the KPI). |
| Statistics | Returns the similarity of the user interaction and |
| | the given statistic, which will be of greater |
| | similarity if the user interactions are influencing |
| | the statistics (e.g., if the user interaction |
| | influences the statistic). |
| Users | Returns the similarity of the user interaction and |
| | the user, which will be of greater similarity if |
| | this user performs the user interaction or ones |
| | like it. |
| Teams | Returns the similarity of the user interaction and |
| | teams, which will be of greater similarity if |
| | the team performs the user interaction or ones |
| | like it. |

Fast Similarity Analysis and Search: User Interactions will be able to leverage the fast similarity analysis and search model task as previously defined, where we will be able to find similar interactions to the one provided. This can be used to find similar interactions (i.e., of the same entity type), or used to find its similarity with other entities. For example, the similarity between a User Interaction and a Field would be of greater similarity if the user interaction took place on that field. Therefore, below, we define all of the fast similarity analysis and search across User Interactions and all other entities.

Finding the Usage Of: Finding the usage of User Interactions is similar to finding where they took place and their relationship to all other entities.

| Usage/Relation To | Description |
|---|---|
| User Interactions | This will return other user interactions that are |
| | similar or take place with the user interaction. |
| Fields | This will return fields that the user interaction |
| | takes place on. |
| Attributes | This will return attributes where the user interaction |
| | takes place on. |
| Views | This will return Views where the user interaction |
| | takes place on. |
| Activities | This will return Activities where the user interaction |
| | takes place on. |
| Steps | This will return Steps where the user interaction |
| | is a part of. |
| Processes | This will return Processes where the user interaction |
| | is a part of. |
| Variations | This will return Variations that the user interaction |
| | is a part of. |
| Documents | This will return Documents that the user interaction |
| | is a part of. |
| Chats/Conversations | This will return Conversations that the user |
| | interaction is a part of. |
| E-Mails | This will return E-mails that the user interaction is |
| | a part of. |
| Groups | This will return Groups of entities that the user |
| | interaction is a part of. |
| KPIs | This will return KPIs that the user interaction |
| | influences. |
| Statistics | This will return Statistics that the user |
| | interaction influences. |
| User | This will return Users who performed this |
| | interaction or one like it. |
| Teams | This will return Teams who performed this |
| | interaction or one like it. |

Grouping: Interactions can now be grouped by their semantic similarity, or their intent as described in the model task. This can now group several interactions like Interaction 1, Interaction 2, Interaction 3, etc. together via the model tasks that were described.

Interactive Queries: There are various interactive queries that can now be supported on User Interactions, for example, asking questions around the most time-consuming user interactions, the processes that have the most user interactions, the documents that have the most user interactions, etc. Questions such as, “Find me an interaction on the ______ View” or “Find me team who performs the following interaction ______.” Queries can now be supported at the interaction-level with responses.

Generation Of: Automation of business activities often happens at the user interaction level, by replaying back what user interactions occur for the process steps. The model has seen and been trained on processes and their flows through the application, so using the generative tasks previously described it can generate a single user interaction or sequence of them. This can help automatically generate automation that performs business processes. Additionally, generating more efficient versions of the user interactions.

Impact on Business KPIs: With the understanding and similarity analysis built into the model, there is now a link between business KPIs and the user interactions. This can therefore allow user experiences that link the user interactions to their impact on business KPIs. Such as, determining that inefficient user interactions are a reason for the processing time of purchase orders to be slow. User Interactions are tied to many business KPIs since it is the users who are conducting various critical steps in a process. Exact user interactions via the similarity search are linked to particular processes, and those processes to business KPIs and so on.

Industry Benchmarking: There are industry standard process flows that the model has been trained on, and with those flows meta-data can be provided such as the average time it should take to perform the given business activity. Those activities are linked to user interactions in the Steps, and then statistics are given on the user interactions in relation to the business steps. Such as, the user interactions contributing to the metric being above or below the industry standard.

Real-time User Experiences: There are various real-time user experiences that are built from the user interactions that are being captured in real-time and the analysis that can be done using the model. For example, classifying the user interactions into topics in real time. Classifying the user interactions into processes, documents, activities, and other entities. Real-time user experiences are that suggest to the user that particular interactions they are taking are inefficient or not to some compliance standard. Real-time user experiences that suggest another set of user interactions to address an issue they ran into (e.g., “click here to response your VPN issue”).

### 4.3.2 Fields

Entity Enrichment: The entity enrichment for Fields is covered similarly as that described in the ‘User Interactions’ section. This understanding can be added within the individual fields, e.g., instead of “Editing field(s) in Expense IT” it can be “Editing expense value fields in a sales expense report” which is the action on editing the fields. Instead of the fields being very generically named without business context, as sometimes the applications are developed without having good names associated with them, the model can now add additional context or business understanding to them. This significantly improves the understandability of the fields that users are interacting with as a part of processes.

The model, by being trained on annotations of applications (e.g., their labels, their Fields, the values associated with fields) also learns what are meaningful fields on the screen and how to identify them from ordinary labels on the screen. The value of Fields being a label and expected associated value with them. For example, a Field named Purchase Order # and its value being PO 12345. Detecting such fields in user applications can be challenging, and especially is challenging in legacy systems such as mainframes. Using the training and annotations of the applications (their labels, their Fields, their values associated with the fields) the model also learns what are likely Fields in the user interface and what their likely associated value is. While this may be more apparent in applications such as Windows Applications, Java Applications, or SAP for example using application frameworks (e.g., Windows UIA), it is less clear in legacy systems like mainframes where there is no such application that you can easily extract such information. At best you often just get text and its coordinates. From the training of the models, it is now possible to label such text as likely a Field Name and a Field Value in legacy applications such as mainframes. However, even with application frameworks (e.g., Windows UIA) there are still some ambiguities on what may be a Field Name and Field Value all depending on how the developer implemented it. The model instead will give what are the Fields and Values with associated confidence scores which can be used to record the User Interactions.

### Summarization:

| Few Words | | |
|---|---|---|
| Summary | One Sentence | One Paragraph Summary |
| Example | Summary Example | Example |
| Order | Order Number Field | Order Number Field in SAP module |
| Number | (Label) in SAP with | ‘Customer Update’ often used as part |
| in SAP | Value (123456) | of the Order creation process |

Topic Modelling: Using the topic modelling that was described on Fields, we can also suggest the business intent or topic that the Fields were related to. By doing so, we can present back the business intent or topics such as the Fields having been related to “Editing address fields” whereas it may have just previously said “Editing fields” where the topic is related to an address. It can also be to a higher-level business set of topics such as purchase orders, invoices, reports, contracts, billing, hiring, loans, banking, etc.

Similarity Analysis: Using the mechanisms described, we can now perform a similarity analysis across all of the following entities, including similarity analysis with Fields itself. Again, the exact similarity mechanism used is modular and described in the previous section on the similarity analysis model task.

Usage/Relation To

| | |
|---|---|
| User Interactions | Returns the similarity score between a field and user |
| | interaction. If the user interaction takes place on |
| | the field or a field of similar business intent, then |
| | the score will be greater. |
| Fields | Returns the similarity between two fields. If the |
| | fields are the same it will have a score of 1. If the |
| | fields are not the same but have similar intent (e.g., |
| | “Address Field 1” and “Address Field 2”) |
| | they will have a greater similarity score. |
| Attributes | Returns the similarity between a field and an |
| | attribute. If the field was used as part of creating |
| | the attribute, it will have a greater similarity. Or, |
| | if the field was semantically similar to another field |
| | that was used to create the attribute. |
| Views | Returns the similarity score between a field and a |
| | view. If the Field was present in the view, it will |
| | have a greater score that is returned. |
| Activities | Returns the similarity score between a field and an |
| | Activity. If the Field was accessed as a part of the |
| | Activity it will return a greater score. |
| Steps | Returns the similarity score between a Field and a |
| | Step. If the Field was accessed as a part of the |
| | Step it will return a greater score. |
| Processes | Returns the similarity score between a Field and a |
| | Process. If the Field was accessed as a part of the |
| | Process it will return a greater score. |
| Variations | Returns the similarity score between a Field and a |
| | Variation. If the Field was accessed as a part of |
| | the Variation it will return a greater score. |
| Documents | Returns the similarity score between a Field and a |
| | Document. If the Field was accessed as a part of the |
| | Document it will return a greater score. Also, |
| | greater if the field was accessed as part of other |
| | Documents of a similar topic. |
| Chats/Conversations | Returns the similarity score between a Field and a |
| | Conversation. If the Field was accessed as a part |
| | of the Conversation it will return a greater score. |
| | Also, greater if the field was accessed as part of |
| | other conversations of a similar topic. |
| E-Mails | Returns the similarity score between a Field and |
| | an E-Mail. If the Field was accessed as a part of |
| | the E-Mail it will return a greater score. Also, |
| | if the field was accessed as part of other e-mails |
| | of similar topics. |
| Groups | Returns the similarity score between a Field and |
| | a Group of any entities. The similarity with the |
| | individual entities in the group is returned and |
| | averaged for a similarity with the group. Other |
| | than an average, other statistics such as |
| | weighted averages or medians. |
| KPIs | Returns the similarity of the Field and the KPIs, |
| | which will be of greater similarity if the field |
| | are influencing or related to the KPIs (e.g., |
| | involved in manual effort which impact the KPI). |
| Statistics | Returns the similarity of the Field and the given |
| | statistic, which will be of greater similarity |
| | if the Field is influencing the statistics. |
| User | Returns the similarity of the Field and the user, |
| | which will be of greater similarity if this user |
| | performs interactions on the Field or ones like |
| | it. |
| Team | Returns the similarity of the Field and teams, |
| | which will be of greater similarity if the team |
| | accesses and uses the field or ones like it for |
| | their business activities. |

Fast Similarity Analysis and Search: Fields will be able to leverage the fast similarity analysis and search model task as previously defined, where we will be able to find similar fields to the one provided. This can be used to find similar fields (i.e., of the same entity type), or used to find its similarity with other entities. For example, the similarity between a User Interaction and a Field would be of greater similarity if the user interaction took place on that field. Therefore, below, we define all of the fast similarity analysis and search across User Interactions and all other entities.

Finding the Usage Of: Finding the usage of Fields is similar to finding where they took place and their relationship to all other entities. Where a similar field is one that has a high similarity to another field (e.g., both being of the same business intent).

| Usage/Relation To | Description |
|---|---|
| User Interactions | This will return user interactions that took place |
| | on this field or similar ones. |
| Fields | This will return other Fields that are similar or |
| | take place with the Field. |
| Attributes | This will return attributes that are based on the |
| | field or a similar one. |
| Views | This will return Views that contain the field or a |
| | similar one. |
| Activities | This will return Activities where the field or a |
| | similar one is used. |
| Steps | This will return Steps that use the field or a |
| | similar one. |
| Processes | This will return Processes that use the field or |
| | a similar one. |
| Variations | This will return Variations that use the field or |
| | a similar one. |
| Documents | This will return Documents that use the field or a |
| | similar one. |
| Chats/Conversations | This will return Conversations that use the field |
| | or a similar one. |
| E-Mails | This will return E-mails that use the field or a |
| | similar one. |
| Groups | This will return Groups of entities that use the |
| | field or a similar one. |
| KPIs | This will return KPIs that the interactions occur on |
| | the field or a similar one. |
| Statistics | This will return Statistics that interactions occur |
| | on the field or a similar one have an influence on. |
| User | This will return Users who performed interactions |
| | on this field or one like it. |
| Teams | This will return Teams who performed interactions |
| | on this field or one like it. |

Grouping: Fields can now be grouped by their semantic similarity, or their intent as described in the model task. This can now group several interactions like Field 1, Field 2, Field 3, etc. together via the model tasks that were described.

Interactive Queries: There are various interactive queries that can now be supported on Fields, for example, asking questions around the most time-consuming fields that users access, the processes that have the most fields involved with them, the documents that users have to complete the most fields in (e.g., Excel sheets), etc. Questions such as, “Find me a field on the ______ View” or “Find me team who performs the following edits on this field ______.” This information is valuable for many reasons, such as before making changes to documents or applications, understanding what is accessed in them. Queries can now be supported at the interaction-level with responses.

Generation Of: Automation of business activities often happens at the user field level, by replaying back what user interactions occur for the process steps. The model has seen and been trained on processes and their flows through the application, so using the generative tasks previously described it can generate a single user interaction or sequence of them. This can help automatically generate automation that performs business processes. Additionally, generating more efficient versions of the user interactions. Generating fields for applications that may be required, or a more efficient set of fields by understanding what is required of the process is now possible.

Impact on Business KPIs: With the understanding and similarity analysis built into the model, there is now a link between business KPIs and the fields. This can therefore allow user experiences that link the fields to their impact on business KPIs. Such as, determining that inefficient fields are a reason for the processing time of purchase orders to be slow. Fields are tied to many business KPIs since it is the users who are conducting various critical steps in a process. Exact fields via the similarity search are linked to particular processes, and those processes to business KPIs and so on

Industry Benchmarking: There are industry standard process flows that the model has been trained on, and with those flows meta-data can be provided such as the average time it should take to perform the given business activity. Those activities are linked to fields in the Steps, and then statistics are given on the fields in relation to the business steps. Such as, the fields contributing to the metric being above or below the industry standard.

Real-time User Experiences: There are various real-time user experiences that are built from the fields that are being captured in real-time and the analysis that can be done using the model. For example, classifying the fields into topics in real time. Classifying the fields into processes, documents, activities, and other entities. Real-time user experiences are that suggest to the user that particular interactions they are taking are inefficient or not to some compliance standard. Real-time user experiences that suggest another set of fields to address an issue they ran into (e.g., “click here to response your VPN issue”).

### 4.3.3 Attributes

Entity Enrichment: Attributes/Identifiers are Fields that contain properties of a business activity, such as a purchase order number for a purchase order process. For these reasons, Attributes will benefit from all of the same enrichment that was described for Fields. Please see the Field entity enrichment section for these reasons. In addition to this, the model's understanding of business context is able to identify possible Attributes from applications, e-mails, conversations, documents, and other identities. It does this through the embedded vector space where, for example, the distance between a value extracted from these entities will match closely with a cluster in the vector space with business context. For example, a number of a purchase order will be nearby the vector space for vectors represented by purchase orders. This is what the model has learned through the training described in that respective section.

Summarization: Attributes/Identifiers are Fields that contain properties of a business activity, such as a purchase order number for a purchase order process. For these reasons, Attributes will benefit from all of the same enrichment that was described for Fields. Please see the Field summarization section for these reasons.

Topic Modelling: Using the topic modelling that was described on Attributes, we can also suggest the business intent or topic that the attributes were related to. By doing so, we can present back the business intent or topics such as the attributes having been related to a “Purchase Order”. It can also be to a higher-level business set of topics such as purchase orders, invoices, reports, contracts, billing, hiring, loans, banking, etc. By doing so, we are able to short-list a set of attributes that are useful to particular processes or types of processes. Attributes can be collected. Topic Modelling helps remove attributes that may not be highly important to the process, which is beneficial given that hundreds or thousands of attributes could have been found during an execution of a process. This can help automatically reduce the number of attributes down substantially for user experiences that have been built.

Similarity Analysis: Using the mechanisms described, we can now perform a similarity analysis across all of the following entities, including similarity analysis with Attributes itself. Again, the exact similarity mechanism used is modular and described in the previous section on the similarity analysis model task.

Usage/Relation To

| | |
|---|---|
| User Interactions | Returns the similarity score between an Attribute |
| | and user interaction. If the user interaction takes |
| | place on the Attribute or an Attribute of similar |
| | business intent, then the score will be greater. |
| Fields | Returns the similarity score between an Attribute |
| | and a Field. If the Attribute was created from or |
| | similar to the Field, it will have a greater score |
| | that is returned. |
| Attributes | Returns the similarity between two Attributes. If the |
| | Attributes are the same it will have a score of 1. If |
| | the Attributes are not the same but have similar |
| | intent (e.g., “Address Field 1” and “Address |
| | Field 2”) they will have a greater similarity |
| | score. |
| Views | Returns the similarity score between an Attribute |
| | and a view. If the Attribute was present in the view, |
| | it will have a greater score that is returned. |
| Activities | Returns the similarity score between an Attribute |
| | and an Activity. If the Attribute was accessed as |
| | a part of the Activity it will return a greater |
| | score. |
| Steps | Returns the similarity score between an Attribute |
| | and a Step. If the Attribute was accessed as a part |
| | of the Step it will return a greater score. |
| Processes | Returns the similarity score between an Attribute |
| | and a Process. If the Attribute was accessed as a |
| | part of the Process it will return a greater score. |
| | Or, if the attribute is semantically related to the |
| | process type (e.g., a purchase order attribute is |
| | more greatly related to a purchase order process). |
| Variations | Returns the similarity score between an Attribute |
| | and a Variation. If the Attribute was accessed as |
| | a part of the Variation it will return a greater |
| | score. |
| Documents | Returns the similarity score between an Attribute |
| | and a Document. If the Attribute was accessed as a |
| | part of the Document it will return a greater score. |
| | Also, greater if the Attribute was accessed as part |
| | of other Documents of a similar topic. |
| Chats/Conversations | Returns the similarity score between an Attribute |
| | and a Conversation. If the Attribute was accessed |
| | as a part of the Conversation it will return a |
| | greater score. Also, greater if the Attribute was |
| | accessed as part of other conversations of a similar |
| | topic. |
| E-Mails | Returns the similarity score between an Attribute |
| | and an E-Mail. If the Attribute was accessed as a |
| | part of the E-Mail it will return a greater score. |
| | Also, if the Attribute was accessed as part of other |
| | e-mails of similar topics. |
| Groups | Returns the similarity score between an Attribute |
| | and a Group of any entities. The similarity with |
| | the individual entities in the group is returned |
| | and averaged for a similarity with the group. |
| | Other than an average, other statistics such as |
| | weighted averages or medians. |
| KPIs | Returns the similarity of the Attribute and the |
| | KPIs, which will be of greater similarity if the |
| | Attribute are influencing or related to the KPIs |
| | (e.g., involved in manual effort which impact the |
| | KPI). |
| Statistics | Returns the similarity of the Attribute and the |
| | given statistic, which will be of greater similarity |
| | if the Attribute is influencing the statistics. |
| User | Returns the similarity of the Attribute and the |
| | user, which will be of greater similarity if this |
| | user performs interactions on the Attribute or |
| | ones like it. |
| Team | Returns the similarity of the Attribute and teams, |
| | which will be of greater similarity if the team |
| | accesses and uses the Attribute or ones like it |
| | for their business activities. |

Fast Similarity Analysis and Search: Attributes will be able to leverage the fast similarity analysis and search model task as previously defined, where we will be able to find similar Attributes to the one provided. This can be used to find similar Attributes (i.e., of the same entity type), or used to find its similarity with other entities. For example, the similarity between a User Interaction and an Attribute would be of greater similarity if the user interaction took place on that Attribute. Therefore, below, we define all of the fast similarity analysis and search across User Interactions and all other entities.

Finding the Usage Of: Finding the usage of Attributes is similar to finding where they took place and their relationship to all other entities. Where a similar Attribute is one that 10 has a high similarity to another Attribute (e.g., both being of the same business intent).

| Usage/Relation To | Description |
|---|---|
| User Interactions | This will return user interactions that took place |
| | on this Attribute or similar ones. |
| Fields | This will return attributes that are based on the |
| | field or a similar one. |
| Attributes | This will return other Attributes that are similar. |
| Views | This will return Views that contain the Attribute |
| | or a similar one. |
| Activities | This will return Activities where the Attribute or |
| | a similar one is used. |
| Steps | This will return Steps that use the Attribute or a |
| | similar one. |
| Processes | This will return Processes that use the Attribute or |
| | a similar one. |
| Variations | This will return Variations that use the Attribute or |
| | a similar one. |
| Documents | This will return Documents that use the Attribute or |
| | a similar one. |
| Chats/Conversations | This will return Conversations that use the Attribute |
| | or a similar one. |
| E-Mails | This will return E-mails that use the Attribute or a |
| | similar one. |
| Groups | This will return Groups of entities that use the |
| | Attribute or a similar one. |
| KPIs | This will return KPIs that the interactions occur |
| | on the Attribute or a similar one. |
| Statistics | This will return Statistics that interactions occur |
| | on the Attribute or a similar one have an influence |
| | on. |
| User | This will return Users who performed interactions |
| | on this Attribute or one like it. |
| Teams | This will return Teams who performed interactions |
| | on this Attribute or one like it. |

Grouping: Attributes can now be grouped by their semantic similarity, or their intent as described in the model task. This can now group several interactions like Attribute 1, Attribute 2, Attribute 3, etc. together via the model tasks that were described.

Interactive Queries: There are various interactive queries that can now be asked and answered for attributes aka identifiers like what are the types of identifiers found in a process, what category of identifiers are seen, what are the top values of an identifier for a particular process, how many identifiers are normally seen for a particular process or a group of process which is another way to determine the number of transactions, what is the time taken for an identifier to be tracked through a process, find me all identifiers which signify a category, find me all processes where identifier x is seen, what is the turnaround time for an identifier to reappear etc.

Generation Of: Automation of business activities often happens at the user attribute level, by replaying back what user interactions occur for the process steps. The model has seen and been trained on processes and their flows through the application, so using the generative tasks previously described it can generate a single user interaction or sequence of them. This can help automatically generate automation that performs business processes. Additionally, generating more efficient versions of the user interactions. Generating attributes for applications that may be required, or a more efficient set of attributes by understanding what is required of the process is now possible.

Impact on Business KPIs: With the understanding and similarity analysis built into the model, there is now a link between business KPIs and the attributes. This can therefore allow user experiences that link the attributes to their impact on business KPIs. Such as, determining that inefficient attributes are a reason for the processing time of purchase orders to be slow. Attributes are tied to many business KPIs since it is the users who are conducting various critical steps in a process. Exact attributes via the similarity search are linked to particular processes, and those processes to business KPIs and so on.

Industry Benchmarking: There are industry standard process flows that the model has been trained on, and with those flows meta-data can be provided such as the average time it should take to perform the given business activity. Those activities are linked to attributes in the Steps, and then statistics are given on the attributes in relation to the business steps. Such as, the attributes contributing to the metric being above or below the industry standard.

Real-time User Experiences: There are various real-time user experiences that are built from the attributes that are being captured in real-time and the analysis that can be done using the model. For example, classifying the attributes into topics in real time. Classifying the attributes into processes, documents, activities, and other entities. Real-time user experiences are that suggest to the user that particular interactions they are taking are inefficient or not to some compliance standard. Real-time user experiences that suggest another set of attributes to address an issue they ran into (e.g., “click here to response your VPN issue”).

### 4.3.4 Views

Entity Enrichment: Views are an abstraction of what a user sees in a business application, similar to what one might consider an application window. The importance of this entity enrichment is that it can overcome substantial challenges with applications being built that do not have good labels for activities that the user is performing. For example, gaps in having good application screen titles at the top of the window. By enriching or replacing the information that would have previously been captured in the screen's title, we can greatly improve the fidelity of the information which has a substantial impact on downstream uses of the information such as process discovery. Without this kind of entity enrichment, then Process Discovery may incorrectly think that interactions happening in the application are the same, when in fact they may not be. Whereas one might have only been able to assign a generic View label associated with it (e.g., “View 3”) it can now be possible to replace such a title with “Create Purchase Order” by understanding the business context with it.

### Summarization:

| Few Words | One Sentence | |
|---|---|---|
| Summary | Summary | |
| Example | Example | One Paragraph Summary Example |
| B005 - | Customer | View allowing edit or creation of new |
| Customer | Billing & | Customers with their banking and |
| Update | Banking | billing information in order to generate |
| | Swift Code | invoices for their purchases |
| | Details | |
| | Update | |

Topic Modelling: Using the topic modelling that was described on Views, we can also suggest the business intent or topic that the user interactions were related to. By doing so, we can present back the business intent or topics such as the View having been related to Creating a Purchase Order. It can also be to a higher-level business set of topics such as purchase orders, invoices, reports, contracts, billing, hiring, loans, banking, etc. Particular verbs can also be part of the modelling to know it is not just about invoices but creating invoices. Those are all labels that can be trained and has been discussed earlier in this work.

Similarity Analysis: Using the mechanisms described, we can now perform a similarity analysis across all of the following entities, including similarity analysis with Views itself. Again, the exact similarity mechanism used is modular and described in the previous section on the similarity analysis model task.

Usage/Relation To

| | |
|---|---|
| User Interactions | Returns the similarity score between a View and |
| | user interaction. If the user interaction takes |
| | place on the View or a View of similar business |
| | intent, then the score will be greater. |
| Fields | Returns the similarity between a View and a field, |
| | determined based on whether the field is a part of |
| | the view or a similar view. |
| Attributes | Returns the similarity between an attribute and a |
| | View, determined based on whether the attribute is |
| | a part of the view or a similar view. |
| Views | Returns the similarity between two Views. If the |
| | Views are the same it will have a score of 1. If |
| | the Views are not the same but have similar intent |
| | they will have a greater similarity score. |
| Activities | Returns the similarity score between a View and an |
| | Activity. If the View was accessed as a part of the |
| | Activity it will return a greater score. |
| Steps | Returns the similarity score between a View and |
| | a Step. If the View was accessed as a part of the |
| | Step it will return a greater score. |
| Processes | Returns the similarity score between a View and a |
| | Process. If the View was accessed as a part of the |
| | Process it will return a greater score. Or, if the |
| | View is semantically related to the process type |
| | (e.g., a purchase order View is more greatly related |
| | to a purchase order process). |
| Variations | Returns the similarity score between a View and a |
| | Variation. If the View was accessed as a part of the |
| | Variation it will return a greater score. |
| Documents | Returns the similarity score between a View and a |
| | Document. If the View was accessed as a part of the |
| | Document it will return a greater score. Also, |
| | greater if the View was accessed as part of other |
| | Documents of a similar topic. |
| Chats/Conversations | Returns the similarity score between a View and a |
| | Conversation. If the View was accessed as a part |
| | of the Conversation it will return a greater score. |
| | Also, greater if the View was accessed as part of |
| | other conversations of a similar topic. |
| E-Mails | Returns the similarity score between a View and an |
| | E-Mail. If the View was accessed as a part of the |
| | E-Mail it will return a greater score. Also, if the |
| | View was accessed as part of other e-mails of |
| | similar topics. |
| Groups | Returns the similarity score between a View and a |
| | Group of any entities. The similarity with the |
| | individual entities in the group is returned and |
| | averaged for a similarity with the group. Other than |
| | an average, other statistics such as weighted |
| | averages or medians. |
| KPIs | Returns the similarity of the View and the KPIs, |
| | which will be of greater similarity if the View are |
| | influencing or related to the KPIs (e.g., involved |
| | in manual effort which impact the KPI). |
| Statistics | Returns the similarity of the View and the given |
| | statistic, which will be of greater similarity if the |
| | View is influencing the statistics. |
| User | Returns the similarity of the View and the user, |
| | which will be of greater similarity if this user |
| | performs interactions on the View or ones like it. |
| Team | Returns the similarity of the View and teams, which |
| | will be of greater similarity if the team accesses and |
| | uses the View or ones like it for their business |
| | activities. |

Fast Similarity Analysis and Search: Views will be able to leverage the fast similarity analysis and search model task as previously defined, where we will be able to find similar Views to the one provided. This can be used to find similar Views (i.e., of the same entity type), or used to find its similarity with other entities. For example, the similarity between a User Interaction and a View would be of greater similarity if the user interaction took place on that View. Therefore, below, we define all of the fast similarity analysis and search across User Interactions and all other entities.

Finding the Usage Of: Finding the usage of Views is defined as the following. Similar Views are ones that contain similar fields, attributes, or intent as the original View used when finding the usage of.

| Usage/Relation To | Description |
|---|---|
| User Interactions | This will return user interactions that took |
| | place on this View or similar ones. |
| Fields | This will return other Fields that are similar or |
| | take place with the View. |
| Attributes | This will return attributes that are based on the |
| | View or a similar one. |
| Views | This will return Views that are similar to the View |
| | provided. |
| Activities | This will return Activities where the View or a |
| | similar one is used. |
| Steps | This will return Steps that use the View or a |
| | similar one. |
| Processes | This will return Processes that use the View or a |
| | similar one. |
| Variations | This will return Variations that use the View or a |
| | similar one. |
| Documents | This will return Documents that use the View or a |
| | similar one. |
| Chats/Conversations | This will return Conversations that use the View or |
| | a similar one. |
| E-Mails | This will return E-mails that use the View or a |
| | similar one. |
| Groups | This will return Groups of entities that use View |
| | field or a similar one. |
| KPIs | This will return KPIs that the interactions occur |
| | on the View or a similar one. |
| Statistics | This will return Statistics that interactions on |
| | the View or a similar one it has an influence on. |
| User | This will return Users who performed interactions |
| | on this View or one like it. |
| Teams | This will return Teams who performed interactions |
| | on this View or one like it. |

Grouping: Views can now be grouped by their semantic similarity, or their intent as described in the model task. This can now group several interactions like View 1, View 2, View 3, etc. together via the model tasks that were described.

Interactive Queries: There are many interactive queries that become enabled with View-level data learned by the model. For example, the ability to ask for what views are related to the business process. What views users spend the most effort on. What views should be made more efficient. What Views contain particular fields or attributes. What processes use a particular view (e.g., that an IT team may want to deprecate) and so on.

Generation Of: Views are important to the productivity of users conducting business processes. The more efficient the views are in their layout, the more quickly that the users can complete their business activities. Once the model understands the business context of a process and activities, it can generate a view for a given activity or business task. This would be similar to generating a document for a given activity or business task. This is beneficial for all of the customization done on CRM systems that are trying to build the best and most efficient views for users to complete tasks, as well as other systems (not just CRM).

Impact on Business KPIs: With the understanding and similarity analysis built into the model, there is now a link between business KPIs and the views. This can therefore allow user experiences that link the views to their impact on business KPIs. Such as, determining that inefficient views are a reason for the processing time of purchase orders to be slow. Views are tied to many business KPIs since it is the users who are conducting various critical steps in a process. Exact views via the similarity search are linked to particular processes, and those processes to business KPIs and so on.

Industry Benchmarking: There are industry standard process flows that the model has been trained on, and with those flows meta-data can be provided such as the average time it should take to perform the given business activity. Those activities are linked to views in the Steps, and then statistics are given on the views in relation to the business steps. Such as, the views contributing to the metric being above or below the industry standard.

Real-time User Experiences: There are various real-time user experiences that are built from the views that are being captured in real-time and the analysis that can be done using the model. For example, classifying the user interactions that are happening in the view in real time. Classifying the views into processes, documents, activities, and other entities. Real-time user experiences are that suggest to the user that particular interactions they are taking are inefficient or not to some compliance standard. Real-time user experiences that suggest another set of views to address an issue they ran into (e.g., “click here to response your VPN issue”).

### 4.3.5 Activities

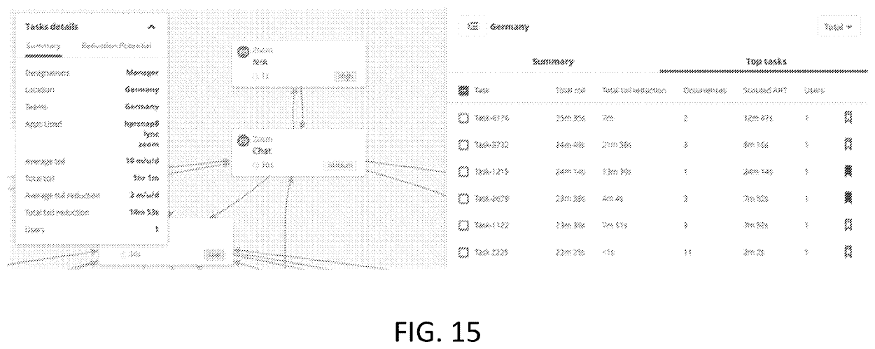

Entity Enrichment: There are techniques that find repetitive patterns in the data without any training and present these patterns back to users with statistics such as how much effort they spend performing the repetitive pattern (i.e., “Total toil” or “Total effort”), and how much of it is automatable (i.e., “Total toil reduction”). This is shown in FIG. 15.

Although we have been able to discover repetitive patterns, historically we have not been able to label the pattern with any business understanding or intent, as shown in FIG. 15 where each repetitive pattern has been given a generic name like Task-4174 or Task-3723. This makes it difficult to understand the purpose of the repetitive pattern, and if an individual is looking for repetitive work related to a particular business activity, they will have a very hard time in doing so. Therefore, without more business context it is significantly harder for anyone to understand the intent of the pattern and to find patterns that match a particular business activity.

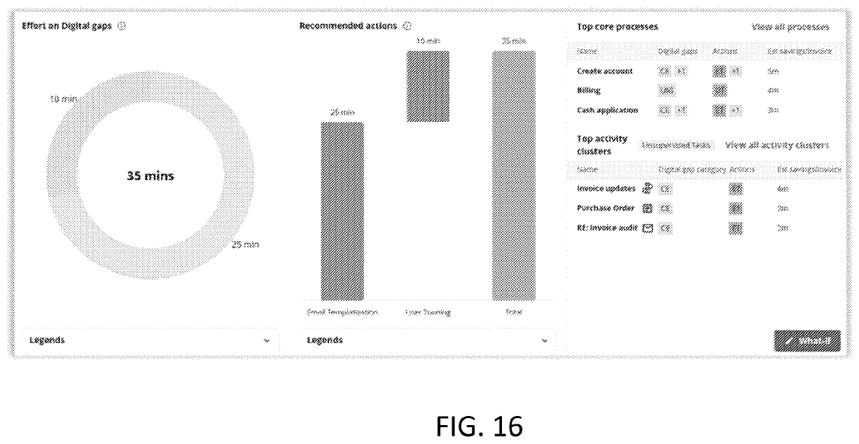

By using classification layers with the model that was described in previous sections, we are now able to get the model to predict the intent of the business activity. Using the intent determined from the model, we are now able to detect the intent for all of the discovered activities and first group them together whereas previous this could have been a flat list of repetitive patterns that were discovered. In the bottom right of FIG. 16, it shows clusters or groups based on the business intent, such as “Invoice updates.”

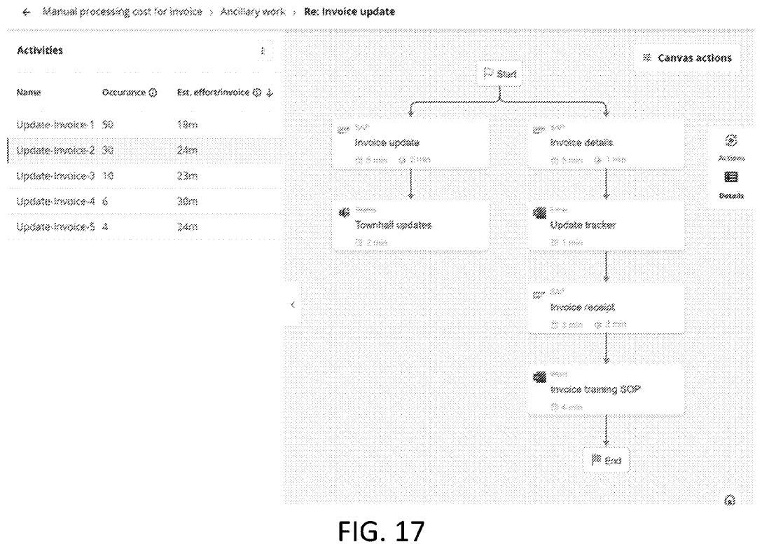

When the cluster or group is interacted with, it can then show all of the repetitive patterns or activities that were related to that exact business intent. This is shown in FIG. 17, where in comparison to the flat list of activities that had no business intent labelled Task-4174 or Task-3723 they can now be labelled with their intent such as “Update-Invoice-1” and “Update-Invoice-2” which are both activities related to this first group of activities.

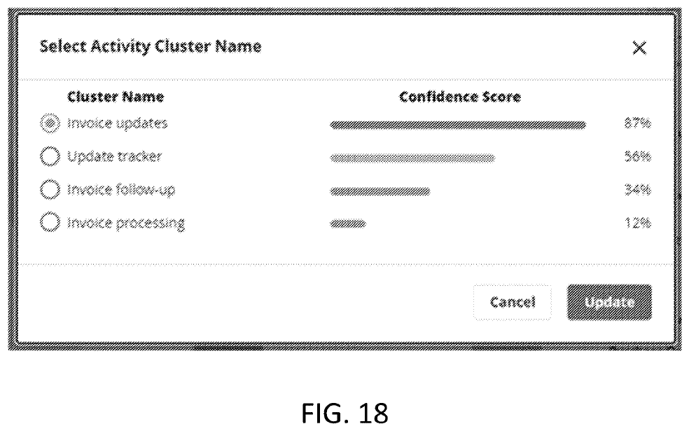

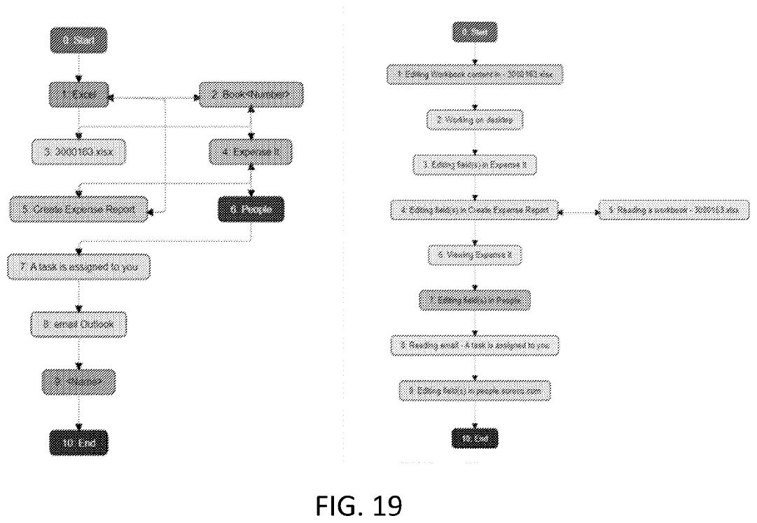

The model is predicting this intent based on all of the information that was observed from the applications and documents, as described in the earlier sections on how the model is designed and trained. The final layers in the model can then be fine-tuned to predict the activity that the user is performing or generating a description of it. That comes with a confidence level that can then be displayed back to the user as shown in FIG. 18. This can be used for them to apply a different predicted label instead, which can update the name of the activity for them as well as provide feedback and additional training back to the machine learning algorithm.

### Summarization:

| Few Words | One Sentence | |
|---|---|---|
| Summary | Summary | One Paragraph Summary |
| Example | Example | Example |
| Create | Creating | Creation of leads in salesforce |
| Lead via | lead via | when emails for demo or pricing |
| | Salesforce | enquiries are received via the |
| salesforce | for email | customer query mailbox |
| | queries | |

Topic Modelling: Topic modelling on Activities has been described as a part of Entity Enrichment for them (e.g., as they get classified into business processes).

Similarity Analysis: Using the mechanisms described, we can now perform a similarity analysis across all of the following entities, including similarity analysis with Activities itself. Again, the exact similarity mechanism used is modular and described in the previous section on the similarity analysis model task.

Usage/Relation To

| | |
|---|---|
| User | Returns the similarity score between an Activity |
| Interactions | and user interaction. If the user interaction |
| | takes place on the Activity or an Activity of |
| | similar business intent, then the score will be |
| | greater. |
| Fields | Returns the similarity between an Activity |
| | and a field, determined based on whether the |
| | field is a part of the Activity or a similar |
| | Activity. |
| Attributes | Returns the similarity between an attribute and an |
| | Activity, determined based on whether the attribute |
| | is a part of the Activity or a similar Activity. |
| Views | Returns the similarity score between a View and an |
| | Activity. If the View was accessed as a part of the |
| | Activity it will return a greater score |
| Activities | Returns the similarity between two Activities. If the |
| | Activities are the same it will have a score of 1. |
| | If the Activities are not the same but have similar |
| | intent they will have a greater similarity score. |
| Steps | Returns the similarity score between an Activity and |
| | a Step. If the Activity was performed as a part of |
| | the Step it will return a greater score. |
| Processes | Returns the similarity score between an Activity |
| | and a Process. If the Activity was performed as a |
| | part of the Process it will return a greater score. |
| | Or, if the Activity is semantically related to the |
| | process type (e.g., a purchase order Activity is |
| | more greatly related to a purchase order process). |
| | This can allow the Activity to be automatically |
| | associated to a process. |
| Variations | Returns the similarity score between an Activity |
| | and a Variation. If the Activity was performed as |
| | a part of the Variation it will return a greater |
| | score. |
| Documents | Returns the similarity score between an Activity |
| | and a Document. If the Activity was performed as |
| | a part of accessing the Document it will return |
| | a greater score. Also, greater if the Activity |
| | was performed as part of other Documents of a |
| | similar topic. |
| Chats/Conversations | Returns the similarity score between an Activity and |
| | a Conversation. If the Activity was performed as a |
| | part of the Conversation it will return a greater |
| | score. Also, greater if the Activity was performed |
| | as part of other conversations of a similar topic. |
| E-Mails | Returns the similarity score between an Activity |
| | and an E-Mail. If the Activity was performed as a |
| | part of the E-Mail it will return a greater score. |
| | Also, if the Activity was performed as part of other |
| | e-mails of similar topics. |
| Groups | Returns the similarity score between an Activity |
| | and a Group of any entities. The similarity with |
| | the individual entities in the group is returned and |
| | averaged for a similarity with the group. Other than |
| | an average, other statistics such as weighted |
| | averages or medians. |
| KPIs | Returns the similarity of the Activity and the KPIs, |
| | which will be of greater similarity if the Activity |
| | are influencing or related to the KPIs (e.g., |
| | involved in manual effort which impact the KPI). |
| Statistics | Returns the similarity of the Activity and the given |
| | statistic, which will be of greater similarity |
| | if the Activity is influencing the statistics. |
| User | Returns the similarity of the Activity and the user, |
| | which will be of greater similarity if this user |
| | performs the Activity or ones like it. |
| Team | Returns the similarity of the Activity and teams, |
| | which will be of greater similarity if the team |
| | performed the Activity or ones like it for their |
| | business activities. |

Fast Similarity Analysis and Search: Fast similarity analysis and search can now be performed on Activities, who will be present in the vector space. Finding all occurrences of an Activity can now happen by passing it through the encoder to get its vector and looking for all instances of that vector. Similarity search can also happen by looking for nearest neighbors in the vector space for a given Activity's vector. That provides back similar activities.

Finding the Usage Of: Finding the usage of Activities is defined as the following. Similar Activities are ones that contain similar steps, user interactions, views, etc. when finding the usage of.

| Usage/Relation To | Description |
|---|---|
| User Interactions | This will return user interactions that took place |
| | as a part of this Activity or similar ones. |
| Fields | This will return other Fields that are similar or |
| | used as a part of this Activity or similar ones. |
| Attributes | This will return attributes that are present as a |
| | part of this Activity or similar ones. |
| Views | This will return Views that are used as a part of this |
| | Activity or similar ones. |
| Activities | This will return Activities that are similar to each |
| | other. |
| Steps | This will return Steps that are a part of this Activity |
| | or a similar one. |
| Processes | This will return Processes that contain this Activity |
| | or a similar one. |
| Variations | This will return Variations that contain this Activity |
| | or a similar one. |
| Documents | This will return Documents that are a part of this |
| | Activity or a similar one. |
| Chats/Conversations | This will return Conversations that are a part of this |
| | Activity or a similar one. |
| E-Mails | This will return E-mails that are a part of this |
| | Activity or a similar one. |
| Groups | This will return Groups of entities that contain this |
| | Activity or a similar one. |
| KPIs | This will return KPIs that the Activity influences or |
| | a similar one. |
| Statistics | This will return Statistics that the Activity or a |
| | similar one have influence on. |
| User | This will return Users who performed this Activity |
| | or one like it. |
| Teams | This will return Teams who performed this Activity |
| | or one like it. |

Grouping: The grouping of Activities has already been described in the Entity Enrichment section. This is where we showed all “Invoice update” related activities grouped together in the activity clusters as shown in FIG. 16.

Interactive Queries: There can be various different types of interactive questions asked in activities which would provide a great deal of insight on the activities. Some of the examples are as what are the kind of activities which are happening around the email topic, “Invoice ID 345876”, what activities can be found to happen around document “Purchase Order No 768”, which activities are seen to happen between 2 to 4 PM on weekdays, which activities are seen in the London office done by the Process Managers, show the activities 10 which have toil greater than 6 hours, show the activities which have more than 2 users involved in those etc.

Generation Of: Activities being a series of user interactions on fields and inside of Views, can similarly be generated like those attributes. This is by using the generative layers described in the model tasks section. By generating activities we can then generate the user interactions that are part of the Activities. Since all of the user interaction detail is collected, automation can then be generated which performs the same activity as the user.

Impact on Business KPIs: Activities have a strong relationship with business KPIs as they are repetitive steps that users perform to complete business actions. The activities can be related to the business KPIs based on the topics that the activity belonged to or the processes that the activity belonged to, both of which are linked to business KPIs. Therefore, once an Activity is selected, we can show which business KPIs it influences, just like we have illustrated for Documents below.

Industry Benchmarking: Activities are a set of user interactions that the users are taking across fields to perform a business action, such as to submit an invoice. As part of the industry standard processes the model is learning, activities can get mapped to individual steps in those standard process flows along with their statistics. This allows for mapping of the industry benchmarks to the interactions that are taking place.

Real-time User Experiences: There are various real-time user experiences that are built from the activities that are being captured in real-time and the analysis that can be done using the model. For example, classifying the user interactions into topics in real time. Classifying the user interactions into processes, documents, activities, and other entities. Real-time user experiences are that suggest to the user that particular interactions they are taking are inefficient or not to some compliance standard. Real-time user experiences that suggest another set of user interactions to address an issue they ran into (e.g., “click here to response your VPN issue”).

### 4.3.6 Steps

Entity Enrichment: One of the challenges in user interaction data is that the default information available from the application can be very sparse. It can be lacking sufficient business context that would help a user understand the actual business activity that was being performed.

In the example shown in FIG. 13, there are many user interactions that are shown which do not have business context associated to them. For example, “Editing field(s) in People” is for what purpose? And “Reading email-A task is assigned to you” also does not carry context of what the e-mail's business purpose is, for example. This is because interaction data is often very low level, but with the model that has been trained in the prior example we can use it to add additional business context and understanding to every interaction.

The way that this is done is by taking the user interaction that the user performed, and having the model generate a few additional labels that describe the work the user was doing, by observing business context that was in the application, document, e-mail, etc. and having the model's decoder layer return back a set of business context labels that can be applied to the activity. For example, as shown in previous sections about training the model there may be additional context in the application when “Editing field(s) in People” occurred that can now be used to pass to the model again to have it find these fields in the vector space and return back labels of business context with it.

By doing so, we can generate a far more descriptive version of what the user was conducting with a greater level of business understanding as shown in FIG. 14.

### Summarization:

| Few Words | One Sentence | |
|---|---|---|
| Summary | Summary | One Paragraph Summary |
| Example | Example | Example |
| Form Submission | Update Customer | Update of Customer shipping |
| ‘B005 - Customer | delivery details | instructions, address and labelling |
| Update’ | via the SAP | name via the SAP ‘B005 Customer |
| | ‘B005 Customer | Update’ in Sap as part of the Order |
| | Update’ form | Fulfilment & Management |

Topic Modelling: Steps can be passed to the topic modelling model task as described in the previous section. By using the information contained in the step such as the user interactions, fields, and attributes that are summarized as a part of it a topic or set of labels can also be provided to the Step.

Similarity Analysis: Using the mechanisms described, we can now perform a similarity analysis across all of the following entities, including similarity analysis with Steps itself. Again, the exact similarity mechanism used is modular and described in the previous section on the similarity analysis model task.

Usage/Relation To

| | |
|---|---|
| User Interactions | Returns the similarity score between a Step |
| | and user interaction. If the user interaction |
| | takes place on the Step of similar business |
| | intent, then the score will be greater. |
| Fields | Returns the similarity between a Step and a |
| | field, determined based on whether the field |
| | is a part of the Step or a similar Step. |
| Attributes | Returns the similarity between an attribute |
| | and a Step, determined based on whether the |
| | attribute is a part of the Step or a similar |
| | Step. |
| Views | Returns the similarity score between a View |
| | and a Step. If the View was accessed as a part |
| | of the Step it will return a greater score |
| Activities | Returns the similarity score between an Activity |
| | and a Step. If the Activity was performed as |
| | a part of the Step it will return a greater score. |
| Steps | Returns the similarity between two Steps. If |
| | the Steps are the same it will have a score of 1. |
| | If the Steps are not the same but have similar |
| | intent they will have a greater similarity score. |
| Processes | Returns the similarity score between a Step |
| | and a Process. If the Step was performed as a |
| | part of the Process it will return a greater |
| | score. Or, if the Step is semantically related |
| | to the process type (e.g., a purchase order Step |
| | is more greatly related to a purchase order |
| | process). |
| Variations | Returns the similarity score between a Step and |
| | a Variation. If the Step was performed as a part |
| | of the Variation it will return a greater score. |
| Documents | Returns the similarity score between a Step and |
| | a Document. If the Step was performed as a part |
| | of accessing the Document it will return a greater |
| | score. Also, greater if the Step was performed as |
| | part of other similar Documents of a similar topic. |
| Chats/Conversations | Returns the similarity score between a Step and |
| | a Conversation. If the Step was performed as a |
| | part of the Conversation it will return a greater |
| | score. Also, greater if the Step was performed |
| | as part of other conversations of a similar topic. |
| E-Mails | Returns the similarity score between a Step and |
| | an E-Mail. If the Step was performed as a part |
| | of the E-Mail it will return a greater score. |
| | Also, if the Step was performed as part of other |
| | e-mails of similar topics. |
| Groups | Returns the similarity score between a Step and |
| | a Group of any entities. The similarity with the |
| | individual entities in the group is returned and |
| | averaged for a similarity with the group. Other |
| | than an average, other statistics such as weighted |
| | averages or medians. |
| KPIs | Returns the similarity of the Step and the KPIs, |
| | which will be of greater similarity if the Steps |
| | are influencing or related to the KPIs (e.g., |
| | involved in manual effort which impact the KPI). |
| Statistics | Returns the similarity of the Step and the given |
| | statistic, which will be of greater similarity |
| | if the Step is influencing the statistics. |
| User | Returns the similarity of the Step and the user, |
| | which will be of greater similarity if this user |
| | performs the Step or ones like it. |
| Team | Returns the similarity of the Step and teams, |
| | which will be of greater similarity if the team |
| | performed the Step or ones like it for their |
| | business activities. |

Fast Similarity Analysis and Search: As described in the model tasks of finding similarity entities, this is also applicable to Steps. Based on the vectorized representation of the steps and the lookup of similar ones in the vector space that has been trained and/or collected during the usage of the technology.

Finding the Usage Of: Finding the usage of Steps is defined as the following. Similar Steps are ones that contain similar activities, user interactions, views, etc. when finding the usage of.

| Usage/Relation To | Description |
|---|---|
| User Interactions | This will return user interactions that took place as a |
| | part of this Step or similar ones. |
| Fields | This will return other Fields that are similar or used |
| | as a part of this Step or similar ones. |
| Attributes | This will return attributes that are present as a part |
| | of this Step or similar ones. |
| Views | This will return Views that are used as a part of this |
| | Step or similar ones. |
| Activities | This will return Steps that are a part of this Activity |
| | or a similar one. |
| Steps | This will return Steps that are similar to each other. |
| Processes | This will return Processes that contain this Step or a |
| | similar one. |
| Variations | This will return Variations that contain this Step or |
| | a similar one. |
| Documents | This will return Documents that are a part of this |
| | Step or a similar one. |
| Chats/Conversations | This will return Conversations that are a part of this |
| | Step or a similar one. |
| E-Mails | This will return E-mails that are a part of this Step |
| | or a similar one. |
| Groups | This will return Groups of entities that contain this |
| | Step or a similar one. |
| KPIs | This will return KPIs that the Step influences or a |
| | similar one. |
| Statistics | This will return Statistics that the Step or a similar |
| | one have influence on. |
| User | This will return Users who performed this Step or |
| | one like it. |
| Teams | This will return Teams who performed this Step or |
| | one like it. |

Grouping: Steps like all other entities have a vector representation, and that representation as described in the training and model tasks section can be used for grouping like all other entities. This means that steps that are similar can be grouped together by having similar vector values and distances to them which can be applied to group similar steps together. Similar groups of steps will help users identify where similar work is being done.

Interactive Queries: Some of the interactive queries which can be asked on the steps are as follows, which processes have a step where the invoice id 564983 is referenced, find the steps where there is a transition between email and the document Customer List, find the steps where the document Process Order List is read from, find the steps where User abc@xyx.com is involved etc.

Generation Of: Like other entities, the model tasks described can generate or suggest more efficient Steps that are a part of an Activity, Process, Variation, Document, etc. These Steps can be suggested based on an understanding of the industry process templates, or from what the model has learned about how the Step is performed by the users or others who have contributed data about this Step. The generated Step could be more efficient in that it contains less user interactions or manual effort.

Impact on Business KPIs: Processes are linked to KPIs based on configuration or the understanding that certain KPIs are related to certain business functions or processes, and with the detection of the process being done the KPIs can therefore be automatically linked to the process. Once the KPIs are associated with the process, the inefficient Steps can be determined (e.g., via large amounts of manual effort) and therefore be indicators of having an impact on the business KPI. It can be large amounts of manual effort that identify the steps as having an impact on a KPI, large wait times for the step to be completed, that step being prone to errors in the process, and others.

Industry Benchmarking: Using the process templates as described before for training the model, there is an understanding of individual processes as associated to the classification of the process. The steps in those process templates can be linked to the steps being performed by the user, along with the industry benchmarks for those steps. If any benchmarks are learned from customers using the product, those can also be used as a comparison.

Real-time User Experiences: Using the detection of processes and the steps being performed, real-time use cases allow the product to notify the user of the steps being performed and just like will be discussed in real-time user experiences of Processes and can A) Inform the user of compliance against a known way of performing the step, B) Suggest the appropriate next step to take, C) Inform the user that they likely missed a step, D) Help the user by showing them how to conduct the business step, and/or E) Helping the user by detecting issues in them performing the step with possible solutions being shown to them. Also, detecting issues in performing the step and informing the user of ways to resolve it based on the step being performed.

Steps as defined are series of User Interactions that someone may perform when conducting an Activity or Process, as an example. Based on what can be given to the product such as learned compliant ways of conducting the process (e.g., via ‘teaching’ or recordings previously defined, and SOP documents), the user's Steps can be evaluated against what the model has learned as the compliant way of performing the process. Then, the product can notify that the user is not performing the Steps properly. When the product notifies of this, it can give the proper next set of steps that it has learned by example or definition.

Since the product can be aware of the proper next set of steps learned by example or definition, it can also notify the user of the best next set of steps. For example, if it is expected that after they create a Purchase Order that it is tracked in a spreadsheet then they can be notified that those are the likely next steps. Using this same mechanism, it is therefore easy to detect that they have likely missed a step. That may not be a compliance issue (e.g., sometimes Steps are optional in business Activities or Processes) but they can be notified of a likely miss. The user can then choose to take action on it or ignore the notification.

If the user is not sure of how to perform the next set of Steps, since the product has learned what they are via example or definition it can also provide a set of instructions to perform them. Those instructions can be natural language provided back to the user, a flow graph of the steps to perform, a series of images showing how to perform them, and/or link out to a user guide. This can help guide users on how to perform the appropriate set of steps, useful in training and for productivity over time.

As also will be described in the Applications section, it is possible to detect or have the user manually report that they are experiencing an issue. Once that is known, these same mechanisms can be used to determine what best next Steps are typically followed by users. Those steps can be shown to the user as natural language back, a flow graph, a series of images, links to user guides, etc. That may help the user resolve the issue in real-time instead of having to file tickets or reaching out to other team members which would block their ability to continue their work for some time.

### 4.3.7 Processes

Entity Enrichment: The processes or their variations are normally represented in a particular way which makes them non-comprehendible from the business context. As a result of that sometimes the process or its variations are not identifiable by the users of the process.

A process is normally expressed as a set of interactions/screen titles which is very similar to FIG. 19. Though the information in FIG. 19 is very detailed it fails to garner sufficient familiarity with the users or specifically business users for whom its particularly difficult to remember the specific steps or integrations

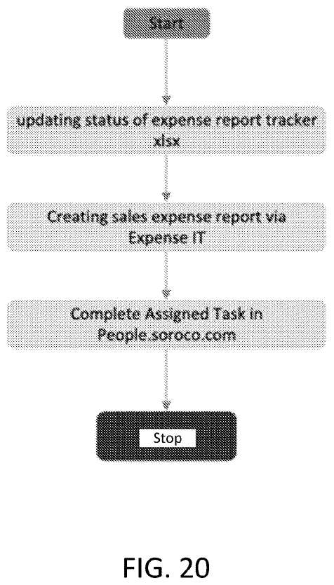

The model by virtue of being trained across multiple processes across various users in multiple business domains has vector space of processes, its steps, its interactions, its applications, its documents, its emails which are tagged into specific respective clusters. Hence when by virtue of that vector space any sample provided to the model helps it find a strong similarity to one or more clusters. From the quantum of similarity found the nearest neighbor can be identified. Then by using the contextual additional labels that describe the work the user was doing, by observing business context that was in the application, document, e-mail, etc. and having the model's decoder layer return back a set of business context labels that can be applied to the activity. By doing so, we can generate a far more descriptive version of what the user was conducting with a greater level of business understanding as shown in FIG. 20.

By being trained on the information presented in the respective training section of the model, it is able to learn what better boundaries of processes are. For example, by taking the industry benchmarks of processes but also through the labels of processes changing.

### Summarization:

| Few Words | One Sentence | |
|---|---|---|
| Summary | Summary | One Paragraph Summary |
| Example | Example | Example |
| Invoice | Invoice Update | Updating of Invoice of |
| Update | requested via Email | <Customer_Name>requested via |
| | Confirmation or | Emails or Service Desk Tickets by |
| | Service Desk Tickets | the service desk team within 1 hour |
| | | of receiving the request on average |

Topic Modelling: Processes along with their steps, activities, fields, and user interactions can all be provided to the model task of topic modelling to be able to automatically classify them towards particular business activities. For example, to automatically classify the process as being a Purchase Order Creation process and so on. These are all labels that the model described in the model tasks can produce. This enables the user real-time experiences that are described below.

Similarity Analysis: Using the mechanisms described, we can now perform a similarity analysis across all of the following entities, including similarity analysis with a Process itself. Again, the exact similarity mechanism used is modular and described in the previous section on the similarity analysis model task.

Usage/Relation To

| | |
|---|---|
| User Interactions | Returns the similarity score between a Process |
| | and user interaction. If the user interaction |
| | takes place in the Process or another one of |
| | similar business intent, then the score will be |
| | greater. |
| Fields | Returns the similarity between a Process and a |
| | field, determined based on whether the field is |
| | a part of the Process or a similar Process. |
| Attributes | Returns the similarity between an attribute and |
| | a Process, determined based on whether the attribute |
| | is a part of the Process or a similar Process. |
| Views | Returns the similarity score between a View and a |
| | Process. If the View was accessed as a part of the |
| | Process it will return a greater score |
| Activities | Returns the similarity score between an Activity |
| | and a Process. If the Activity was performed as |
| | a part of the Process it will return a greater |
| | score. |
| Steps | Returns the similarity score between a Step and a |
| | Process. If the Step was performed as a part of |
| | the Process it will return a greater score. Or, |
| | if the Step is semantically related to the process |
| | type (e.g., a purchase order Step is more greatly |
| | related to a purchase order process). |
| Processes | Returns the similarity between two Processes. If |
| | the Processes are the same it will have a score of |
| | 1. If the Processes are not the same but have similar |
| | intent they will have a greater similarity score. |
| Variations | Returns the similarity score between a Process and |
| | a Variation. If the Variation was performed as a |
| | part of the Process it will return a greater score. |
| Documents | Returns the similarity score between a Process and |
| | a Document. If the Document was accessed as a part |
| | of the Process it will return a greater score. Also, |
| | greater if the Document was accessed in a similar |
| | Process it will return a greater score. |
| Chats/Conversations | Returns the similarity score between a Process and |
| | a Conversation. If the Conversation was part of |
| | conducting the Process it will return a greater |
| | score. Also, greater if the Conversation takes place |
| | for another Process of similar relationship it will |
| | return a greater score. |
| E-Mails | Returns the similarity score between a Process and |
| | an E-Mail. If the E-Mail or E-Mails like it of |
| | similar topic were read, accessed, sent, etc. as |
| | a part of the Process it will return a greater score. |
| Groups | Returns the similarity score between a Process and a |
| | Group of any entities. The similarity with the |
| | individual entities in the group is returned and |
| | averaged for a similarity with the group. Other than |
| | an average, other statistics such as weighted |
| | averages or medians. |
| KPIs | Returns the similarity of the Process and the KPIs, |
| | which will be of greater similarity if the Process |
| | is influencing or related to the KPIs (e.g., involved |
| | in manual effort which impact the KPI). |
| Statistics | Returns the similarity of the Process and the given |
| | statistic, which will be of greater similarity if the |
| | Process is influencing the statistics. |
| User | Returns the similarity of the Process and the user, |
| | which will be of greater similarity if this user |
| | performs the Process or ones like it. |
| Team | Returns the similarity of the Process and teams, |
| | which will be of greater similarity if the team |
| | performed the Process or ones like it for their |
| | business activities. |

Fast Similarity Analysis and Search: Similar processes can easily be found by vectorizing the entity, e.g., Steps that belong to it, and then looking for similar processes in the vector space using the techniques described in the model tasks section. This will allow for quick search of similar processes, as well as to be able to compute the similarity of them.

This will also enable other ways of searching for the process, by converting another representation of the way the process is performed into a series of User Interactions, Steps, or Activities that represent the process. This conversion can build a signature of the process that can then be searched for, and used as training for how the process is performed. For example, by taking a natural language description of the process like a training guide or Standard Operating Procedure (SOP) written about how to conduct the process and converting it into a series of User Interactions, Steps, or Activities and then using those as the process signature or search vector to find when/where the process has been conducted. This can be done by taking the natural language in the document which contains descriptions of what to click on, what to enter in what fields, how to navigate through the applications involved in the process, etc. and translating them to the set of entities such as User Interactions, Steps, or Activities and then the vector representation of them. The similarity search can then happen which finds similar vectors in the vector space to find examples of when the process was performed.

Finding the Usage Of: Finding the usage of Process is defined as the following. Similar Processes are ones that contain similar activities, user interactions, views, etc. when finding the usage of.

| Usage/Relation To | Description |
|---|---|
| User Interactions | This will return user interactions that took place as |
| | a part of this Process or similar ones. |
| Fields | This will return other Fields that are similar or used |
| | as a part of this Process or similar ones. |
| Attributes | This will return attributes that are present as a part |
| | of this Process or similar ones. |
| Views | This will return Views that are used as a part of this |
| | Process or similar ones. |
| Activities | This will return Activities that are a part of this |
| | Process or a similar one. |
| Steps | This will return Processes that contain this Step or |
| | a similar one. |
| Processes | This will return Processes that are similar to |
| | each other. |
| Variations | This will return Variations that are part of this |
| | Process or a similar one. |
| Documents | This will return Documents that are a part of this |
| | Process or a similar one. |
| Chats/Conversations | This will return Conversations that are a part of |
| | this Process or a similar one. |
| E-Mails | This will return E-mails that are a part of this |
| | Process or a similar one. |
| Groups | This will return Groups of entities that contain |
| | this Process or a similar one. |
| KPIs | This will return KPIs that the Process influences |
| | or a similar one. |
| Statistics | This will return Statistics that the Process or a |
| | similar one have influence on. |
| User | This will return Users who performed this Process |
| | or one like it. |
| Teams | This will return Teams who performed this Process |
| | or one like it. |

Grouping: Now that we have the fast implementation of search and similarity, the information can be used to create groups of process sequences which are effectively variations of the process. The groups of the process sequences represent unique variations of the process and the distance used in the grouping (e.g., cosine similarity, Euclidean, or others) can allow the groups to more tightly represent the unique ways of doing the process or a representation that is more loose in doing the group. This is done using the representation of the entities, similarity, and distance whose implementation was described in prior sections. Additionally, groups of process sequences can be grouped together using the business understanding to create groups of sequences that indicate the presence of repetitive work patterns which are therefore indicative of a process being present. This enables users to explore the groups to identify processes with the ability to present labels to the groups using the model task associated to topic modelling or labelling, and which can also be presented as multiple possible topics or labels which the user can pick from or override with their own label. Similarity analysis between two or more groups will compare the similarity of the entities in the two groups which can further create hierarchies in group using techniques like hierarchical clustering. This allows for the creation of hierarchical relationships of processes using this technique.

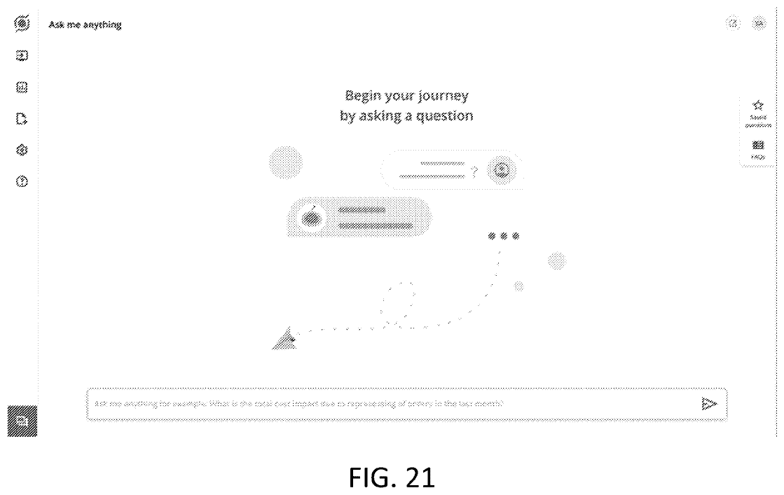

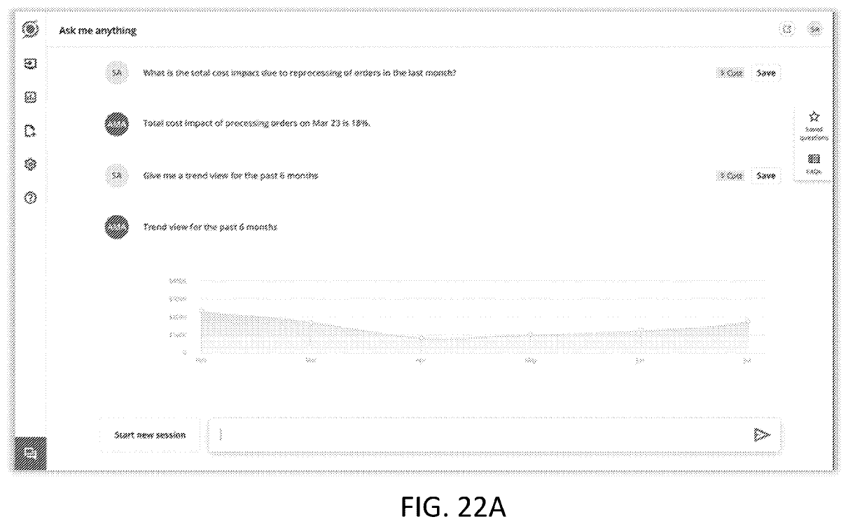

Interactive Queries: The model provides a capability through which a user can ask anything about the business entities like processes, variations, documents, emails, chats etc. described previously as shown in FIG. 21.

Questions can be asked in various categories which the model would identify automatically and tag these questions with that. The users can provide feedback on the answers as well as save them.

There can be questions in categories like Cost and the user can either ask a further detailed question on the same topic or start a new topic altogether. There can be questions in categories like Customer Experience and the users would be provided by answers from the model which is pertaining to same. Sometimes these answers are from the results which are part of the product itself.

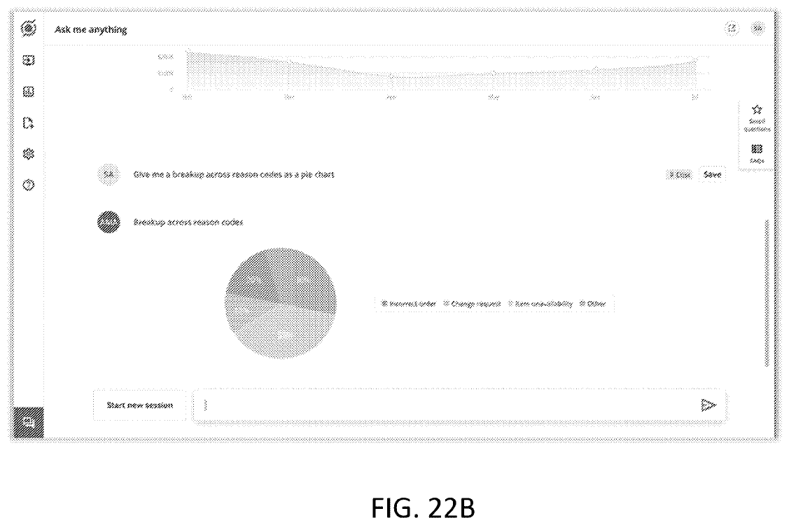

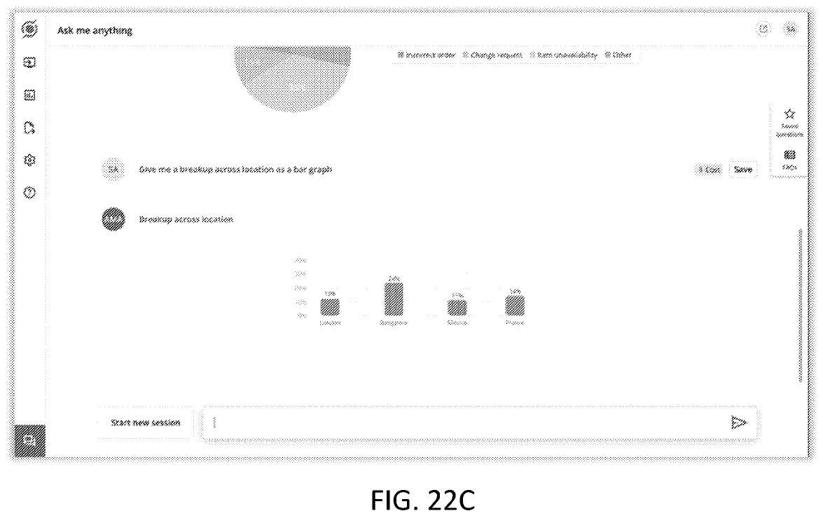

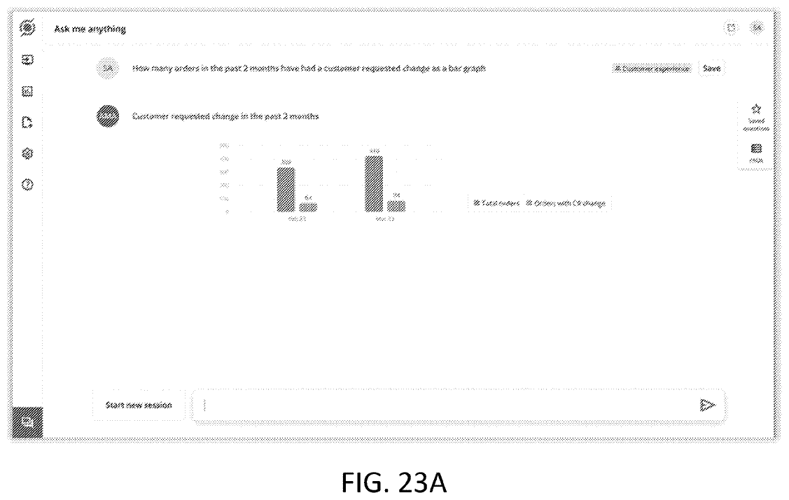

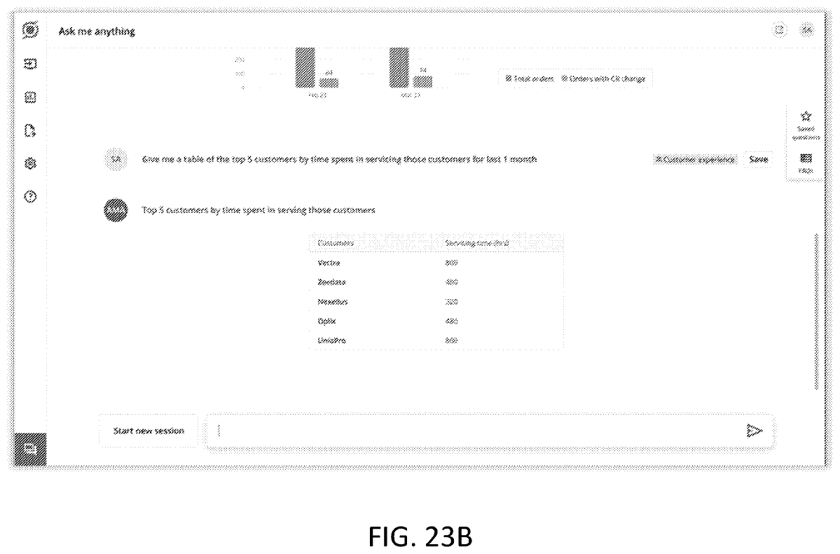

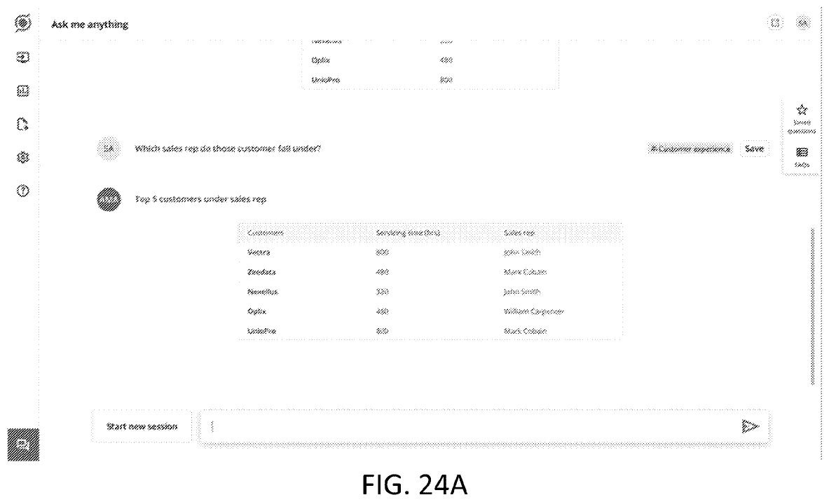

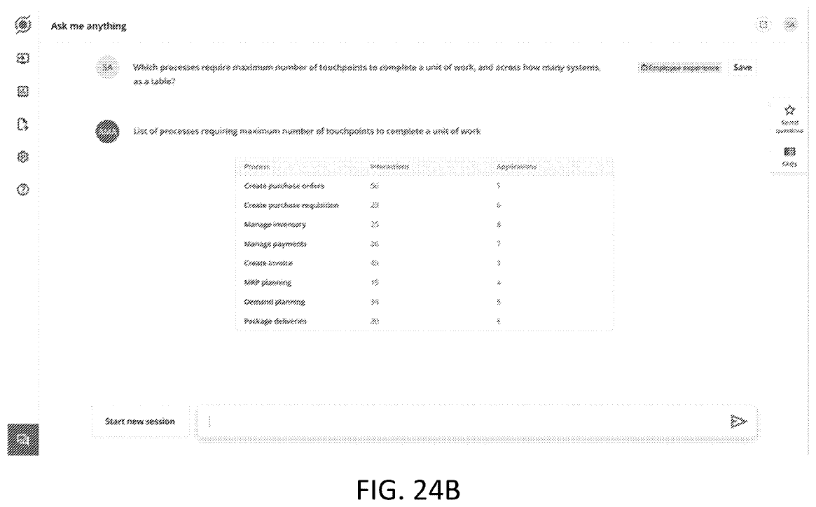

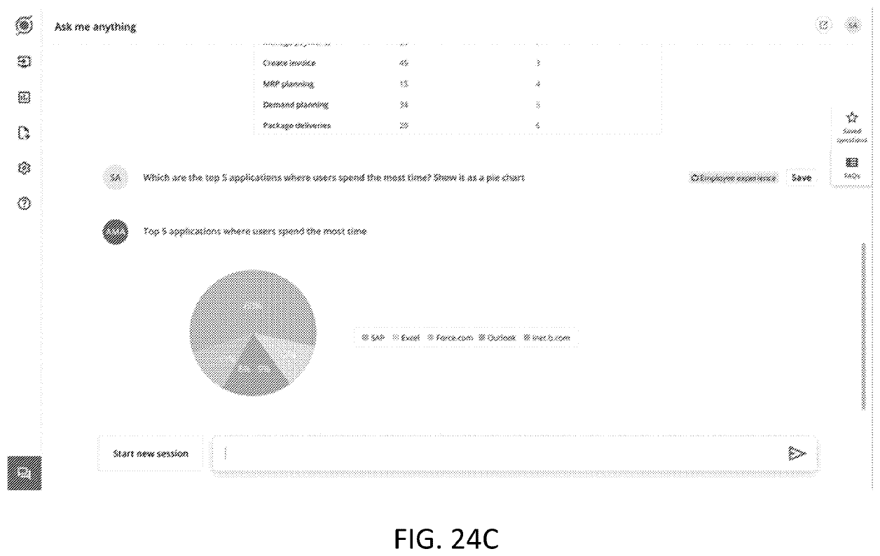

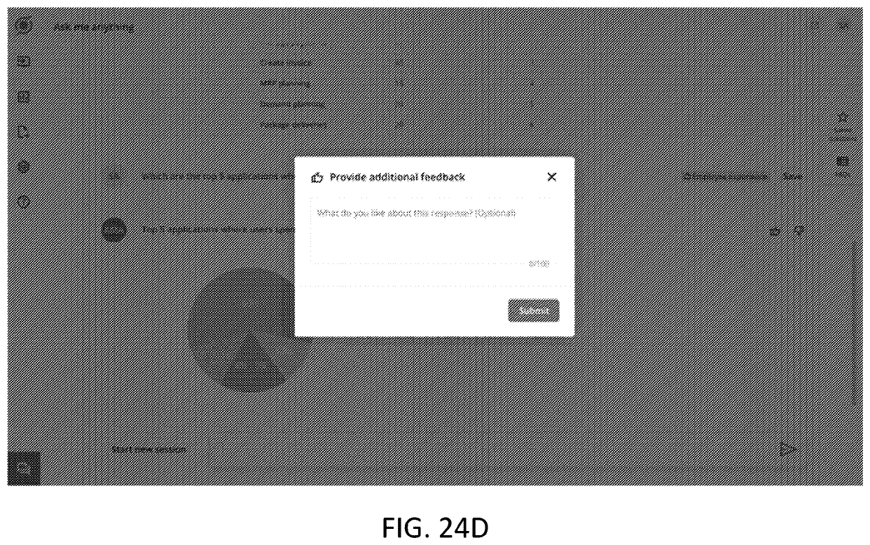

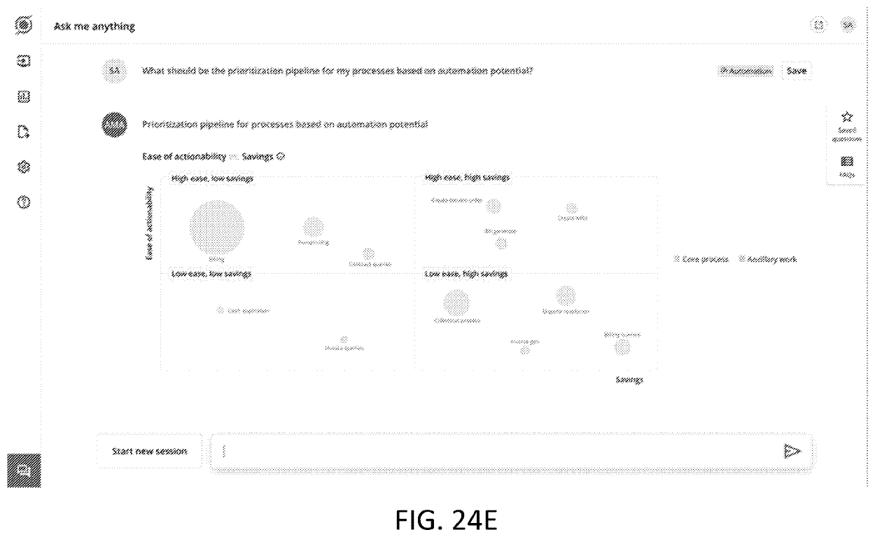

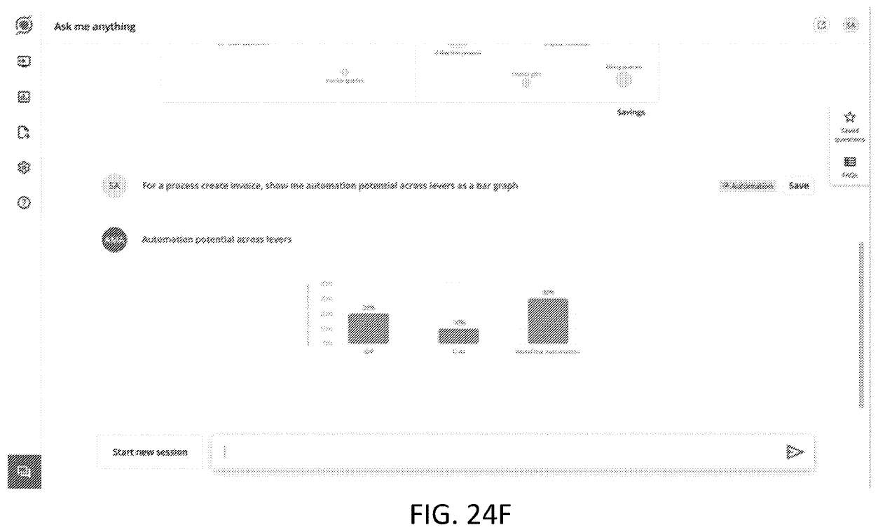

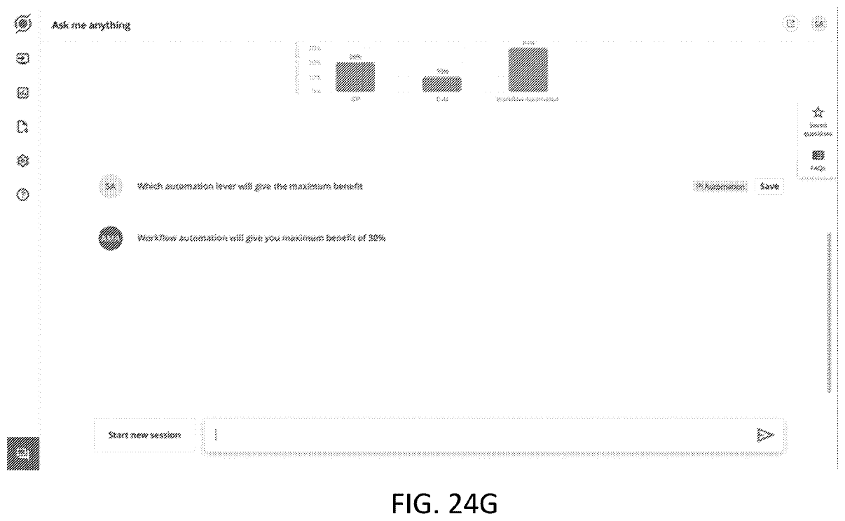

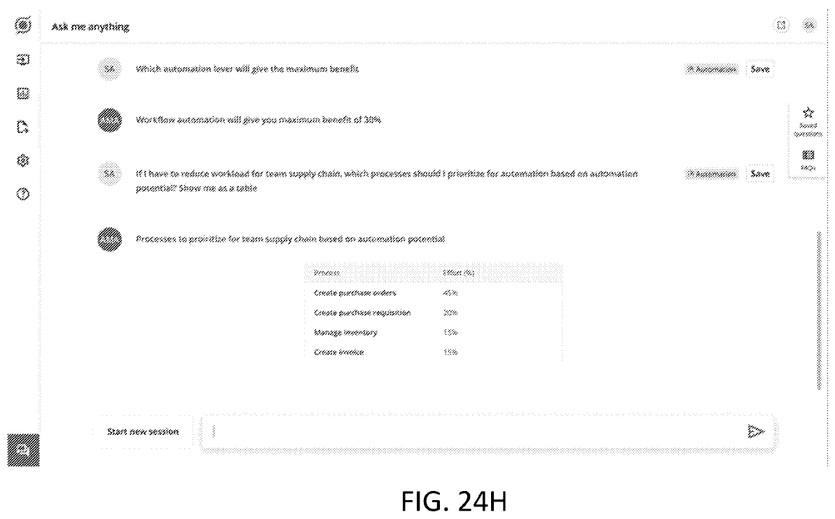

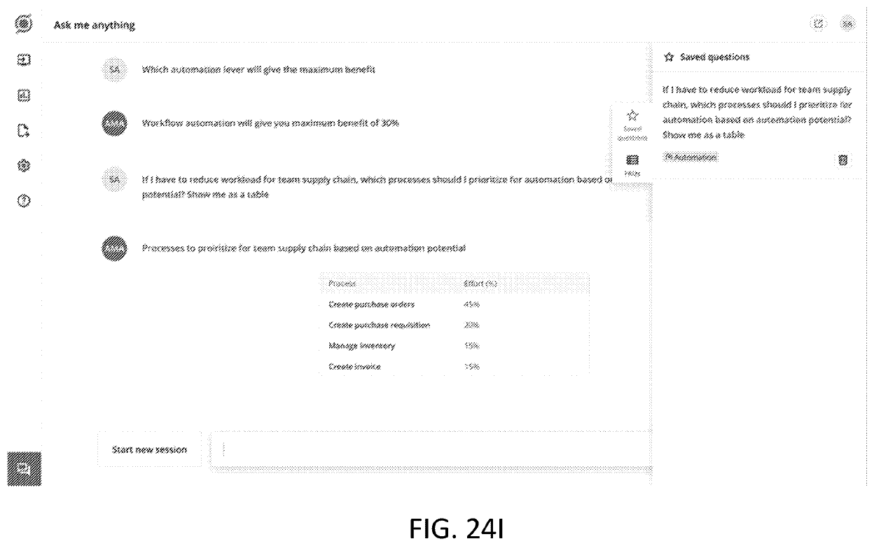

Some examples of questions which can be asked are shown in FIGS. 22A-22C, 23A-23B, and 24A-24I.

Generation Of: Like other entities, the model tasks described can generate or suggest more efficient Processes as a result of it also being able to generate the entities that are a part of it, e.g., by being able to generate Steps since a Process is a series of Steps and also contains other entities like Documents. This allows the model tasks to suggest a more efficient way of performing the process by generating a more efficient form of it and the entities contained in it. This can be based on the information learned from the industry process templates, industry benchmarks, users performing the process, and other sources that the model has been described as being trained on.

Impact on Business KPIs: Processes have a direct relationship to KPIs based on the process that is being performed and the KPIs that are setup and configured for that process or learned to be associated to the process via the model. With an understanding and association of all of the steps, documents, activities, user interactions, etc. that are associated with a process, it is known what of these entities is impacting the KPI. Therefore, suggesting to the user to address inefficiencies in any of these entities to improve the KPI of the process. Additionally, by identifying the inefficiency (e.g., using measures of manual human effort), it is suggested to the user that multiple bottlenecks or inefficiencies be resolved to actually influence the business KPI. This is as opposed to, only suggesting a single improvement needs to be made, only for the user to later learn their KPI has not improved due to a bottleneck elsewhere.

Industry Benchmarking: The model is trained on a large amount of data upwards of 100 Million parameters which provides a large number of statistics around various industries and the following parameters.
Processes and their types
Variations of each type of process
Effort spent on one transaction of a process.
Cycle time for one transaction of a process
Time taken by a process.
No of users typically executing the process
Documents normally used by a process.
Email templates used by similar processes.
Places where the process/variants are generally executed etc.

Using this data the model would be able to provide benchmark statistics across multiple dimensions for every work graph entity. The benchmarking statistics would help a user to determine their competitive standing using which they would be able to apply a corrective or preventive measure to either improve their position or consolidate their position further. This includes the benchmarks of processes being presented to users with the industry or competitive standard model visualized on one side of a canvas, and the user's process as captured on another side of the canvas for comparison.

From what the model has learned from either the industry benchmarks or the patterns in the Activities, Steps, User Interactions, Documents, etc. it can provide recommendations for automation (i.e., what to automate and how much savings could come from it), recommendations for training users or teams, recommendations for improvements to Applications that are impacting the efficiency of the process, recommendations for improvements to Documents that are impacting the efficiency of the process, recommendations for improving any of the User Interactions, Steps, or Activities that are impact the efficiency of the process.

From using generative models such as the transformer-based architecture that was described in how it is trained above, we can therefore also generate better User Interactions, Steps, Activities, Documents and any other Entity that has been listed here that the model has been trained on. Generating reports and dashboards to help users understand their processes, its KPIs and statistics associated with it.

Real-time User Experiences: Prior approaches have relied on training from users on processes that they conduct for the purpose of classification. For example, if the team does a process related to Creating Purchase Orders, to train a system to learn how to detect the process users can be asked to provide examples of them conducting the process. In some cases, this may be the user providing a recording of themselves doing the process which could be a screen recording or a recording of their individual interactions with the business applications to complete the process (i.e., what they clicked on, typed in, etc.).

Providing the several examples of the process can be very time consuming for the user. For example, if the process is 30 minutes long and they are asked to provide 5 examples of it, it would require 2.5 hours of their effort to train the system to detect the process.

With the use of the model described herein, it is now possible that we can detect the process without user training or with substantially less effort. For some very common industry processes, the model may be trained to detect the process based on what we had described it is trained on (e.g., business process templates, applications where the processes are performed, and documents that are used in the processes). Or, even if not pre-trained it is possible that users may now only be able to provide one example thereby significantly reducing the effort of the user by instead just requiring positive or negative confirmation in a few predictions made by the model.

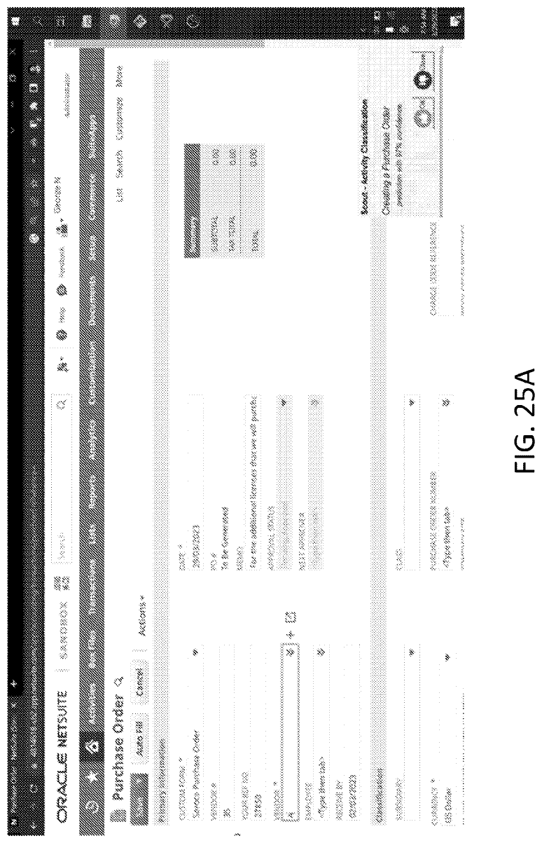

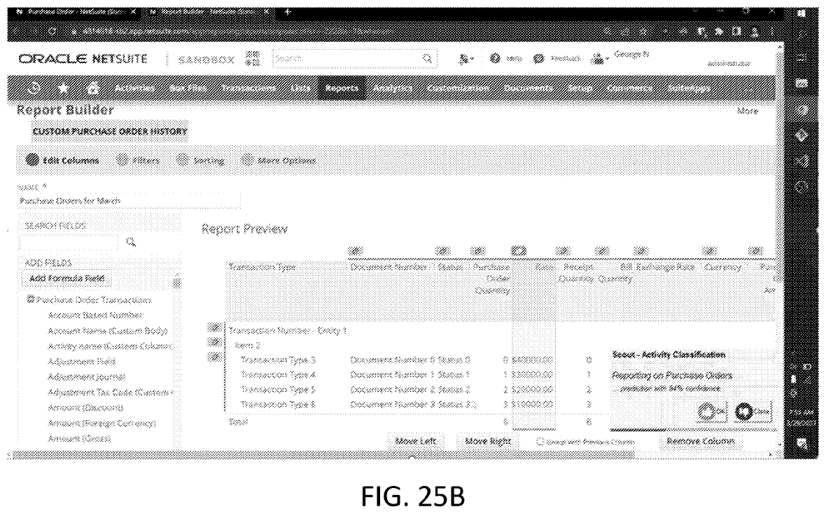

This effort reduction and user experience is illustrated in FIGS. 25A-25B where a user is creating a purchase order using a business application. The model may not been explicitly trained on this process in this application, and it is still able to provide a possible prediction for the process being conducted. In this example, it has predicted that the user is “Creating a Purchase Order” (FIG. 25A) and that the prediction was made with 97% confidence. This can provide user experiences that do not require any manual recorded examples, such that the entire training process is defined by classification suggestions and simple feedback from the users to accept or reject those classification suggestions.

In another example, the model is detecting that the user is now conducting a different process related to “Reporting on Purchase Orders,” as shown in FIG. 25B.

Therefore, instead of requiring so much training provided by users it is now possible to significantly reduce the amount of effort they have to contribute by instead just requesting for their feedback on whether a prediction is correct or not. If the user provides a positive confirmation of the prediction the model can learn from it to reinforce its learning. If the user provides a negative confirmation of the prediction the model can learn to produce a lower confidence score for this activity to that classification.

From the unsupervised capture of data, the model is able to identify the type of process which is getting executed and which type of business function this might belong to.

By looking at the steps, interactions, documents, emails, and applications it is be able create buckets/clusters of identified sequences which belong to same type of process under a particular business function.

The model would be able to identify the following (the list is not exhaustive) and show some ancillary piece of information which would be insightful for the ordinary user.
Type of Process it can be and additionally show samples of similar processes (with names) which have been seen across clients which also function in a similar domain.
Type of Business Function it can be associated with and some ancillary business functions which might use a similar process in parts.
Processes which are ordinarily found ancillary to these types of processes.
The variations which we have located and the variations of the process which is found in the industry.
Types of Documents and Applications used by these types of processes.
Types of Email Topics which are ordinarily observed in such processes.
Locations where such types of processes are usually observed in the industry.
How many users are normally observed to execute such types of processes etc.
How much time and effort do these processes take.

The model would be able to provide some clusters of probable processes which the user would be able to review and provide feedback upon whether the identified process is indeed like one of their processes. The feedback would be in terms of liking/disliking some of the steps/interactions which would help determine the actual process steps without training a process explicitly.

In addition to providing feedback by liking and disliking steps/interactions the users can drag and drop portions of a process from one or more automatically created cluster of processes and custom create their processes which is much lesser effort than training a process.

With time progressing the model continues to gather more data and evolve by capturing data from many users, the model would be able to identify processes and their interrelationships more accurately and comprehensively.

Another experience that is enabled from this technology is the ability for users to describe the process they are looking for in the data, such as: “My process starts by logging into SAP and creating a purchase order. Then, I use Excel to track the activity and submit it in Salesforce.” Using this natural language input we can convert it to the data representation (e.g., a vector or set of vectors) and then also search through the data to find where the process has occurred. This interface would therefore allow users to search through the data and train the system by finding a representation of their process with the natural language (e.g., in data already collected) and confirming it, which is of far less effort than recording examples of their process.

Once the Process that they are conducting is detected, it is also possible to guide the user on the ideal path or the best way to do the process they are working on. This is learned by the product via compliant and efficient ways of doing the process via ‘teachings’ or recordings from the user, Standard Operating Procedure (SOP) documents that describe the process, and/or learned ways of conducting the process by detecting common patterns. Those detected common patterns happen via discovery of users conducting the process and determining which patterns are more efficient in time, user effort, and/or improving business KPIs. The user can then be guided to the more efficient set of steps to perform by having them explained to the user in natural language in a pop-up on their screen, by linking them out to a flow chart or graph of the more efficient way of performing the process, by showing them a series of example screenshots on how to perform the more efficient steps, and/or showing them a recording of them. After being shown those steps the user can also give feedback on them as a way to further train the model that what it showed was helpful or not.

### 4.3.8 Variations

Entity Enrichment: One of the key outcomes that our model can produce today is to find variations of a processes which is trained to the model. Thus multiple different variations which match with the trained process in multiple degrees is found. As explained earlier there can be a plethora of such variations which can be found by our model. But for the ordinary user these variations are very difficult to comprehend as to why they are determined as variations or what are the differences between them and what they do signify

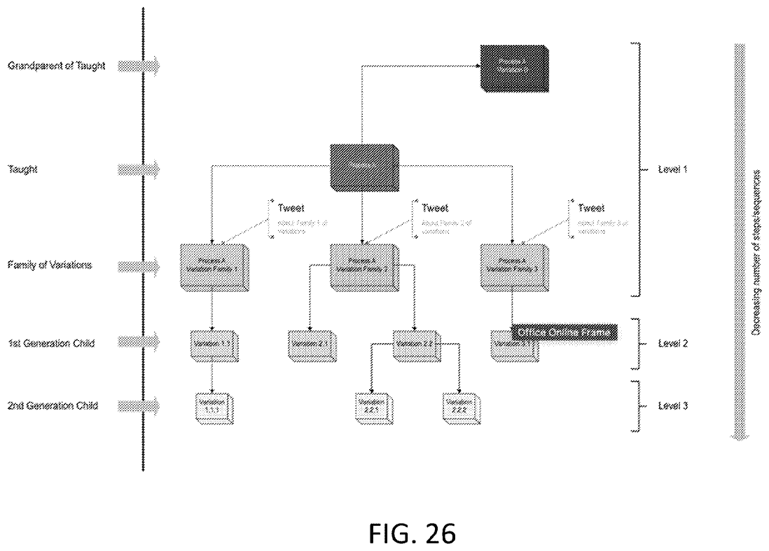

A trained process which can be an ‘Invoice Generation’ process can have multiple different variations where each variation achieves the same goal of generating an invoice but there can be certain steps which makes them different from the others or stand out. In FIG. 26 it can be seen that the different types of variations can each be classified to a family (of variations). A trained Process A when provided as an input to the model, it would be able to produce, for example, three different families of variations. The model in addition would be able to generate a human understandable business context for each family of variations denoting the objective and difference between the families. As in the example Process A (which is Invoice Generation) has 3 variation families which are identified by the model, these three variation families can be denoted through a small tweet which makes them identifiable to the business users:

“This variation of Invoice Generation accounts for 36% of the total effort spent on this process. 6 out of 8 users who have executed this process have used this variation which is 75% users prefer this variation over the others. An average of 5 users conducts each variation. The average handling time for this variation is about 2.5 mins which is 1 min shorter than the average handling time overall across all variations.”

Since the model would have the understanding of an Invoice Generating process per se across multiple users in the same organization as well as other organizations, our model would be able to provide many more details for benchmarking pertaining to what the variations should be, how many variations are usually observed, how many users are generally seen executing these variations, whether the variation has any geographical significance, what is the average executing time etc.

These comparative statistics helps the user understand where they are in terms of the industry and their peers.

### Summarization:

| Few Words | One Sentence | |
|---|---|---|
| Summary | Summary | One Paragraph Summary |
| Example | Example | Example |
| Invoice | Invoice Update | Update Invoice of <Customer |
| Update | requested | Name> requested via Service desk |
| | via Service | tickets to the service desk team who |
| | Desk Tickets | update the records in SAP and |
| | | confirm the customer by updating |
| | | the service desk ticket |

Topic Modelling: Variations along with their steps, activities, fields, and user interactions can all be provided to the model task of topic modelling to be able to automatically classify them towards particular business activities. For example, to automatically classify the variation as being a Purchase Order Creation process and so on. These are all labels that the model described in the model tasks can produce. This enables the user real-time experiences that are described below.

Similarity Analysis: Using the mechanisms described, we can now perform a similarity analysis across all of the following entities, including similarity analysis with a Process itself. Again, the exact similarity mechanism used is modular and described in the previous section on the similarity analysis model task.

Usage/Relation To

| | |
|---|---|
| User Interactions | Returns the similarity score between a Variation |
| | and user interaction. If the user interaction |
| | takes place in the Variation or another one of |
| | similar business intent, then the score will be |
| | greater. |
| Fields | Returns the similarity between a Variation and |
| | a field, determined based on whether the field |
| | is a part of the Variation or a similar Variation. |
| Attributes | Returns the similarity between an attribute and |
| | a Variation, determined based on whether the |
| | attribute is a part of the Variation or a similar |
| | Variation. |
| Views | Returns the similarity score between a View and |
| | a Variation. If the View was accessed as a part |
| | of the Variation it will return a greater score |
| Activities | Returns the similarity score between an Activity |
| | and a Variation. If the Activity was performed |
| | as a part of the Variation it will return a |
| | greater score. |
| Steps | Returns the similarity score between a Step and |
| | a Variation. If the Step was performed as a part |
| | of the Variation it will return a greater score. |
| | Or, if the Step is semantically related to the |
| | Variation type (e.g., a purchase order Step is |
| | more greatly related to a purchase order Variation). |
| Processes | Returns the similarity score between a Process |
| | and a Variation. If the Variation was performed |
| | as a part of the Process it will return a greater |
| | score. |
| Variations | Returns the similarity between two Variations. |
| | If the Variations are the same it will have a |
| | score of 1. If the Variations are not the same |
| | but have similar intent, steps, user interactions, |
| | etc. they will have a greater similarity score. |
| Documents | Returns the similarity score between a Variation |
| | and a Document. If the Document was accessed as |
| | a part of the Variation it will return a greater |
| | score. Also, greater if the Document was accessed |
| | in a similar Variation it will return a greater |
| | score. |
| Chats/Conversations | Returns the similarity score between a Variation |
| | and a Conversation. If the Conversation was |
| | part of conducting the Variation it will return |
| | a greater score. Also, greater if the Conversation |
| | takes place for another Variation of similar |
| | relationship it will return a greater score. |
| E-Mails | Returns the similarity score between a Variation |
| | and an E-Mail. If the E-Mail or E-Mails like it |
| | of similar topic were read, accessed, sent, etc. |
| | as a part of the Variation it will return a |
| | greater score. |
| Groups | Returns the similarity score between a Variation |
| | and a Group of any entities. The similarity |
| | with the individual entities in the group is |
| | returned and averaged for a similarity with |
| | the group. Other than an average, other |
| | statistics such as weighted averages or medians. |
| KPIs | Returns the similarity of the Variation and |
| | the KPIs, which will be of greater similarity |
| | if the Variation is influencing or related to |
| | the KPIs (e.g., involved in manual effort which |
| | impact the KPI). |
| Statistics | Returns the similarity of the Variation and the |
| | given statistic, which will be of greater |
| | similarity if the Variation is influencing the |
| | statistics. |
| User | Returns the similarity of the Variation and the |
| | user, which will be of greater similarity if |
| | this user performs the Variation or ones like it. |
| Team | Returns the similarity of the Variation and teams, |
| | which will be of greater similarity if the team |
| | performed the Variation or ones like it for their |
| | business activities. |

Fast Similarity Analysis and Search: Similar variations can easily be found by vectorizing the entity and then looking for similar variations in the vector space using the techniques described in the model tasks section. This will allow for quick search of similar variations, as well as to be able to compute the similarity of them.

Finding the Usage Of: Finding the usage of a Variation is defined as the following. Similar Variations are ones that contain similar activities, user interactions, views, etc. when finding the usage of.

| Usage/Relation To | Description |
|---|---|
| User Interactions | This will return user interactions that took place as |
| | a part of this Variation or similar ones. |
| Fields | This will return other Fields that are similar or |
| | used as a part of this Variation or similar ones. |
| Attributes | This will return attributes that are present as a |
| | part of this Variation or similar ones. |
| Views | This will return Views that are used as a part of |
| | this Variation or similar ones. |
| Activities | This will return Activities that are a part of this |
| | Variation or a similar one. |
| Steps | This will return Variations that contain this Step |
| | or a similar one. |
| Processes | This will return Variations that are part of this |
| | Process or a similar one, or Processes that the |
| | variation belongs to. |
| Variations | This will return variations that are similar to |
| | each other. |
| Documents | This will return Documents that are a part of this |
| | Variation or a similar one. |
| Chats/Conversations | This will return Conversations that are a part of |
| | this Variation or a similar one. |
| E-Mails | This will return E-mails that are a part of this |
| | Variation or a similar one. |
| Groups | This will return Groups of entities that contain |
| | this Variation or a similar one. |
| KPIs | This will return KPIs that the Variation |
| | influences or a similar one. |
| Statistics | This will return Statistics that the Variation |
| | or a similar one have influence on. |
| User | This will return Users who performed this |
| | Variation or one like it. |
| Teams | This will return Teams who performed this |
| | Variation or one like it. |

Grouping: Based on the distance of a vector representation of sequences in a variation, they can now even be organized together into groups of variations of which a group of variations can have similarity in them. There may be different ways of doing a process, that still share some unique aspect about them. For example, all of the variations in a group may be about Purchase Orders that had to undergo a modification, but inside that group there are still distinct variations where one had to complete the work in a Salesforce application and the other did not. The grouping is determined by obtaining a representation vector of a sequence inside the variations to group them or can be done by a median vector representation of all of the sequences in a group, or by a suitable representation using the weighted sum. However, it is the distance between these values that can allow us to group variations together.

Interactive Queries: Some of the questions which can be asked on the variations are as follows, show the variations which have a usage of more than 75%, find the most popular variations for the process Create Invoice, find the variations which have the least usage, find the variations which are seen seasonally and are not perennial, find the variations which have an average handling time of lesser than 2.7 mins, find the variations which have the most number of steps, find the variations which are least popular in terms of usage etc.

Generation Of: Like we have written for generation of Processes, not only can we generate an example of a more efficient way of doing a process we can also generate more efficient ways of performing a variation. A more efficient way of performing a process is effectively creating a new variation of the process. And this same technique can be used to generate a more efficient way of performing a variation of a process. That more efficient way may also already exist and being performed by users, which is an existing variation. In the generation of the more efficient way, the result very well may be close to an existing way of performing it as can be determined by the distance to nearby representations of other variations. Thus, one way to generate the more efficient variation, is from the model's mapping and understanding of another variation that has less time, effort, etc.

Impact on Business KPIs: Variations have a direct impact on business KPIs and are those which are related to the Process entity that the variation belongs to. Variations, however, also have additional refinement to them than just being a representation of the whole Process. Certain variations often represent a particular way of doing the process and can often be representative of doing the process under a certain condition (e.g., the way of doing the process for a particular vendor if it is a vendor reconciliation process). Therefore, variations can additionally be linked to very specific KPIs based on the conditions of the process it represents. This is learned directly through the Attributes prior work. Attributes are related to processes and variations, and Attributes indicate particular conditions of the variation or process (e.g., like what Vendor was being worked on).

Industry Benchmarking: Like we have written on industry benchmark for Processes, the same benchmarking can be provided at the granularity of a variation which was a particular way of doing the process. This allows the breakdown to be given specific to Variations instead of across the process as a whole.

Real-time User Experiences: Like we can detect that users are performing certain processes as described by the model tasks, we can reduce the threshold or distance to the signatures of the process and/or representative vector to be more refined to match to a particular variation. This allows the technology to detect that a user is performing a particular variation of the process.

### 4.3.9. Applications

Entity Enrichment: Similar to how we were able to group activities related to a business intent such as a Process being related to Invoice processing, we use the same such business intent labels which can be applied to Applications. Such as being able to not just say that the users use SAP but being able to say that the user use SAP to perform invoice processing, purchase order cancellation, and other business activities. This allows the Application data to be enriched with business understanding of how it is used generally and within the team. The Application entity can be enriched with information such as:
What processes use the application.
What documents are generated from the application.
What views belong to the application.
What attributes belong to the application.
What the business intent of the application is across all teams.
What the business intent of the application is within a team.

And more that we describe within the “Usage of” subsection below.

### Summarization:

| Few Words | One Sentence | |
|---|---|---|
| Summary | Summary | |
| Example | Example | One Paragraph Summary Example |
| ExpenseIT | Used for | ExpenseIT is used to manage the |
| | managing | expenses and the process surrounding |
| | expenses by | it. Expenses are created, updated, and |
| | the team. | verified using the application. |

Topic Modelling: Applications and their intended business use is derived from the topic models and labels as having been described in the task models section previous. The application attributes and labels can be used to determine which topics (i.e., business intents like “processing invoices”) are relevant to the application for generating the labelled used of the application.

Similarity Analysis: As previously shown, using the model we are able to leverage nearest neighbor or nearest neighbor-like searches to find similar applications to one that is provided. This can help for various reasons in an organization, such as finding applications that are used for similar purposes but may not be needed (e.g., why two invoice processing systems), and even to relate things like document intent to applications to understand that a document may have been created to perform an operation that an application should be able to (e.g., why should a document be needed to track Invoices when SAP has an implementation to track invoices?).

Fast Similarity Analysis and Search: Fast similarity analysis and search on applications is provided through their vector representation. Application content vectorized (e.g., as highlighted in the training section) is used to then compute the similarity between the applications, e.g., as a cosine distance or other metric as described in the model task. That same vectorization can be used to search for similar applications, whose vectors would be nearby each other in the vector space.

Similarity Analysis: Using the mechanisms described, we can now perform a similarity analysis across all of the following entities, including similarity analysis with an Application itself. Again, the exact similarity mechanism used is modular and described in the previous section on the similarity analysis model task.

Usage/Relation To

| | |
|---|---|
| User Interactions | Returns the similarity score between an Application |
| | and user interaction. If the user interaction takes |
| | place in the Application or another one of similar |
| | business intent, then the score will be greater. |
| Fields | Returns the similarity between an Application and |
| | a field, determined based on whether the field is |
| | a part of the Application or a similar Application. |
| Attributes | Returns the similarity between an attribute and an |
| | Application, determined based on whether the |
| | attribute is a part of the Application or a similar |
| | Application. |
| Views | Returns the similarity score between a View and |
| | an Application. If the View was accessed as a part |
| | of the Application it will return a greater score |
| Activities | Returns the similarity score between an Activity |
| | and an Application. If the Activity was performed |
| | as a part of the Application it will return a |
| | greater score. |
| Steps | Returns the similarity score between a Step and |
| | an Application. If the Step was performed as a |
| | part of the Application it will return a greater |
| | score. Or, if the Step is semantically related |
| | to the Application type (e.g., a purchase order |
| | Step is more greatly related to an Application |
| | purchase orders take place in). |
| Processes | Returns the similarity score between a Process |
| | and an Application. If the Application was accessed, |
| | used, processes performed in it, etc. as a part of |
| | the Process it will return a greater score. |
| Variations | Returns the similarity score between a Variation |
| | and an Application. If the Application was accessed |
| | as a part of the Variation it will return a greater |
| | score. Also, greater if the Application was accessed |
| | in a similar Variation it will return a greater |
| | score. |
| Application | The similarity of one application with another |
| | application, based on the business intent of the |
| | application, the processes performed in it, the |
| | information accessed in it, the steps performed in |
| | it, the activities performed in it, etc. |
| Documents | Returns the similarity between an application and |
| | a document. This similarity will be higher if the |
| | business intent of the application and document |
| | are similar (e.g., a purchase order document |
| | and an application used to process purchase orders). |
| Chats/Conversations | Returns the similarity score between an |
| | Application and a Conversation. If the |
| | Conversation was part of reading, creating, |
| | accessing, etc. the Application it will return |
| | a greater score. Also, greater if the Conversation |
| | takes place for another Application of similar |
| | relationship it will return a greater score. |
| E-Mails | Returns the similarity score between an |
| | Application and an E-Mail. If the E-Mail or |
| | E-Mails like it of similar topic were read, |
| | accessed, sent, etc. as a part of the |
| | Application it will return a greater score. |
| Groups | Returns the similarity score between an Application |
| | and a Group of any entities. The similarity with |
| | the individual entities in the group is returned |
| | and averaged for a similarity with the group. |
| | Other than an average, other statistics such |
| | as weighted averages or medians. |
| KPIs | Returns the similarity of the Application and the |
| | KPIs, which will be of greater similarity if the |
| | Application is influencing or related to the KPIs |
| | (e.g., involved in manual effort which impact |
| | the KPI). |
| Statistics | Returns the similarity of the Application and |
| | the given statistic, which will be of greater |
| | similarity if the Application is influencing the |
| | statistics. |
| User | Returns the similarity of the Application and |
| | the user, which will be of greater similarity |
| | if this user reads, writes, creates, accesses, |
| | etc. the Application or ones like it. |
| Team | Returns the similarity of the Application and |
| | teams, which will be of greater similarity if |
| | this Team reads, writes, creates, accesses, etc. |
| | the Application or ones like it. |

Grouping: Grouping is shown in the example in the entity enrichment section.

Finding the Usage Of: Finding the usage of an application is defined as the following. Similar Applications are ones that contain similar content, intent, etc. as previously defined when finding the usage of.

| Usage/Relation To | Description |
|---|---|
| User Interactions | This will return user interactions that took place |
| | as a part of this Application or similar ones. |
| Fields | This will return other Fields that are similar or |
| | used as a part of this Application or similar |
| | ones. |
| Attributes | This will return attributes that are present as |
| | a part of this Application or similar ones. |
| Views | This will return Views that are used as a part |
| | of this Application or similar ones. |
| Activities | This will return Activities that are a part of |
| | this Application or a similar one. |
| Steps | This will return Applications that contain this |
| | Step or a similar one. |
| Processes | This will return Applications that are part of |
| | this Process or a similar one, or Processes |
| | that the Application belongs to. |
| Variations | This will return Applications that are a part |
| | of this Variation or a similar one. |
| Documents | This will return Applications that may have |
| | generated this document or have been used |
| | with this document (e.g., exported from it, |
| | imported to it, information copied between |
| | the two). |
| Applications | This will return Applications that are similar |
| | to each other. |
| Chats/Conversations | This will return Conversations that access or |
| | discuss this Application or a similar one. |
| E-Mails | This will return E-mails that access or discuss |
| | this Application or a similar one. |
| Groups | This will return Groups of entities that contain |
| | this Application or a similar one. |
| KPIs | This will return KPIs that the Application |
| | influences or a similar one. |
| Statistics | This will return Statistics that the Application |
| | or a similar one have influence on. |
| User | This will return Users who access, create, |
| | discuss, etc. this Application or one like it. |
| Teams | This will return Teams who access, create, |
| | discuss, etc. this Application or one like it. |

Interactive Queries: Some of the sample questions can be like what are the processes which use the application, what Applications are used in the process Invoice Generation, what Applications are similar to the Invoice Directory in the work graph, which KPI is related to the Application, what users are accessing the Application ______, what processes are accessing the Application ______, etc.

Generation Of: With the business understanding of Applications and what are typically contained in them, it is now possible for the model to generate possible Views that would be complete for the application and the business intent it is trying to provide. The generation of ideal Views, layouts of the applications, attributes, or fields for the applications.

Impact on Business KPIs: Processes are performed in applications, and as written in other sections of this document processes can be linked to KPIs. Once the processes, activities, steps, etc. are all linked to KPIs then it is apparent what business KPIs are also influenced by what applications. This is used to indicate that improvements or bottlenecks in applications are impacting business KPIs, and what exact KPIs those are.

Industry Benchmarking: Shown in the example in the entity enrichment section.

Real-time User Experiences: Real-time user experiences are now available where as users interact with Applications, the vectorized content can then be used to propose what kind of Application that the user is working on for the purpose of grouping, classification, topic modelling, etc. That user's feedback will be taken into consideration when performing all of these model tasks. That makes the model more accurate over time and ensures a proper understanding of the team's work.

Using the fast lookup and vector search for Activities and User Interactions, we can also identify common IT problems across users. Such that, when a user detects a problem that they are experiencing with their Application, Document, Chat, etc. they can submit that they have experienced the problem (e.g., via the product interface or application slowness/errors detected automatically). A vector representation is created for this IT issue and it is annotated as being an issue with any meta-data that the user might choose to attach to it (e.g., a description, a screenshot, a title, a resolution . . . ). In real-time, another user might experience the same IT issue. When that issue is vectorized using the Application, Document, Chat, or other entity vectorization it will be similar to the signature created from the other user's issue. That signature need not be a separate entity, but will have a vector representation. When the match is made, we can then return back the pattern that the other user performed to resolve the issue. This helps users within and across organizations resolve issues together automatically.

By monitoring for application slowness, errors detected on the screen, and/or a user manually notifying that an issue has occurred it will then also be possible to automatically generate an IT ticket with the associated information that was Scouted. The vector signature can be recorded with the IT ticket and could even be used by IT systems to detect how many times a user has experienced the particular issue. It could auto-close the ticket with the steps performed by another user that lead to a resolution, and so on.

By learning what users commonly fill into fields, looking at their recent history of User Interactions as well as those expected when performing Steps, Activities, and Processes, then Fields can automatically be filled in as users conduct processes and/or on demand as they request the technology to fill in the fields. That is, by some mechanism like a series of keystrokes we can invoke the technology to fill in a Field or set of Fields with a recommended value, or by option automatically fill in Fields as the technology has the appropriate values to fill in.

### 4.3.10 Documents

Entity Enrichment: Similar to how we were able to group activities related to a business intent such as updating an invoice based on the application behavior observed from the user, we can also use the trained model to label the intent of documents that the users are interacting with. This is shown in the bottom right of FIG. 16 whereas before we may have only been able to show that they accessed files by particular file names, we can now group all of that activity under something like “Purchase Order” which are all of the activities related to purchase order documents.

When interacting with the activity cluster related to the document, a substantial amount of new information can now be provided due to the contextual understanding of the model. This is shown in FIG. 28 and described in further detail below.

For the group of activities related to the particular document class, we can also suggest back to the user the other possible document classes that are similar. This information can be used to help the user navigate to similar documents or activities, but it can also provide the user with the ability to change the model's understanding of the document cluster. If they reclassify the activities related to the documents accessed in the cluster or group, then the feedback will be provided to the model for retraining. That will influence the model's future classifications.

Since the model has a semantic understanding of the information based on its training as described earlier in this document, we can also leverage nearest neighbor searches in the vector space to find similar documents to the ones listed. This is valuable so that users can find all of the documents that are related to a particular business activity that they are performing. For example, when working on purchase orders it may also be helpful to quickly access a Goods Order. When working on an Invoice, it may also be valuable to be able to quickly access Bill of materials, and so on.

Using the same business understanding in the model, process activity that is nearby in the vector space to the document also suggests that the processes use this kind of document. This is valuable to users who when updating or changing a document, may have to think through what processes need to be updated to a new version of the document. Or, to gain a deeper understanding of where the document is used and if it were to be improved the kind of processes that may be influenced based on it. There are many reasons why it is valuable for an understanding of what processes use what documents, these are just some of them. Likewise, a mapping can be obtained from this understanding of what teams use the document as well. This information can be used for similar purposes.

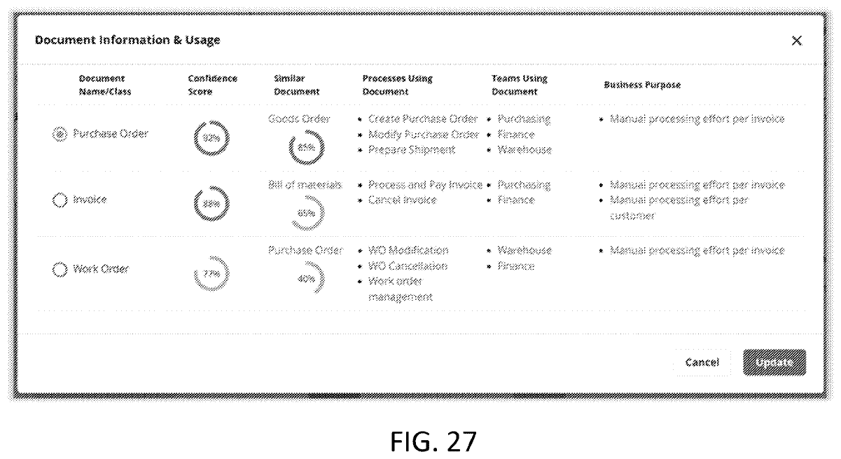

As another example of how this information can be used is in the final “Business Purpose” column shown in FIG. 27. That purpose links the document with the KPIs and business activities that the document influences. This is known by meta-data associated with process and activities that are performed where the document is used. This allows users to better understand the influence of changes to this document in some way. For example, to improve efficiency, reduce toil, etc.

### Summarization:

| Few Words | One Sentence | |
|---|---|---|
| Summary | Summary | |
| Example | Example | One Paragraph Summary Example |
| Expense | Itemized | Manual tracking of order request |
| Tracker | tracking of | details by the user, which assists them |
| | each order | in tracking the current state of the |
| | request for | orders created by them in Order details |
| | a date | page of ERP Ops |

Topic Modelling: Document topic modelling is shown in the example in the entity enrichment section.

Similarity Analysis: As previously shown, using the model we are able to leverage nearest neighbor or nearest neighbor-like searches to find similar documents to one that is provided. The document is passed through the encoder to produce a vector representation for it, which can then be used to lookup its particular area in the vector space. Other documents whose vector values are within a particular distance (e.g., cosine distance between the original document and potential similar document) can be returned as similar documents to the original document.

As shown in FIG. 28, this is useful for users to be able to find similar documents for reasons such as the following which are experiences that can be provided:
Finding similar documents to help users access other information that is relevant to the work they are doing (e.g., a Bill of Materials may be helpful when working on an Invoice).
Finding similar documents to find unapproved versions of documents being used in the organization for control purposes and to ensure compliance.
To find other documents that may be influencing the efficiency of a process or the team's productivity.
To find information that may be relevant to completing a business activity to help users be more productive in their work.
To help find other documents like it to create a more ideal version of the document to improve productivity of processes.

These are a few examples of uses of this information.

Fast Similarity Analysis and Search: Fast similarity analysis and search on documents is provided through their vector representation. Document content as vectorized is used to then compute the similarity between the documents, e.g., as a cosine distance or other metric as described in the model task. That same vectorization can be used to search for similar documents, whose vectors would be nearby each other in the vector space.

Similarity Analysis: Using the mechanisms described, we can now perform a similarity analysis across all of the following entities, including similarity analysis with a Document itself. Again, the exact similarity mechanism used is modular and described in the previous section on the similarity analysis model task.

Usage/Relation To

| | |
|---|---|
| User Interactions | Returns the similarity score between a Document |
| | and user interaction. If the user interaction |
| | takes place in the Document or another one of |
| | similar business intent, then the score will |
| | be greater. |
| Fields | Returns the similarity between a Document and |
| | a field, determined based on whether the field |
| | is a part of the Document or a similar Document. |
| Attributes | Returns the similarity between an attribute and |
| | a Document, determined based on whether the |
| | attribute is a part of the Document or a similar |
| | Document. |
| Views | Returns the similarity score between a View and |
| | a Document. If the View was accessed as a part |
| | of the Document it will return a greater score |
| Activities | Returns the similarity score between an Activity |
| | and a Document. If the Activity was performed |
| | as a part of the Document it will return a |
| | greater score. |
| Steps | Returns the similarity score between a Step and |
| | a Document. If the Step was performed as a part |
| | of the Document it will return a greater score. |
| | Or, if the Step is semantically related to the |
| | Document type (e.g., a purchase order Step is |
| | more greatly related to a purchase order Document). |
| Processes | Returns the similarity score between a Process |
| | and a Document. If the Document was accessed, |
| | read, written, etc. as a part of the Process |
| | it will return a greater score. |
| Variations | Returns the similarity score between a |
| | Variation and a Document. If the Document was |
| | accessed as a part of the Variation it will |
| | return a greater score. Also, greater if the |
| | Document was accessed in a similar Variation |
| | it will return a greater score. |
| Documents | Returns the similarity between two Documents. |
| | If the Documents are the same it will have a |
| | score of 1. If the Documents are not the same |
| | but have similar intent, steps, user interactions, |
| | content, etc. they will have a greater |
| | similarity score. |
| Chats/Conversations | Returns the similarity score between a Document |
| | and a Conversation. If the Conversation was |
| | part of reading, creating, accessing, etc. the |
| | Document it will return a greater score. Also, |
| | greater if the Conversation takes place for |
| | another Document of similar relationship it |
| | will return a greater score. |
| E-Mails | Returns the similarity score between a Document |
| | and an E-Mail. If the E-Mail or E-Mails like it |
| | of similar topic were read, accessed, sent, etc. |
| | as a part of the Document it will return a |
| | greater score. |
| Groups | Returns the similarity score between a Document |
| | and a Group of any entities. The similarity with |
| | the individual entities in the group is returned |
| | and averaged for a similarity with the group. |
| | Other than an average, other statistics such as |
| | weighted averages or medians. |
| KPIs | Returns the similarity of the Document and the |
| | KPIs, which will be of greater similarity if the |
| | Document is influencing or related to the KPIs |
| | (e.g., involved in manual effort which impact |
| | the KPI). |
| Statistics | Returns the similarity of the Document and the |
| | given statistic, which will be of greater |
| | similarity if the Document is influencing the |
| | statistics. |
| User | Returns the similarity of the Document and the |
| | user, which will be of greater similarity if |
| | this user reads, writes, creates, accesses, etc. |
| | the Document or ones like it. |
| Team | Returns the similarity of the Document and teams, |
| | which will be of greater similarity if this Team |
| | reads, writes, creates, accesses, etc. the |
| | Document or ones like it. |

Grouping: Grouping is shown in the example in the entity enrichment section.

Finding the Usage Of: Finding the usage of a Document is defined as the following. Similar Documents are ones that contain similar content, intent, etc. as previously defined when finding the usage of.

| Usage/Relation To | Description |
|---|---|
| User Interactions | This will return user interactions that took |
| | place as a part of this Document or similar ones. |
| Fields | This will return other Fields that are similar |
| | or used as a part of this Document or similar ones. |
| Attributes | This will return attributes that are present as |
| | a part of this Document or similar ones. |
| Views | This will return Views that are used as a part |
| | of this Document or similar ones. |
| Activities | This will return Activities that are a part of |
| | this Document or a similar one. |
| Steps | This will return Documents that contain this Step |
| | or a similar one. |
| Processes | This will return Documents that are part of this |
| | Process or a similar one, or Processes that the |
| | Document belongs to. |
| Variations | This will return Documents that are a part of |
| | this Variation or a similar one. |
| Documents | This will return Documents that are similar to |
| | each other. |
| Chats/Conversations | This will return Conversations that access or |
| | discuss this Document or a similar one. |
| E-Mails | This will return E-mails that access or discuss |
| | this Document or a similar one. |
| Groups | This will return Groups of entities that contain |
| | this Document or a similar one. |
| KPIs | This will return KPIs that the Document influences |
| | or a similar one. |
| Statistics | This will return Statistics that the Document or a |
| | similar one have influence on. |
| User | This will return Users who access, create, discuss, |
| | etc. this Document or one like it. |
| Teams | This will return Teams who access, create, discuss, |
| | etc. this Document or one like it. |

Interactive Queries: Some of the sample questions can be like what are the processes which use the document Procurement Diary, what documents are used in the process Invoice Generation, what documents are similar to the Invoice Directory in the work graph, which KPI is related to the document Vendor Retention, what users are accessing the document ______, what processes are accessing the document ______ etc.

Generation Of: With the business understanding of documents and what are typically contained in them, it is now possible for the model to generate documents that contain all of the information required for a process. That is because the model is aware of what is typically seen in each of the documents. Models such as Layout models can also be used to learn the structure of the documents and layout of the fields.

Impact on Business KPIs: Shown in the example in the entity enrichment section.

Industry Benchmarking: Shown in the example in the entity enrichment section.

Real-time User Experiences: Real-time user experiences are now available where as users interact with documents, the vectorized content can then be used to propose what kind of document that the user is working on for the purpose of grouping, classification, topic modelling, etc. That user's feedback will be taken into consideration when performing all of these model tasks. That makes the model more accurate over time and ensures a proper understanding of the team's work.

### 4.3.11 Chats/Conversations

Entity Enrichment: Whereas before we may only be able to say that a conversation took place, we can enrich the conversational entities about the business topics that were involved in the conversation. That might include annotating it that the users were discussing purchase orders, for example.

### Summarization:

| Few Words | One Sentence | |
|---|---|---|
| Summary | Summary | One Paragraph Summary |
| Example | Example | Example |
| Bug <Number> | Triage | Triage involving users from |
| | Discussion | engineering, analyst and database |
| | for Bug | team for Bug <Number> |
| | <Number> | |

Topic Modelling: Based on the observed conversation, the topic can be associated with the conversation using the topic modelling task as described in the previous sections. This is what will enable the system to be able to label the conversation with the topic such as dealing with purchase orders.

Similarity Analysis: Using the mechanisms described, we can now perform a similarity analysis across all of the following entities, including similarity analysis with a Conversation itself. Again, the exact similarity mechanism used is modular and described in the previous section on the similarity analysis model task.

Usage/Relation To

| | |
|---|---|
| User Interactions | Returns the similarity score between a Conversation |
| | and user interaction. If the user interaction takes |
| | place in the Conversation or another one of similar |
| | business intent, then the score will be greater. |
| Fields | Returns the similarity between a Conversation and |
| | a field, determined based on whether the field is a |
| | part of the Conversation or a similar Conversation. |
| Attributes | Returns the similarity between an attribute and a |
| | Conversation,determined based on whether the |
| | attribute is a part of the Conversation or a similar |
| | Conversation. |
| Views | Returns the similarity score between a View and a |
| | Conversation. If the View was accessed as a part of |
| | the Conversation it will return a greater score |
| Activities | Returns the similarity score between an Activity and |
| | a Conversation. If the Activity was performed as a |
| | part of the Conversation it will return a greater |
| | score. |
| Steps | Returns the similarity score between a Step and a |
| | Conversation. If the Step was performed as a |
| | part of the Conversation it will return a greater |
| | score. Or, if the Step is semantically related to |
| | the Conversation topic (e.g., a purchase order Step |
| | is more greatly related to a purchase order |
| | conversation). |
| Processes | Returns the similarity score between a Process and |
| | a Conversation. If the Conversation took place as a |
| | part of the Process it will return a greater score. |
| Variations | Returns the similarity score between a Variation and |
| | a Conversation. If the Conversation took place as a |
| | part of the Variation it will return a greater score. |
| | Also, greater if the Document was accessed in a |
| | similar Variation it will return a greater score. |
| Documents | Returns the similarity score between a Document |
| | and a Conversation. If the Conversation was part of |
| | reading, creating, accessing, etc. the Document it |
| | will return a greater score. Also, greater if the |
| | Conversation takes place for another Document of |
| | similar relationship it will return a greater score. |
| Chats/Conversations | Returns the similarity between two Conversations. If |
| | the Conversations are the same exact topic will have |
| | a score of 1. If the Conversations are not the same |
| | but have similar intent, steps, user interactions, etc. |
| | they will have a greater similarity score. |
| E-Mails | Returns the similarity score between a Conversation |
| | and an E-Mail. If the E-Mail or E-Mails like it of |
| | similar topic were read, accessed, sent, etc. as a |
| | part of the Conversation it will return a greater |
| | score. |
| Groups | Returns the similarity score between a Conversation |
| | and a Group of any entities. The similarity with the |
| | individual entities in the group is returned and |
| | averaged for a similarity with the group. Other |
| | than an average, other statistics such as weighted |
| | averages or medians. |
| KPIs | Returns the similarity of the Conversation and the |
| | KPIs, which will be of greater similarity if the |
| | Conversation is influencing or related to the KPIs |
| | (e.g., involved in manual effort which impact the |
| | KPI). |
| Statistics | Returns the similarity of the Conversation and the |
| | given statistic, which will be of greater similarity |
| | if the Conversation is influencing the statistics. |
| User | Returns the similarity of the Conversation and the |
| | user, which will be of greater similarity if this user |
| | reads, writes, creates, accesses, etc. the |
| | Conversation or ones like it. |
| Team | Returns the similarity of the Conversation and |
| | teams, which will be of greater similarity if this |
| | Team reads, writes, creates, accesses, etc. the |
| | Conversation or ones like it. |

Fast Similarity Analysis and Search: Using the mechanisms described, we can now perform a similarity analysis across all of the following entities, including similarity analysis with Conversations itself. Again, the exact similarity mechanism used is modular and described in the previous section on the similarity analysis model task.

Finding the Usage Of: Finding the usage of entities as a part of Conversations is defined as the following. Similar Conversations are ones that contain similar content, intent, etc. as previously defined when finding the usage of.

| Usage/Relation To | Description |
|---|---|
| User Interactions | This will return user interactions that took place |
| | as a part of this Conversation or similar ones. |
| Fields | This will return other Fields that are similar or |
| | used as a part of this Conversation or similar ones. |
| Attributes | This will return attributes that are present as a |
| | part of this Conversation or similar ones. |
| Views | This will return Views that are used as a part of |
| | this Conversation or similar ones. |
| Activities | This will return Activities that are a part of this |
| | Conversation or a similar one. |
| Steps | This will return Conversations that contain this |
| | Step or a similar one. |
| Processes | This will return Conversations that are part of this |
| | Process or a similar one, or Processes that the |
| | Conversation belongs to. |
| Variations | This will return Conversations that are a part of |
| | this Variation or a similar one. |
| Documents | This will return Conversations that access or |
| | discuss this Document or a similar one. |
| Chats/Conversations | This will return Conversations that are similar to |
| | each other. |
| E-Mails | This will return E-mails that access or discuss |
| | this Conversation or a similar one. |
| Groups | This will return Groups of entities that contain |
| | this Conversation or a similar one. |
| KPIs | This will return KPIs that the Conversation |
| | influences or a similar one. |
| Statistics | This will return Statistics that the Conversation or |
| | a similar one have influence on. |
| User | This will return Users who access, create, discuss, |
| | etc. this Conversation or one like it. |
| Teams | This will return Teams who access, create, discuss, |
| | etc. this Conversation or one like it. |

Grouping: Grouping is done based on the topics and intent that is associated with them. This allows e-mails to be grouped by topics such as being related to purchase orders, invoices, payments, and other business activities. Multiple layers of grouping are applicable, such as being able to group at the high-level of Invoices, and then further refining it down to groupings like creating invoices, cancelling invoices, modifying invoices, etc. E-mails can also belong to multiple groups if multiple groups or labels were involved in the communication.

Interactive Queries: Some examples are which chats use the invoice id ______, which conversations happened during the process ______, what are the conversations are created by the user ______ etc.

Generation Of: Generation of conversation is similar to the Interactive Queries in that the interaction queries enable generated conversations that can allow users to access information or knowledge more easily as embedded in the model, without needing to speak with another person.

Impact on Business KPIs: Conversations have association to processes, activities, steps, and all other entities related to the digital execution of the work. All of these entities are associatable to KPIs via the association of KPIs to processes, activities, and steps which is configurable or automatically assigned by having both the KPI and the step, process, activity, etc. being labelled to the system business activity (e.g., purchase order creation). It is therefore known what Conversations influence business KPIs as well.

Industry Benchmarking: Topics that are related to the conversation have a relationship to the Activity or Process that they were performed in and can be a source of a bottleneck in performing a process more efficiently. For example, if the users spend significant amounts of time reading and writing to each other as part of a Purchase Order process. They may be lacking information or require help which is delaying the process. It is therefore known whether conversations can be part of a process under performing compared to an industry or learned standard.

Real-time User Experiences: Real-time classification of conversations can be provided, as well as feedback mechanisms from the user that suggest that the conversation is time consuming, and standardization is missing from it. Standard templates can also be provided to users in real-time to help them perform the task related to creating, sending, or responding to the conversation.

### 4.3.12 Emails

Entity Enrichment: Whereas before we may only be able to say that an e-mail took place, we can enrich the e-mail entities about the business topics that were involved in the conversation. That might include annotating it that the users were e-mailing about purchase orders, for example.

### Summarization:

| Few Words | One Sentence | |
|---|---|---|
| Summary | Summary | One Paragraph Summary |
| Example | Example | Example |
| Password | HROps One | One Time Password (OTP) valid |
| Reset | Time Pin for | till Next 15 minutes for resetting |
| Invoice | Resetting | your HR Ops login access |
| Query | Password Customer | Request for the current state of the |
| | request for | invoice by its generated number |
| | Invoice Number | |
| | Status Check | |

Topic Modelling: Based on the observed e-mail, the topic can be associated with the e-mail using the topic modelling task as described in the previous sections. This is what will enable the system to be able to label the e-mail with the topic such as dealing with purchase orders.

Similarity Analysis: Using the mechanisms described, we can now perform a similarity analysis across all of the following entities, including similarity analysis with an E-Mail itself. Again, the exact similarity mechanism used is modular and described in the previous section on the similarity analysis model task.

Usage/Relation To

| | |
|---|---|
| User Interactions | Returns the similarity score between an E-Mail |
| | and user interaction. If the user interaction |
| | takes place in the E-Mail or another one of similar |
| | business intent, then the score will be greater. |
| Fields | Returns the similarity between an E-Mail and a |
| | field, determined based on whether the field is a |
| | part of the E-Mail or a similar E-Mail. |
| Attributes | Returns the similarity between an attribute and an |
| | E-Mail, determined based on whether the attribute |
| | is a part of the E-Mail or a similar E-Mail. |
| Views | Returns the similarity score between a View and an |
| | E-Mail. If the View was accessed as a part of the |
| | E-Mail it will return a greater score |
| Activities | Returns the similarity score between an Activity and |
| | an E-Mail. If the Activity was performed as a part of |
| | the E-Mail it will return a greater score. |
| Steps | Returns the similarity score between a Step and an |
| | E-Mail. If the Step was performed as a part of the |
| | E-Mail it will return a greater score. Or, if the |
| | Step is semantically related to the E-Mail topic |
| | (e.g., a purchase order Step is more greatly related |
| | to a purchase order E-Mail). |
| Processes | Returns the similarity score between a Process and |
| | an E-Mail. If the E-Mail took place as a part of |
| | the Process it will return a greater score. |
| Variations | Returns the similarity score between a Variation |
| | and an E-Mail. If the E-Mail took place as a part |
| | of the Variation it will return a greater score. |
| | Also, greater if the Document was accessed in a |
| | similar Variation it will return a greater score. |
| Documents | Returns the similarity score between a Document |
| | and an E-Mail. If the E-Mail was part of reading, |
| | creating, accessing, etc. the Document it will |
| | return a greater score. Also, greater if the E-Mail |
| | takes place for another Document of similar |
| | relationship it will return a greater score. |
| Chats/E-Mails | Returns the similarity score between a Conversation |
| | and an E-Mail. If the E-Mail or E-Mails like it of |
| | similar topic were read, accessed, sent, etc. as a |
| | part of the Conversation it will return a greater |
| | score. |
| E-Mails | Returns the similarity between two E-Mails. If the |
| | E-Mails are the same exact topic will have a score |
| | of 1. If the E-Mails are not the same but have |
| | similar intent, content, steps, user interactions, |
| | etc. they will have a greater similarity score. |
| Groups | Returns the similarity score between an E-Mail |
| | and a Group of any entities. The similarity with |
| | the individual entities in the group is returned |
| | and averaged for a similarity with the group. Other |
| | than an average, other statistics such as weighted |
| | averages or medians. |
| KPIs | Returns the similarity of the E-Mail and the KPIs, |
| | which will be of greater similarity if the E-Mail is |
| | influencing or related to the KPIs (e.g., involved |
| | in manual effort which impact the KPI). |
| Statistics | Returns the similarity of the E-Mail and the given |
| | statistic, which will be of greater similarity if the |
| | E-Mail is influencing the statistics. |
| User | Returns the similarity of the E-Mail and the user, |
| | which will be of greater similarity if this user reads, |
| | writes, creates, accesses, etc. the E-Mail or ones |
| | like it. |
| Team | Returns the similarity of the E-Mail and teams, |
| | which will be of greater similarity if this Team |
| | reads, writes, creates, accesses, etc. the E-Mail |
| | or ones like it. |

Fast Similarity Analysis and Search: With the vectorization of the e-mails based on the bodies and their intent, we enable fast similarity analysis and search via the nearest neighbor techniques that have been described in the previous sections. This will find e-mails that are of similar intent.

Finding the Usage Of: Finding the usage of entities as a part of E-Mail is defined as the following. Similar E-Mails are ones that contain similar content, intent, etc. as previously defined when finding the usage of.

| Usage/Relation To | Description |
|---|---|
| User Interactions | This will return user interactions that took place as |
| | a part of this E-Mail or similar ones. |
| Fields | This will return other Fields that are similar or used |
| | as a part of this E-Mail or similar ones. |
| Attributes | This will return attributes that are present as a part |
| | of this E-Mail or similar ones. |
| Views | This will return Views that are used as a part of this |
| | E-Mail or similar ones. |
| Activities | This will return Activities that are a part of this |
| | E-Mail or a similar one. |
| Steps | This will return E-Mails that contain this Step or a |
| | similar one. |
| Processes | This will return E-Mails that are part of this Process |
| | or a similar one, or Processes that the E-Mail |
| | belongs to. |
| Variations | This will return E-Mails that are a part of this |
| | Variation or a similar one. |
| Documents | This will return E-Mails that access or discuss this |
| | Document or a similar one. |
| Chats/Conversations | This will return E-mails that access or discuss this |
| | Conversation or a similar one. |
| E-Mails | This will return E-Mails that are similar to each |
| | other. |
| Groups | This will return Groups of entities that contain this |
| | E-Mail or a similar one. |
| KPIs | This will return KPIs that the E-Mail influences or a |
| | similar one. |
| Statistics | This will return Statistics that the E-Mail or a |
| | similar one have influence on. |
| User | This will return Users who access, create, discuss, |
| | etc. this E-Mail or one like it. |
| Teams | This will return Teams who access, create, discuss, |
| | etc. this E-Mail or one like it. |

Grouping: Grouping is done based on the topics and intent that is associated with them. This allows e-mails to be grouped by topics such as being related to purchase orders, invoices, payments, and other business activities. Multiple layers of grouping are applicable, such as being able to group at the high-level of Invoices, and then further refining it down to groupings like creating invoices, cancelling invoices, modifying invoices, etc. E-mails can also belong to multiple groups if multiple groups or labels were involved in the communication.

Interactive Queries: Some example queries can be find emails with the topic ______, how many emails are sent from the user ______, how many emails are sent to the customer ______, can the email topic distribution be shown as a pie chart, what is the mean response time for emails to the customer ______ etc.

Generation Of: E-mail templates are one application for generation, which is used to produce more efficient ways for users to respond to e-mails. These templates can be generated from an understanding of the model about the content that needs to be provided given a communication that needs to happen about the process.

Impact on Business KPIs: E-mails have association to processes, activities, steps, and all other entities related to the digital execution of the work. All of these entities are associable to KPIs via the association of KPIs to processes, activities, and steps which is configurable or automatically assigned by having both the KPI and the step, process, activity, etc. being labelled to the system business activity (e.g., purchase order creation). It is therefore known what E-mails influence business KPIs as well.

Industry Benchmarking: Topics that are related to the e-mail have a relationship to the Activity or Process that they were performed in and can be a source of a bottleneck in performing a process more efficiently. For example, if the users spend significant amounts of time reading and writing e-mails as part of a Purchase Order e-mail, related to a set of Purchase Order processes. It is therefore known whether e-mails can be part of a process under performing compared to an industry or learned standard.

Real-time User Experiences: Real-time classification of e-mails can be provided, as well as feedback mechanisms from the user that suggest that the e-mail is time consuming, and standardization is missing from it. Standard templates can also be provided to users in real-time to help them perform the task related to creating, sending, or responding to the e-mail.

### 4.3.13 Groups

Entity Enrichment: Groups had previously been one of the more difficult things to associate business intent and context with. All of the entity enrichment that is available on all of the other entities can now be used to enrich the description of the groups, such as being able to say that the group of entities is about e-mails that are related to purchase orders.

Topic Modelling: The topic modelling task can then be used to populate the topic models for the groups. Since groups can contain many entities, several topic models are predicted for the groups. A predominant one can be chosen if desired.

Similarity Analysis: The similarity analysis between groups is defined via all of the other entities already in their respective sections, e.g., between an e-mail and a group, a variation and a group, a View and a group, etc. However, similarity analysis between two groups will compare the similarity of the entities in the two groups which can further create hierarchies in group using techniques like hierarchical clustering.

Fast Similarity Analysis and Search: Fast similarity search can be provided using the same vectorization techniques described, which will allow for finding similar groups.

Finding the Usage Of: Finding the usage of entities as a part of Groups is defined as the following. Similar Groups are ones that contain similar entities as previously defined when finding the usage of.

| Usage/Relation To | Description |
|---|---|
| User Interactions | This will return user interactions that took place |
| | as a part of this Group or similar ones. |
| Fields | This will return other Fields that are similar or |
| | used as a part of this Group or similar ones. |
| Attributes | This will return attributes that are present as a |
| | part of this Group or similar ones. |
| Views | This will return Views that are used as a part of |
| | this Group or similar ones. |
| Activities | This will return Activities that are a part of this |
| | Group or a similar one. |
| Steps | This will return Groups that contain this Step or |
| | a similar one. |
| Processes | This will return Groups that are part of this Process |
| | or a similar one, or Processes that the Group belongs |
| | to. |
| Variations | This will return Groups that are a part of this |
| | Variation or a similar one. |
| Documents | This will return Groups that access or discuss this |
| | Document or a similar one. |
| Chats/Conversations | This will return Groups that access or discuss this |
| | Conversation or a similar one. |
| E-Mails | This will return Groups of entities that contain this |
| | E-Mail or a similar one. |
| Groups | Groups that are similar to each other. |
| KPIs | This will return KPIs that the Group influences or |
| | a similar one. |
| Statistics | This will return Statistics that the Group or a |
| | similar one have influence on. |
| User | This will return Users who access, create, discuss, |
| | etc. this Group or one like it. |
| Teams | This will return Teams who access, create, discuss, |
| | etc. this Group or one like it. |

Interactive Queries: Some examples are find the group of processes which has the highest effort coverage, which groups of processes use the identifier, group all the processes which refer to the document ______ etc.

### 4.3.14 KPIs

Entity Enrichment: Not applicable for this entity as KPIs are typically manually derived metrics with descriptions from industry standards.

Summarization: Not applicable for this entity as KPIs are typically manually derived metrics with descriptions from industry standards.

Topic Modelling: Given the relationship between KPIs as well as information that is kept with them in their names and descriptions, it is also easy to use the model tasks described in the prior sections to generate relevant topics for the KPIs. This helps relate KPIs to processes that have been defined, as well as KPIs that have been defined. This can therefore say that the following KPIs are all relevant to purchase order processes, for example, or that the KPIs are relevant to many or all processes.

Similarity Analysis: The similarity analysis between KPIs is defined via all of the other entities already in their respective sections, e.g., between an e-mail and a KPI, a variation and a KPI, a View and a KPI, etc. However, similarity analysis between two KPIs will compare the similarity of the KPIs intent, including the processes that are influenced by the KPI, the documents that influence the KPI, the variations that influence the KPI. The similarity of the intents of the KPIs and what influences them are compared to return the similarity of the KPIs. As well as a comparison between any KPIs with the KPIs.

Fast Similarity Analysis and Search: Not applicable for this entity.

Finding the Usage Of: Finding the usage of entities as a part of KPIs is defined as the following. Similar KPIs are ones that contain similar entities as previously defined when finding the usage of.

| Usage/Relation To | Description |
|---|---|
| User Interactions | This will return user interactions that influence |
| | this KPI or similar ones. |
| Fields | This will return other Fields that influence this |
| | KPI or similar ones. |
| Attributes | This will return attributes that influence this KPI |
| | or similar ones. |
| Views | This will return Views that influence this KPI or |
| | similar ones. |
| Activities | This will return Activities that influence this KPI |
| | or a similar one. |
| Steps | This will return KPIs that are influenced by this |
| | Step or a similar one. |
| Processes | This will return KPIs that are influenced by this |
| | Process or a similar one, or Processes that the KPI |
| | belongs to. |
| Variations | This will return KPIs that are influenced by this |
| | Variation or a similar one. |
| Documents | This will return KPIs that are influenced by this |
| | Document or a similar one. |
| Chats/Conversations | This will return KPIs that are influenced by this |
| | Conversation or a similar one. |
| E-Mails | This will return KPIs that are influenced by this |
| | E-Mail or a similar one. |
| Groups | Groups that are influenced by this KPI are similar |
| | ones. |
| KPIs | This will return the similarity of the KPIs provided. |
| Statistics | This will return Statistics that the KPIs are |
| | influenced by. |
| User | This will return Users who influence this KPI or |
| | similar ones. |
| Teams | This will return Teams who influence this KPI or |
| | similar ones. |

Grouping: Using the topics or classifications that are produced by the model tasks, it is possible to group KPIs together that are available into processes or activities that users or teams may be conducting. This can automatically make certain statistics or KPIs available for them.

Interactive Queries: Sample questions, find the processes which affect the KPI ______, find the biggest jump in the KPI ______ achieved in the previous year, which KPIs can be improved if the bottleneck around the data entry to documents can be resolved, how many KPIs are showing an increasing trend in the last quarter etc.

Generation Of: Given a process or an activity, organizations that did not have a set of statistics or KPIs can now have ones generated for them based on the model and its industry standards.

Impact on Business KPIs: Statistics are directly linked to KPIs and the computation of them. Therefore, there is a strong influence between the two.

Industry Benchmarking: There are many known statistics in industries which are all part of industry published metrics and KPIs. These can be learned from the model, as well as any data that can be collected and used for benchmarking. This enables users to see how their statistics compare across the industry, but with consideration of how their work is performed which is understood by the model.

Real-time User Experiences: Users can now be notified when their process or business activities are falling behind in terms of KPIs or statistics. This may not be of fault to the user, but may be an impact that application performance is negatively having on their work, or documents negatively having on their work, etc. However, this notification can inform users and/or their managers so that they can take action upon it.

### 4.3.15 Statistics

Entity Enrichment: Not applicable for this entity as statistics are typically manually derived metrics with descriptions from industry standards.

Summarization: Not applicable for this entity as statistics are typically manually derived metrics with descriptions from industry standards.

Topic Modelling: Given the relationship between statistics as well as information that is kept with them in their names and descriptions, it is also easy to use the model tasks described in the prior sections to generate relevant topics for the statistics. This helps relate statistics to processes that have been defined, as well as KPIs that have been defined. This can therefore say that the following statistics are all relevant to purchase order processes, for example, or that the statistics are relevant to many or all processes.

Similarity Analysis: The similarity analysis between Statistics is defined via all of the other entities already in their respective sections, e.g., between an e-mail and Statistics, a variation and Statistics, a View and Statistics, etc. However, similarity analysis between two sets of Statistics will compare the similarity of the Statistics intent, including the processes that are influenced by the Statistics, the documents that influence the Statistics, the variations that influence the Statistics. The similarity of the intents of the Statistics and what influences them are compared to return the similarity of the Statistics. As well as a comparison between any Statistics with the KPIs.

Fast Similarity Analysis and Search: Not applicable for this entity.

Finding the Usage Of: Finding the usage of entities as a part of Statistics is defined as the following. Similar Statistics are ones that contain similar entities as previously defined when finding the usage of.

| Usage/Relation To | Description |
|---|---|
| User Interactions | This will return user interactions that influence |
| | this Statistic or similar ones. |
| Fields | This will return other Fields that influence this |
| | Statistic or similar ones. |
| Attributes | This will return attributes that influence this |
| | Statistic or similar ones. |
| Views | This will return Views that influence this Statistic |
| | or similar ones. |
| Activities | This will return Activities that influence this |
| | Statistic or a similar one. |
| Steps | This will return Statistics that are influenced by |
| | this Step or a similar one. |
| Processes | This will return Statistics that are influenced by |
| | this Process or a similar one, or Processes that |
| | the KPI belongs to. |
| Variations | This will return Statistics that are influenced by |
| | this Variation or a similar one. |
| Documents | This will return Statistics that are influenced by |
| | this Document or a similar one. |
| Chats/Conversations | This will return Statistics that are influenced by |
| | this Conversation or a similar one. |
| E-Mails | This will return Statistics that are influenced by |
| | this E-Mail or a similar one. |
| Groups | Groups that are influenced by this Statistic are |
| | similar ones. |
| KPIs | This will return Statistics that the KPIs are |
| | influenced by. |
| Statistics | This will return the similarity of the Statistics |
| | provided. |
| User | This will return Users who influence this Statistic |
| | or similar ones. |
| Teams | This will return Teams who influence this Statistic |
| | or similar ones. |

Grouping: Using the topics or classifications that are produced by the model tasks, it is possible to group statistics together that are available into processes or activities that users or teams may be conducting. This can automatically make certain statistics or KPIs available for them.

Interactive Queries: Sample questions are like how many users accessed the document ______, how many emails were received by the user ______ in the last week, number of variations which was used only once in the last week, how many variations has the lowest effort coverage and how can those be removed, how much effort can be saved if the digital gap data entry to email is resolved etc.

Generation Of: Given a process or an activity, organizations that did not have a set of statistics or KPIs can now have ones generated for them based on the model and its industry standards.

Impact on Business KPIs: Statistics are directly linked to KPIs and the computation of them. Therefore, there is a strong influence between the two.

Industry Benchmarking: There are many known statistics in industries which are all part of industry published metrics and KPIs. These can be learned from the model, as well as any data that can be collected and used for benchmarking. This enables users to see how their statistics compare across the industry, but with consideration of how their work is performed which is understood by the model.

Real-time User Experiences: Users can now be notified when their process or business activities are falling behind in terms of KPIs or statistics. This may not be of fault to the user, but may be an impact that application performance is negatively having on their work, or documents negatively having on their work, etc. However, this notification can inform users and/or their managers so that they can take action upon it.

### 4.3.16 User

Entity Enrichment: When information is collected about users and associated with them, it is typically a very manual process that only contains very coarse information. Such as the team that users belong to, a department, etc. Through all of the association made between users and Activities, Processes, Variations, etc. there is more substantial information that we enrich a User's entity with. For example, to be able to say that a user typically works on Purchase related activities, and more specifically they are typically related to the creation of purchases or updating of them. Whereas other users can be more associated with the cancellation of purchase orders. What this means is that users and their relationship to all of the entities we've described thus far can be used to more significantly annotate information about the business user. This will eventually help teams better understand their members and each other based on their work activity.

The prior entity having had details like:
Team Member: George Nychis
Team: Purchasing
Department: Logistics

Whereas now far more rich information can be made available like:
Team Member: George Nychis
Team: Purchasing
Department: Logistics
Common Activities: Creating purchase orders, modifying purchase orders.
Shared Documents Commonly Accessed: . . . .
Applications Commonly Accessed: . . . .

### Summarization:

| Few Words | One Sentence | |
|---|---|---|
| Summary | Summary | One Paragraph Summary |
| Example | Example | Example |
| Team Manager/Line | Supports Customer | Involved in responding to |
| Manager, | requests via | Customer requests via Emails |
| Customer | Emails in India | by utilizing SAP, Salesforce |
| Support/Lead | | and ServiceNow software |
| Generator | | during the IST shift hours as |
| | | part of the order creation |
| | | process. |

Topic Modelling: Topic modelling for users can be about any of the entities that they are related to, such as describing users based on the topics of the processes they conduct, the topics of the e-mails they work with, the topics of the documents they access, etc. All of this information can be provided to be able to provide better topics about the users.

Similarity Analysis: The similarity analysis between Users is defined via all of the other entities already in their respective sections, e.g., between an e-mail and Users, a variation and Users, a View and Users, etc. However, the similarity analysis between two Users is defined by the similarity of the processes they perform, the documents they access, the interactions they perform, the activities they perform as a part of the work, the variations that they conduct, etc. The similarity across the users is implemented to consider all of these fields in aggregate, as well as can specify that two users be compared solely on one Entity. For example, to compare two users by their activities. Or, to compare two users by the processes that they conduct for example.

Fast Similarity Analysis and Search: Finding similar users to each other can be done by taking their entity vectors and performing some summarization of those entity vectors, e.g., all of their processes with vector representations of them and comparing those across users. This can be done to quickly find similar users in the vector space. It can be done on all entities, or by selecting a set of entities for this.

Finding the Usage Of: This defines finding the usage of various entities with Users.

Usage/Relation To

| | |
|---|---|
| User Interactions | This will return user interactions that this user |
| | performed, or users who performed this interaction. |
| Fields | This will return users who interacted with these |
| | fields, or fields that the user interacted with. |
| Attributes | This will return users who accessed or experienced |
| | this attribute (e.g., was present during their work), |
| | or all of the attributes that the user accessed or |
| | experienced. |
| Views | This will return users who accessed this View, or |
| | all of the Views that a given user accessed. |
| Activities | This will return users who accessed this Activity, |
| | or all of the Activities that a given user accessed. |
| Steps | This will return all users who performed the |
| | following step, or all steps that a given user |
| | performed. |
| Processes | This will return all processes the user performed, |
| | or all users that performed a particular process. |
| Variations | This will return all variations that the user |
| | performed, or all users that performed a given |
| | variation. |
| Documents | This will return all documents that the user |
| | accessed, read, created, etc. or all users that |
| | accessed, read, created, etc. a particular document. |
| Chats/Conversations | This will return all users that were part of a |
| | conversation, or a similar conversation. Or topics |
| | of conversations that a given user was involved |
| | with. |
| E-Mails | This will return all users that were part of an |
| | e-mail, or a similar e-mail. Or topics of e-mails |
| | that a given user was involved with. |
| Groups | This will return groups of entities that the user |
| | was involved with. All groups, or specified by a |
| | particular entity type (e.g., by e-mail groups). |
| KPIs | This will return all KPIs that the user influences, |
| | or all users that influence a particular KPI. |
| Statistics | This will return all statistics that the user |
| | influences, or all users that influence a |
| | particular statistics. |

Grouping: Although users are often grouped by departments or teams, there is substantially more information to better group users together based on their activities, processes, variations they do, documents they access, etc. This provides a far more substantial grouping to users based on their actual work, which often does not come across through team-based grouping. This can help teams, especially large ones, better understand their organization and how users can help each other within teams. Also, addressing challenges for one user and understanding their similarity to another user can predict the same improvements for another user. The grouping can also help teams gain an understanding of the similarity of users across geographies even. Is an HR representative in one geography very indicative of one in another geography?

Interactive Queries: Sample questions, how many users are generally observed in the industry who execute the process ______, find the number users who have spent more than 2 mins in the excel entry steps in the process, what are the distinct number of users executing the process ______ etc.

Generation Of: Although the model cannot generate users, the generative models described in the training section are capable of mimicking data that is similar to their typical behavior. This means it is possible to generate synthetic users to study behavior at scale and/or what happens if different users were placed together in teams or on processes.

Impact on Business KPIs: Users have a very direct impact on business KPIs. It is now possible to link users to business KPIs based on the activities and processes that they perform. This is used to help team leaders or CXO level individuals understand where KPIs need to improve, how to better augment or support users or teams. Without this kind of mapping, it would be very difficult to understand all teams and members that are involved with or responsible for a particular business KPI, such as the turnaround time of shipments. Users can now be directly linked to such KPIs based on those KPI's links to activities and processes, as described in those respective sections.

Industry Benchmarking: There are industry benchmarks for roles in the industry. A simple example of this might be for a recruiting function, where sizes of candidate pipelines are studied and known in the industry, as well as particular conversion rates that might be expected. One could understand an employee's performance against such benchmarks. Such benchmarks are known across various industries and standards are published for them. This can be used for comparisons.

Real-time User Experiences: Many real-time experiences are built for the end-users which are described in the other real-time user experience sections which are particular to the entities and tasks. That provides greater detail which we refer the reader to.

### 4.3.17 Team

Entity Enrichment: When information is collected about teams and associated with them, it is typically a very manual process that only contains very coarse information. Through all of the association made between teams and Activities, Processes, Variations, etc. there is more substantial information that we enrich a Team's entity with. For example, to be able to say that a team typically works on Purchase related activities, and more specifically they are typically related to the creation of purchases or updating of them. Whereas other teams can be more associated with the cancellation of purchase orders. What this means is that teams and their relationship to all of the entities we've described thus far can be used to more significantly annotate information about the business team. This will eventually help teams better understand their members and each other based on their work activity.

The prior entity had details like:
Team: Purchasing
Department: Logistics

Whereas now far more rich information can be made available like:
Team: Purchasing
Department: Logistics
Common Activities: Creating purchase orders, modifying purchase orders.
Shared Documents Commonly Accessed: . . . .
Applications Commonly Accessed: . . . .

### Summarization:

| Few Words | One Sentence | |
|---|---|---|
| Summary | Summary | One Paragraph Summary |
| Example | Example | Example |
| Order | Create Order | Create & Edit Orders for Customers |
| Shipping | details for | via Electronic Trade Exchange or |
| Fulfilment | Customers in | Emails on SAP in the North |
| | the North Americas | Americas |

Topic Modelling: Topic modelling for teams can be about any of the entities that they are related to, such as describing teams based on the topics of the processes they conduct, the topics of the e-mails they work with, the topics of the documents they access, etc. All of this information can be provided to be able to provide better topics about the teams.

Similarity Analysis: The similarity analysis between Teams is defined via all of the other entities already in their respective sections, e.g., between an e-mail and Teams, a variation and Teams, a View and Teams, etc. However, the similarity analysis between two Teams is defined by the similarity of the processes they perform, the documents they access, the interactions they perform, the activities they perform as a part of the work, the variations that they conduct, etc. The similarity across the Teams is implemented to consider all of these Entities in aggregate, as well as can specify that two Teams be compared solely on one Entity. For example, to compare two Teams by their activities. Or, to compare two Teams by the processes that they conduct for example.

Fast Similarity Analysis and Search: Finding similar teams to each other can be done by taking their entity vectors and performing some summarization of those entity vectors, e.g., all of their processes with vector representations of them and comparing those across teams. This can be done to quickly find similar teams in the vector space. It can be done on all entities, or by selecting a set of entities for this.

Finding the Usage Of: This defines finding the usage of various entities with Teams.

Usage/Relation To

| | |
|---|---|
| User Interactions | This will return user interactions that this |
| | team performed, or teams who performed this |
| | interaction. |
| Fields | This will return teams who interacted with these |
| | fields, or fields that the team interacted with. |
| Attributes | This will return teams who accessed or experienced |
| | this attribute (e.g., was present during their |
| | work), or all of the attributes that the team |
| | accessed or experienced. |
| Views | This will return teams who accessed this View, or |
| | all of the Views that a given team accessed. |
| Activities | This will return teams who accessed this Activity, |
| | or all of the Activities that a given team accessed. |
| Steps | This will return all teams who performed the |
| | following step, or all steps that a given team |
| | performed. |
| Processes | This will return all processes the team performed, |
| | or all teams that performed a particular process. |
| Variations | This will return all variations that the team |
| | performed, or all teams that performed a given |
| | variation. |
| Documents | This will return all documents that the team |
| | accessed, read, created, etc. or all teams that |
| | accessed, read, created, etc. a particular document. |
| Chats/Conversations | This will return all teams that were part of a |
| | conversation, or a similar conversation. Or topics |
| | of conversations that a given team was involved |
| | with. |
| E-Mails | This will return all teams that were part of an |
| | e-mail, or a similar e-mail. Or topics of e-mails |
| | that a given team was involved with. |
| Groups | This will return groups of entities that the team |
| | was involved with. All groups, or specified by a |
| | particular entity type (e.g., by e-mail groups). |
| KPIs | This will return all KPIs that the team influences, |
| | or all teams that influence a particular KPI. |
| Statistics | This will return all statistics that the team |
| | influences, or all teams that influence particular |
| | statistics. |

Interactive Queries: Some samples are which team has processed the maximum number of invoices, group the teams by location for the invoices generated by them respectively, which team has the achieved the maximum reduction in effort through the intervention on 22 Sep. 2022, show the number of new variations introduced in the process ______ grouped by teams etc.

Generation Of: Although the model cannot generate teams, the generative models described in the training section are capable of mimicking data that is similar to their typical behavior. This means it is possible to generate synthetic teams to study behavior at scale and/or what happens if different teams were placed together in teams or on processes.

Impact on Business KPIs: Teams have a very direct impact on business KPIs. It is now possible to link teams to business KPIs based on the activities and processes that they perform. This is used to help team leaders or CXO level individuals understand where KPIs need to improve, how to better augment or support teams or teams. Without this kind of mapping, it would be very difficult to understand all teams and members that are involved with or responsible for a particular business KPI, such as the turnaround time of shipments. Teams can now be directly linked to such KPIs based on those KPI's links to activities and processes, as described in those respective sections.

Industry Benchmarking: There are industry benchmarks for roles in the industry. A simple example of this might be for a recruiting function, where sizes of candidate pipelines are studied and known in the industry, as well as particular conversion rates that might be expected. One could understand an employee's performance against such benchmarks. Such benchmarks are known across various industries and standards are published for them. This can be used for comparisons.

Real-time Team Experiences: Many real-time experiences are built for the end-users which are described in the other real-time user experience sections which are particular to the entities and tasks. That provides greater detail which we refer the reader to. These users are those who belong to teams.

### Other Implementation Details

The techniques described herein can be used to build models for other tasks on top of the base BERT or RoBERTa model. For example, the numeric representations corresponding to the windows of events obtained using the RoBERTa model can be used in clustering similar events or sequences together. Also, a classification model can be fine-tuned on top of the base BERT or RoBERTa model to classify sequence of events into pre-defined categories/classes (e.g., business process names). For this task a classification head of appropriate size depending on the number of classes can be used as the final layer, and the model can be fine-tuned on a human annotated dataset. Similarly, a pair wise binary classification model can be designed and trained that takes in two sequences and classifies if the pair are similar or dissimilar to each other.

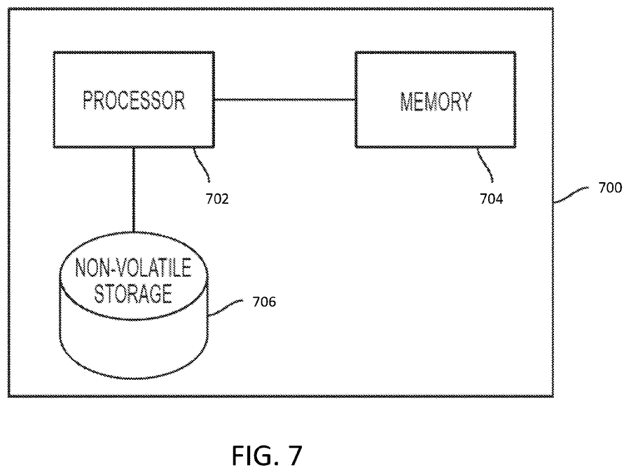

An illustrative implementation of a computer system 700 that may be used in connection with any of the embodiments of the disclosure provided herein is shown in FIG. 7. For example, any of the computing devices described above may be implemented as computing system 700. The computer system 700 may include one or more computer hardware processors 702 and one or more articles of manufacture that comprise non-transitory computer-readable storage media (e.g., memory 704 and one or more non-volatile storage devices 706). The processor 702(s) may control writing data to and reading data from the memory 704 and the non-volatile storage device(s) 706 in any suitable manner. To perform any of the functionality described herein, the processor(s) 702 may execute one or more processor-executable instructions stored in one or more non-transitory computer-readable storage media (e.g., the memory 704), which may serve as non-transitory computer-readable storage media storing processor-executable instructions for execution by the processor(s) 702.

The terms “program” or “software” are used herein in a generic sense to refer to any type of computer code or set of processor-executable instructions that may be employed to program a computer or other processor to implement various aspects of embodiments as described above. Additionally, according to one aspect, one or more computer programs that when executed perform methods of the disclosure provided herein need not reside on a single computer or processor but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed.

Also, data structures may be stored in one or more non-transitory computer-readable storage media in any suitable form. For simplicity of illustration, data structures may be shown to have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, for example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term). The phraseology and terminology used herein is for the purpose of description and should not be regarded as limiting. The use of “including,” “comprising,” “having,” “containing,” “involving,” and variations thereof, is meant to encompass the items listed thereafter and additional items.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

1. A method of using at least one trained machine learning (ML) model to identify a first process in a stream of event data, the method comprising:
using at least one computer hardware processor to perform:
receiving information corresponding to a stream of events corresponding to interactions between a user and one or more application programs executing on a computing device, the information comprising, for each particular event in the stream, metadata associated with the particular event, wherein metadata for the particular event specifies values for attributes of the particular event;
organizing events in the stream of events into a plurality of windows of events, wherein each of the plurality of windows of events comprises one or multiple events in the stream of events;
generating, using the at least one trained machine learning (ML) model, a respective plurality of numeric representations corresponding to the plurality of windows of events;
determining a measure of similarity between each of the numeric representations in the plurality of numeric representations and one or more stored and previously-determined numeric representations of the first process to obtain a plurality of measures of similarity; and
identifying, using the determined plurality of measures of similarity, the first process in the stream of events as comprising events in those windows, among the plurality of windows, whose determined measure of similarity to the one or more stored numeric representations of the first process was greater than a first threshold.

2. The method of claim 1, wherein:
the at least one trained ML model comprises a first trained ML model,
the plurality of windows comprises a first window comprising a first plurality of events, and
wherein the generating the respective plurality of numeric representations corresponding to the plurality of windows of events comprises:
generating a first numeric representation of the first window by processing at least some of the metadata associated with events in the first plurality of events using the first trained ML model.

3. The method of claim 2, wherein generating the first numeric representation of the first window comprises:
generating a numeric embedding of each of the events in the first plurality of events using the first trained ML model to obtain a first plurality of numeric embeddings corresponding to the first plurality of events; and
combining the first plurality of embeddings to obtain the first numeric representation of the first window.

4. The method of claim 3, wherein the combining comprises:
averaging the first plurality of embeddings to obtain the first numeric representation of the first window.

5. The method of claim 3, wherein the combining comprises:
determining a weighted average of the first plurality of embeddings to obtain the first numeric representation of the first window.

6. The method of claim 5, wherein determining the weighted average comprises:
weighting the first plurality of embeddings based on durations of the first plurality of events from which the first plurality of embeddings were derived.

7. The method of claim 3,
wherein the first plurality of events comprises a first event and the information corresponding to the stream of events comprises first metadata associated with the first event, and
wherein generating the numeric embedding of each of the events in the first plurality of events comprises generating a first numeric embedding of the first event by processing the first metadata with the first trained ML model.

8. The method of claim 7, wherein the first metadata comprises first attributes and first values of the first attributes, wherein generating the first numeric embedding of the first event by processing the first metadata with the first trained ML model comprises:
generating a textual event representation of the first event using the first values of the first attributes;
tokenizing the textual event representation to obtain a tokenized event representation;
determining an initial numeric encoding of the tokenized event representation; and
processing the initial numeric encoding with the first trained ML model to obtain the first numeric embedding of the first event.

9. The method of claim 8, wherein determining the initial numeric encoding comprises determining a byte pair encoding (BPE) of the tokenized event representation.

10. The method of claim 2, wherein the first trained ML model comprises an encoder including a trained neural network having a transformer-based architecture.

11. The method of claim 2, wherein the first trained ML model comprises an encoder including a trained neural network having a BERT model architecture or a RoBERTa model architecture.

12. The method of claim 2,
wherein the at least one trained ML model further comprises a second trained ML model different from the first trained ML model,
wherein the plurality of windows comprises a first window comprising a first plurality of events, and
wherein generating the first numeric representation of the first window includes processing the at least some of the metadata associated with the events in the first plurality of events using the first trained ML model and at least some other of the metadata associated with the events in the first plurality of events using the second trained ML model.

13. The method of claim 12,
wherein the first plurality of events comprises a first event and the information corresponding to the stream of events comprises first metadata associated with the first event, and
wherein generating the numeric embedding of each of the events in the first plurality of events comprises generating a first numeric embedding of the first event by processing a first portion of the first metadata with the first trained ML model and generating a second numeric embedding of the first event by processing a second portion of the first metadata with the second trained ML model.

14. The method of claim 13,
wherein the first trained ML model comprises an encoder including a trained neural network having a BERT model architecture or a RoBERTa model architecture, and
wherein the second trained ML model comprises an encoder having a trained neural network having a Sentence-BERT architecture.

15. The method of claim 1, wherein the measure of similarity comprises a cosine similarity.

16. The method of claim 1,
wherein the stream of events comprises a first event corresponding to an interaction between a user and an application program executing on the computing device,
wherein the information corresponding to the stream of events comprises metadata associated with the first event, and
wherein the first metadata comprises values for one or more attributes selected from the group consisting of: a name of the application program, a title of an application program screen of the application program with which the user interacted during the first event, an identifier of the user interface element of the application program screen with which the user interacted, a type of the user interface element of the application program screen with which the user interacted, one or more identifiers for one or more user interface elements of the application program screen with which the user did not interact, a duration of the interaction, and one or more textual phrases and/or sentences appearing on the application program screen.

17. The method of claim 1, wherein identifying the first process in the stream of events comprises:
using the determined measures of similarity to filter windows in the plurality of windows to obtain a plurality of filtered windows;
merging at least some consecutive windows in the plurality of filtered windows to obtain a plurality of candidate process windows;
determining a second plurality of numeric representations corresponding to the plurality of candidate process windows based on the first plurality of numeric representations corresponding to the plurality of windows;
determining second measures of similarity between each of the numeric representations in the second plurality of numeric representations and the one or more stored and previously-determined numeric representations of the first process to obtain a second plurality of measures of similarity; and
identifying, using the second determined plurality of measures of similarity, the first process in the stream of events as comprising events in those windows, among the plurality of candidate process windows, whose determined measure of similarity to the one or more stored numeric representations of the first process is greater than a second threshold.

18. The method of claim 17,
wherein the plurality of candidate process windows comprises a first candidate process window obtained by merging a first set of windows in the plurality of filtered windows,
wherein each window in the first set of windows has a respective numeric representation in the plurality of numeric representations, and
wherein determining the second plurality of numeric representations comprises determining a numeric representation for the first candidate process window by averaging or weighted averaging of numeric representations of the windows in the first set of windows.

19. A system, comprising:
at least one computer hardware processor; and
at least one non-transitory computer-readable storage medium storing processor executable instructions that, when executed by the at least one compute hardware processor, cause the at least one computer hardware processor to perform a method of using at least one trained machine learning (ML) model to identify a first process in a stream of event data, the method comprising:
receiving information corresponding to a stream of events corresponding to interactions between a user and one or more application programs executing on a computing device, the information comprising, for each particular event in the stream, metadata associated with the particular event, wherein metadata for the particular event specifies values for attributes of the particular event;
organizing events in the stream of events into a plurality of windows of events, wherein each of the plurality of windows of events comprises one or multiple events in the stream of events;
generating, using the at least one trained machine learning (ML) model, a respective plurality of numeric representations corresponding to the plurality of windows of events;
determining a measure of similarity between each of the numeric representations in the plurality of numeric representations and one or more stored and previously-determined numeric representations of the first process to obtain a plurality of measures of similarity; and
identifying, using the determined plurality of measures of similarity, the first process in the stream of events as comprising events in those windows, among the plurality of windows, whose determined measure of similarity to the one or more stored numeric representations of the first process was greater than a first threshold.

20. At least one non-transitory computer-readable storage medium storing processor executable instructions that, when executed by at least one computer hardware processor, cause the at least one computer hardware processor to perform a method of using at least one trained machine learning (ML) model to identify a first process in a stream of event data, the method comprising:
receiving information corresponding to a stream of events corresponding to interactions between a user and one or more application programs executing on a computing device, the information comprising, for each particular event in the stream, metadata associated with the particular event, wherein metadata for the particular event specifies values for attributes of the particular event;
organizing events in the stream of events into a plurality of windows of events, wherein each of the plurality of windows of events comprises one or multiple events in the stream of events;
generating, using the at least one trained machine learning (ML) model, a respective plurality of numeric representations corresponding to the plurality of windows of events;
determining a measure of similarity between each of the numeric representations in the plurality of numeric representations and one or more stored and previously-determined numeric representations of the first process to obtain a plurality of measures of similarity; and
identifying, using the determined plurality of measures of similarity, the first process in the stream of events as comprising events in those windows, among the plurality of windows, whose determined measure of similarity to the one or more stored numeric representations of the first process was greater than a first threshold.
